(19) United States
(12) Patent Application Publication
(10) Pub. No.: US 2007/0210559 A1
(43) Pub. Date: Sep. 13, 2007

(54) COUPLING GUIDANCE DEVICE

(76) Inventor: Gharrad Amine Yasmine, Balwyn (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/571,164

(22) PCT Filed: Jun. 22, 2005
(86) PCT No.: PCT/AU05/00887

§ 371 Date: Dec. 22, 2006

(30) Foreign Application Priority Data
Feb. 17, 2005 (AU) 2005900744
Jun. 22, 2004 (AU) 2004903411

(51) Int. Cl. B60D 1/36

(52) U.S. Cl. 280/504; 280/477

(57) ABSTRACT

A coupling guidance device comprising a first member (13) adapted to be coupled to a first vehicle (12), the first member (13) further adapted to be operatively associated with a guidance member (14) for providing a guide path, a second chamber (15) adapted to be coupled to a second vehicle (11), the second member (15) comprising a receptacle adapted to cooperate with the guidance member (14) such that the first (13) and second member (15) are adapted to be moved relative to one another, the relative movement serving to bring the first vehicle (12) and the second vehicle (11) into closer proximity.

### RELATED APPLICATIONS

This application claims priority to Australian Provisional Patent Application Nos. 2004903411, filed 22 Jun. 2004 and 2005900744, filed 17 Feb. 2005 both entitled “Coupling Guidance Device” and, the specifications thereof are incorporated herein by reference in their entirety and for all purposes.

### FIELD OF INVENTION

The present invention relates to a device for guiding first and second members. In one form, the invention relates to a device for guiding the coupling of a first vehicle to a second vehicle. It will be convenient to hereinafter describe the invention in relation to the use of a guide for the coupling of a motor vehicle to an object to be towed by the motor vehicle, such as a caravan or boat trailer or the like. However, it should be appreciated that the present invention is not limited to that use, only

### BACKGROUND TO THE INVENTION

The inventor has identified the following related art. In order to couple a first and second member, such as a vehicle and trailer, both vehicle and trailer must be brought into a sufficiently close proximity to enable the coupling to take place. This task is typically accomplished by backing the towing vehicle coupling member up to within a very short distance of the coupling member of the trailer, and then physically moving the trailer so that it may be coupled to the corresponding member of the vehicle.

The task of moving the vehicle to within coupling distance may be very difficult. This difficulty primarily arises due to an operator being unable to correctly judge the distance between the vehicle and trailer. Often it is necessary for a lone operator to exit the vehicle several times to make the correct alignment of the complementary coupling means and this may be very time-consuming and potentially dangerous. It may also be difficult to move and align the trailer with the vehicle coupling member, once the vehicle is stationary. This task may require significant physical strength to move the weight-laden trailer in either a vertical or horizontal plane, such that it may be coupled with the complementary vehicle member.

Both of these above tasks may be particularly difficult when the trailer supports a heavy load, such as a caravan or large boat and/or when the task is done by a single person lacking the physical ability to move the heavy trailer to the point of coupling with the vehicle. In some instances, a trailer may be positioned such that it is not possible to position the vehicle within an appropriate coupling distance. This occurs when the trailer is parked to one side of a garage or fence and not aligned with the driveway on which the vehicle is parked, or when the trailer is located on an angle or steep slope.

Due to the above-described problems, it may be common for an operator to accidentally damage either the vehicle or the trailer during the coupling process, or be unable to couple the trailer and vehicle at all.

Various types of devices have been provided heretofore for guiding coupling components into registry. They are however characterized by complex and expensive structures that may form permanent parts of either the vehicle or the trailer, making them economically unfeasible. Moreover, many of these existing devices may be operable only within a very short distance between trailer and vehicle.

Any discussion of documents, devices, acts or knowledge in this specification is included to explain the context of the invention. It should be not be taken as an admission that any of the material, so discussed, forms part of the prior art base or the common general knowledge in the relevant art in Australia or elsewhere on or before the priority date of the disclosure and/or claims herein.

### SUMMARY OF INVENTION

It is an object of the present invention to provide an improved coupling guidance device. A further object of the present invention is to alleviate at least one disadvantage associated with the identified related art.

In one aspect the present invention provides a coupling guidance device comprising:

a first member adapted to be coupled to a first vehicle, the first member further adapted to be operatively associated with a guidance member for providing a guide path;

a second member adapted to be coupled to a second vehicle, the second member comprising a receptacle adapted to cooperate with the guidance member such that the first and second member are adapted to be moved relative to one another, the relative movement serving to bring the first vehicle and the second vehicle into closer proximity.

In another aspect the present invention provides a method of guiding a first and a second vehicle into closer proximity for enabling the coupling of one vehicle to the other comprising the steps of:

operatively associating a first member adapted to be coupled to the first vehicle with a guidance member for providing a guide path;

cooperating a second member adapted to be coupled to the second vehicle with the guidance member such that the first and second member are adapted to be moved relative to one another along a guide path provided by the guidance member, the relative movement serving to bring the first vehicle and the second vehicle into closer proximity.

In another aspect the present invention provides a coupling guidance device comprising:

a guidance member;

a guidance member accepting means adapted for mounting to a second vehicle, and;

a guidance member coupling means adapted for mounting to a first vehicle, wherein the guidance member in operative association with the coupling means interacts with the accepting means and upon movement of at least one of the first vehicle or the second vehicle relative to one another the guidance member, the accepting means and the coupling means, in combination, cause substantial alignment of the two vehicles to enable coupling of one vehicle to the other.

In a further aspect the present invention provides a method of guiding the coupling of first and second vehicles comprising the steps of:

operatively associating a guidance member with a guidance member coupling means adapted for mounting to a first vehicle;

interacting the operatively associated guidance member and coupling means with a guidance member accepting means adapted for mounting to a second vehicle;

moving at least one of the first and second vehicles relative to the other to cause substantial alignment of the two vehicles thereby enabling coupling of one vehicle to the other.

In one form, the present invention provides for a coupling guidance device, preferably suitable for the coupling of a towed vehicle to a towing vehicle. The device may comprise a guidance member, a guidance member accepting means on the towed vehicle and a guidance member coupling means on the towing vehicle, wherein when in use, the guidance member coupled to the coupling means interacts with the accepting means and upon movement of at least one of the towing vehicle or the towed vehicle relative to one another, the coupling device causes substantial alignment of the two vehicles to enable attachment or coupling of one to the other.

Preferably, the towing vehicle is a motor vehicle, such as a car or a truck and the towed vehicle is a trailer or a caravan.

The guidance member coupling means is preferably mountable upon or to the motor vehicle's tow-bar, while the accepting means is mountable upon or to a gooseneck area of the trailer.

Preferably, the guidance member is a rigid and elongated rod.

Preferably, the guidance member is pivotally coupled to the coupling means to allow substantial free lateral, and preferably limited vertical movement of the guidance member when located upon or in the acceptance means.

Preferably further, the accepting means and the coupling means are removably attachable to said corresponding trailer or towing vehicle.

In essence, the present invention provides a guide path for bringing two members into close proximity by virtue of the combination of the guidance member operatively associated and cooperating with the first and second members, respectively. In use, the invention provides for a coupling device that has two cooperating regions, the first may comprise the guidance member and its associated coupling means in the form of the first member, which may be attachable to a towing vehicle, while the second region may comprise accepting means in the form of the second member, which may be attachable to a trailer. When the vehicle and trailer are placed within an acceptable distance relative to one another, the first region is engaged with the vehicle and the second region is engaged for coupling with the first region at the trailer, the guidance member coupled to the coupling means is located upon or partially in the accepting means. With, for example, the reversal of a motor vehicle towards the trailer, the guidance member further penetrates the accepting means and this combined arrangement causes substantial alignment of the vehicles to enable the trailer to be coupled to the vehicle.

Each of the components of the device may be made from materials suitable for achieving the desired end. For example, the materials may be of steel, coated steel, galvanized iron, stainless steel or forged steel. Preferably, the materials of construction are selected to take into consideration the environment in which the device is to be used. For example, when the towed vehicle is a boat trailer that may be submerged in water, particularly seawater, the material from which the accepting means is constructed may be non-corrosive.

A further embodiment of the invention provides a coupling guidance device adapted to remain permanently coupled to a trailer and even form part of the trailer itself, but at the same time if desired, this device is readily removable. In one particular embodiment, the second member or accepting means of the coupling guidance device may be partially recessed into the gooseneck region of a trailer so as to provide suitable clearance of the device from the ground.

In this further embodiment the present invention provides for a coupling guidance accepting means suitable for the coupling of a towed vehicle with a towing vehicle to enable the accepting means to remain permanently positioned on the towed vehicle. A receiving means of the guidance member accepting means is movable, wherein the receiving means is adapted to move from a closed to an open condition. Preferably, the receiving means is placed in the closed condition to receive a guidance member while the towing vehicle is being connected to the towed vehicle. When the coupling has been completed, the receiving means is preferably placed in the open condition to enable release of and removal of a guidance member positioned therein. Preferably, the receiving means is adapted to move laterally, longitudinally, vertically and/or horizontally or at so as to provide at least three degrees of freedom of movement.

Preferably, the receiving means is movable into a collapsed or compressed state. More preferably, the receiving means is sequentially collapsible through at least one stage and preferably, through three stages of collapse. Preferably, the movement is similar to a concertina where the various means are caused to at least partially fold or envelope one another. Preferably, there is a first stage, a second stage and a third stage wherein when in the third stage, the receiving means is in its most compressed state and when in the first stage, the receiving means is in a form adapted to receive the guidance means. Stage two is an intermediate point between stages one and three. The receiving means is preferably adapted to move between any of these three stages as required. For example, the receiving means may be moved from stage one directly to stage three or vice versa, but preferably it follows the procedure of being moved from stage one to stage two to stage three. Preferably, when the receiving means is placed in stage three, the accepting means may be in its fully collapsed state and in this state, it may remain in place in the vicinity of the gooseneck end of the trailer.

To enable the sequential collapsing of the receiving means, the receiving means is preferably substantially U-shaped having a base section with a substantially T-shaped opening therein. The base section may be the front portion of the receiving means and may have substantially perpendicular flange members extending outwardly therefrom, the flange members preferably being adapted to be mountable upon at least one side wall of the body of the accepting means and thereby straddle the body member therebetween. In this way, the receiving means may be movable relative to the body to create a variable opening to receive or remove the guidance member from the accepting means. Preferably, each flange member has positioned towards its end remote from the base section at least one opening, which opening is substantially parallel to its corresponding opening on the other flange member. These two openings may be substantially oblong slots, which enable the receiving means to be slidable relative to the body and which may also permit the receiving means to move longitudinally and vertically relative to the body member to which it may be secured. The receiving means may be attachable to the body member preferably by way of suitable fastening means, which are able to pass through the substantially oblong slots of the two opposed flange members. The or each fastening means may be a threadable and/or lockable bolt or bolts. More preferably, the bolt is provided with at least one spacer means locatable between the body member and each flange member. At least one other opening/recess may be positioned along and preferably at a substantially mid-way point on at least each one of the extending flange members. To the other opening, there may be aligned at least one corresponding lock means which may be inserted through the at least one other opening/s to secure the receiving means to the body of the accepting means. Preferably, there are on each flange member aligned along their length at least three other openings which openings may represent different stages. Preferably, there is a lock means to cooperate with at least one of the other openings on each flange member.

In this way, the overall width and/or height of the accepting means may be reduced to substantially be accommodated within the gooseneck area of the trailer to which it may be removably mountable. In this collapsed form, there may be a reduced likelihood of the accepting means protruding below the bottom edge of the gooseneck end of the trailer, thereby allowing it to remain affixed thereto and thus removing the necessity of it having to be decoupled from the trailer. In its most preferred form, when the receiving means is secured to the accepting means through the uppermost other opening, the base section of the accepting means is raised above the bottom edge of the gooseneck area of the trailer.

In a further preferred form of the invention, the improved collapsible receiving means is formed so as to be integral with the trailer,

In use, this embodiment provides for an accepting means that has two cooperating regions, the first comprising the receiving means and the second comprising the body of the acceptance means. The receiving means being preferably placed in a first stage via the lock means with respect to the body of the acceptance means and when so placed may be in a potentially forwardly slidable aspect with respect to the body and so placed may be able to receive the guidance member. As the motorized vehicle, holding the free remote end of the guidance member, is reversed the receiving means may be caused to slide backwardly until the front portion engages the complementary front portion on the body. Once the coupling has been completed, the lock means may be removed from the selected other opening on the flange member which may then allow the receiving means to be placed in the open condition to facilitate removal of the guidance member. The receiving means may successively then be moved into the closed condition relative to the body by collapsing it thereon whereby the receiving means partially envelopes and/or encloses the body. The relative degree of collapse is preferably achieved by the location of the lock in the openings on the flange members. The lock means when positioned may fix the receiving means into its selected position. In this way, the overall height of the accepting means may be reduced. When the accepting means is required to be used again, the reverse process to that described above may be applied.

Other aspects and preferred aspects are disclosed in the specification and/or defined in the appended claims, forming a part of the description of the invention.

The present invention has been found to result in a number of advantages, such as the following.

A lone operator may perform the operation of coupling a vehicle and a trailer and does not require a second person to provide exact directions for coupling to take place. The invention allows a lone operator to couple a vehicle to a trailer that is parked to one side of a fence or driveway, or when the trailer is located on an angle or steep slope. The features of the. device may remove the danger of a lone operator attempting to negotiate the coupling of a vehicle to a heavy and potentially unstable object, such as a wheeled trailer, which may not be easily controlled if it is not in a braked condition.

A further advantage is that the device may be easily installed on a standard trailer and does not interact with any other part of the trailer in use.

The first and second regions of the device are advantageously removable when not required, such as when the trailer is coupled and ready to be towed. The regions are also of a size that allows them to be transported within the boot of the vehicle and therefore also be readily accessible when required.

A particular advantage according to embodiments where the accepting means is permanently positioned on a towed vehicle is that the device may remain installed on a standard trailer and does not interfere with any other part of the trailer in use or in storage.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates a side view assembly of a boat-laden trailer attached to the rear of a vehicle in a stationary position, indicating the general relationship with a one embodiment of the guidance device of the invention.

FIG. 2 illustrates an aerial view of the assembly as shown in FIG. 1.

FIG. 3 illustrates a perspective view of the embodiment of FIG. 1 engaged with a trailer and tow bar of a vehicle.

FIG. 4 illustrates an exploded view of some aspects of the guidance device of FIG. 1.

FIG. 5 illustrates a perspective view of the trailer portion of the device according to on embodiment.

FIG. 6 illustrates an exploded view of the trailer portion of the device of FIG. 5.

FIG. 7a illustrates a detailed cut-away portion of the encircled portion of FIG. 6.

FIG. 7b illustrates a detailed cut-away portion of the second encircled portion of FIG. 6.

FIG. 8 illustrates the trailer portion of the device of FIG. 5.

FIG. 9 illustrates a side view of the trailer portion of the device of FIG. 5.

FIG. 10 illustrates a rear end view of the trailer portion of the device of FIG. 5.

FIG. 11 illustrates an aerial view of the interior of the trailer portion of the device with inserted guidance rod.

FIG. 12a illustrates an aerial view of the device of FIG. 5 and its action after the vehicle has been first placed within coupling distance of the trailer.

FIG. 12b illustrates an aerial view of the device of FIG. 5 and its action after the motor vehicle has reversed from the position view of FIG. 12a.

FIG. 12c illustrates an aerial view of the device of FIG. 5 with the guidance rod fully engaged.

FIG. 13 illustrates a perspective view of a second preferred embodiment of the device as attached to the trailer.

FIG. 14 illustrates a perspective view of the device of FIG. 13.

FIG. 15 illustrates a second perspective view of the device of FIG. 13.

FIG. 16 illustrates an aerial view of the device of FIG. 13.

FIG. 17 illustrates a frontal view of the device of FIG. 13.

FIG. 18 illustrates a side view of the device of FIG. 13.

FIG. 19 illustrates a rear cut-away view of a third preferred embodiment of the device of the invention, showing the positioning of the guidance rod therein after the vehicle has been placed within coupling distance of the trailer.

FIG. 20 illustrates an aerial cut-away view of the device of FIG. 19 with the guidance rod inserted.

FIG. 21 illustrates a further cut-away view of the device of FIG. 19.

FIG. 22 illustrates a further aerial perspective view of the device of

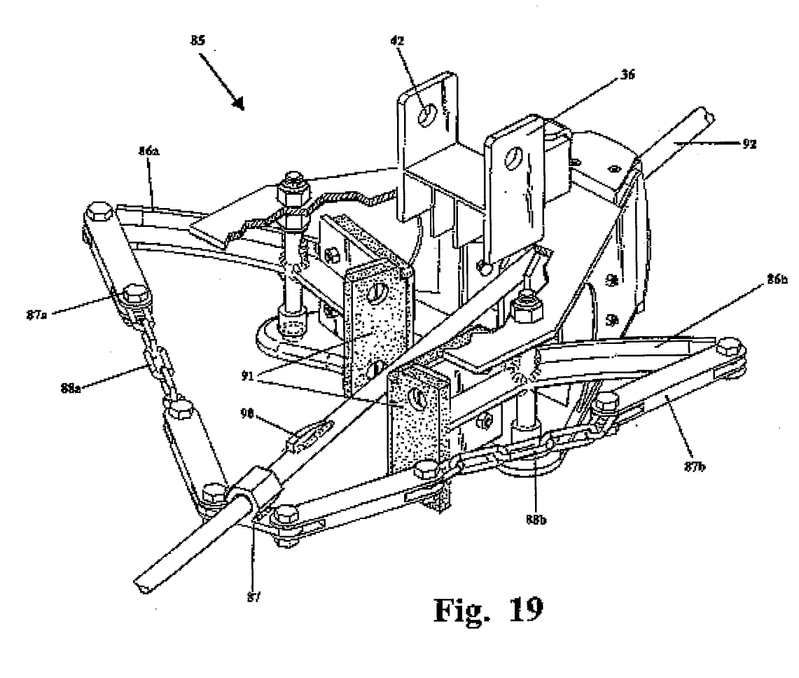

FIG. 19 in the fully engaged and aligned position.

FIG. 23 illustrates a further rear view of the device of FIG. 19.

FIG. 24a illustrates another aerial view of the device of FIG. 1 and its action after the vehicle has been first placed within coupling distance of the trailer.

FIG. 24b illustrates an aerial view of the device of FIG. 1 and its action after the motor vehicle has reversed from the position view in FIG. 24a.

FIG. 24c illustrates another aerial view of the device of FIG. 1 with the guidance rod fully engaged and showing the guidance rod being manually adjusted to bring the trailer into alignment.

FIG. 24d illustrates an aerial view of the device of FIG. 1 with the guidance rod fully engaged and the trailer aligned.

FIG. 25 illustrates an exploded view of some aspects the accepting means and the coupling means of the guidance device according to another embodiment in a closed condition.

FIG. 26 illustrates a perspective view of the accepting means of the device of FIG. 25 in an open condition.

FIG. 27 illustrates a cross-sectional view of the device of FIG. 26 in an engaged stage.

FIG. 28 illustrates an aerial view of the device of FIG. 26.

FIG. 29 illustrates an exploded view of some aspects of another preferred embodiment of a collapsible receiving means of the guidance device in accordance with the invention.

FIG. 30a illustrates a side view of the accepting means of FIG. 29 attached to the trailer portion of the device and prior to receiving the guidance member.

FIG. 30b illustrates a side view of the accepting means of FIG. 29 with the guidance rod fully engaged.

FIGS. 30c, 30d and 30e sequentially illustrate side views of the trailer being coupled to the tow ball of the vehicle and the receiving means of FIG. 29 being placed in an open condition to allow removal of the guidance member therefrom.

FIG. 30f illustrates a side view of the guidance member being removed from the receiving means of FIG. 29 and the accepting means being locked into a fully collapsed condition.

FIG. 30g illustrates a side view of the accepting means of FIG. 29 locked in a fully collapsed condition.

FIGS. 31a to 31e illustrate perspective views of a preferred embodiment of the collapsible accepting means.

FIG. 32 illustrates a perspective view of the accepting means of FIG. 31.

FIG. 33 illustrates a lock means and portions associated with the device of FIG. 32.

FIG. 34 illustrates a perspective view of one embodiment of a collapsible accepting means adapted to be fitted integral with the end portion of a trailer.

FIG. 34a illustrates a perspective view of an alternate preferred embodiment of a collapsible accepting means adapted to be fitted integral with the end portion of a trailer.

FIG. 35 illustrates a side view of the accepting means of FIG. 34.

FIG. 35a illustrates a side view of the accepting means of FIG. 34a.

FIG. 36 illustrates a perspective view of the accepting means of FIG. 34 in a closed condition.

FIG. 36a illustrates a perspective view of the accepting means of FIG. 34a in a closed condition.

FIG. 37 illustrates a perspective view of the receiving means of FIG. 34 placed in a condition to receive the guidance member.

FIG. 37a illustrates a perspective view of the receiving means of FIG. 34a placed in a condition to receive the guidance member.

FIG. 38 illustrates a perspective view of the accepting means of FIG. 34 in an open condition.

FIG. 38a illustrates a perspective view of the accepting means of FIG. 34a in an open condition.

FIG. 39 illustrates a perspective view of the accepting means of FIG. 34 in a fully collapsed condition attached to a trailer.

FIG. 39a illustrates a perspective view of the accepting means of FIG. 34a in a fully collapsed condition attached to a trailer.

FIG. 40 illustrates a rear cut-away view of the receiving means of FIG. 34, showing the positioning of the guidance rod therein without a centering means.

FIG. 40a illustrates a rear cut-away view of the receiving means of FIG. 34a, showing the positioning of the guidance rod therein without a centering means.

FIG. 41 illustrates a rear cut-away view of the receiving means of FIG. 34, showing the positioning of the guidance rod therein with one preferred form of centering means.

FIG. 41a illustrates a rear cut-away view of the receiving means of FIG. 34a, showing the positioning of the guidance rod therein with a preferred form of centering means.

FIG. 42 illustrates a rear cut-away view of the receiving means of FIG. 34, showing the positioning of the guidance rod therein with a another preferred form of centering means.

FIG. 43 illustrates an exploded view of part of a guidance member assembly and an attachment means for coupling the guidance member to a tow bar of a motor vehicle.

FIG. 43a illustrates an exploded view of part of a guidance member assembly and an attachment means for coupling the guidance member to a tow bar of a motor vehicle in accordance with an alternate preferred embodiment.

FIG. 44 illustrates a perspective view of an attachment means on the motor vehicle.

FIG. 44a illustrates a perspective view of a preferred embodiment of an attachment means on the motor vehicle.

FIG. 45 is a cross-sectional view of the device shown in FIG. 44 illustrating one form of the guidance member assembly.

FIG. 45a is a cross-sectional view of the device shown in FIG. 44a illustrating a preferred form of the guidance member assembly.

FIG. 46 is a front perspective view of a further embodiment of the accepting means.

FIG. 47 is a back perspective illustration of the device of FIG. 46 with an exploded view from above.

FIG. 48 is a front perspective illustration of the device of FIG. 46 with an exploded view from below.

FIG. 49 is a sectional side view of the device of FIG. 46.

FIG. 50 is a plan view of the device of FIG. 46.

FIG. 51 is a front view of the device of FIG. 46.

FIG. 52 is a rear view of the device of FIG. 46.

FIG. 53 is an exploded view of the assembly of part of the mechanism of the accepting means in accordance with one embodiment.

FIG. 54 is a sectional side view of an embodiment of the guidance device of the invention showing the device in close range of a vehicle tow ball and indicating planar movement of the guidance member and accepting means relative to a tow bar.

FIG. 55 is a sectional side view of an embodiment of the accepting means of the invention shown welded to a trailer as a permanent feature of the trailer and showing a preferred arrangement for maximising ground clearance of the device.

FIG. 56 is an exploded view of a guidance rod arrangement in accordance with an embodiment of the invention allowing three-way movement of the device.

FIG. 57 is an underneath plan view of an embodiment of the invention showing an alignment rod in a maximum off-centre position.

FIG. 58 is an underneath plan view of an embodiment of the invention showing a guidance rod in progressive alignment.

FIG. 59 is an underneath plan view of an embodiment of the invention showing an alignment rod in a centre position.

FIG. 60a is a schematic illustration of a guidance rod of an embodiment of the invention in a maximum off-centre position.

FIG. 60b is a schematic illustration of a guidance rod of an embodiment of the invention in progressive alignment.

FIG. 60c is a schematic illustration of a guidance rod of an embodiment of the invention in final alignment.

FIG. 61a is a front perspective view of an alternate arrangement for an accepting means of the invention.

FIG. 61b is rear perspective view of the alternate arrangement of FIG. 61a.

FIG. 62 is a front perspective view of a further alternate arrangement of an accepting means and guidance member assembly of the invention.

FIG. 63 is a rear perspective view showing a guidance rod engaged with the device of FIG. 62.

FIG. 64 is a perspective view of an alternate form of the accepting means of the invention shown as permanently fixed to a trailer.

FIG. 65 shows a perspective view of the device of FIG. 62 in a packed away configuration.

FIG. 66 is side view of the device of FIG. 62 engaging a guidance means of the invention.

FIG. 67 is a front view of the device of FIG. 62.

FIG. 68 is a rear view of the device of FIG. 62.

FIG. 69 is a plan view of the device of FIG. 62.

FIG. 70 is a perspective sectional view of the device of FIG. 62.

FIG. 71 is a front perspective view of the device of FIG. 62 engaging a guidance means of the invention showing the bottom plate in a swung open position for freeing the guide means for removal.

FIG. 72 is an exploded view of the assembly of the device of FIG. 62.

FIG. 73 is an underneath plan view of an alignment rod embodying the guidance member of the invention in a centre position within the device of FIG. 62.

FIG. 74 is an underneath plan view of an alignment rod embodying the guidance member of the invention in a maximum off-centre position within the device of FIG. 62.

FIG. 75 is an underneath plan view of an alignment rod embodying the guidance member of the invention in a progressive alignment position within the device of FIG. 62.

FIG. 76 is an underneath plan view of an alignment rod embodying the guidance member of the invention in a completed alignment within the device of FIG. 62.

FIG. 77 is a schematic diagram showing an alignment rod embodying the guidance member of the invention in a maximum off-centre position within the device of FIG. 62 with one chain connection thereof in tension.

FIG. 78 is a schematic diagram showing an alignment rod embodying the guidance member of the invention in a progressive alignment within the device of FIG. 62 with one chain connection maintained in tension.

FIG. 79 is a schematic diagram showing an alignment rod embodying the guidance member of the invention in a further progressive alignment within the device of FIG. 62.

FIG. 80 is a schematic diagram showing an alignment rod embodying the guidance member of the invention in a position where alignment has been completed.

FIG. 81 is a front perspective view of yet another embodiment of the accepting means of the present invention having a set of locating pins and corresponding slots for providing limited movement of a turntable arrangement.

FIG. 82 is a rear perspective view of the device of FIG. 81.

FIG. 83 is a rear perspective view from underneath of the device of

FIG. 81 showing a guidance member in an aligned position therewith.

FIG. 84 is a rear perspective view from underneath of the device of FIG. 81 showing a guidance member in a maximum off-set position therewith.

FIG. 85 is a perspective view of the device of FIG. 81 shown permanently fixed to a trailer.

FIG. 86 is a perspective view of the device of FIG. 81 in a packed away condition.

FIG. 87 is a front view of the device of FIG. 81.

FIG. 88 is a rear view of the device of FIG. 81.

FIG. 89 is a side view of the device of FIG. 81.

FIG. 90 is a plan view of the device of FIG. 81.

FIG. 91 is a sectional side view of the device of FIG. 81.

FIG. 92 is an underneath plan view of the device of FIG. 81.

FIG. 93 is a front perspective view of the device of FIG. 81 showing the device engaging a guide member of the invention in a maximum off-set position and a manually operated side bar engaged for operation to place the guide member into alignment.

FIG. 94 is a front perspective view showing the device of FIG. 81 in an open condition to allow removal of the guidance member.

### DETAILED DESCRIPTION

The present invention provides a coupling guidance device that is particularly useful as a means for enabling the coupling of a motor vehicle to a trailer, caravan or the like where the coupling guidance device comprises:

a first member adapted to be coupled to a first vehicle, the first member further adapted to be operatively associated with a guidance member for providing a guide path;

a second member adapted to be coupled to a second vehicle, the second member comprising a receptacle adapted to cooperate with the guidance member such that the first and second member are adapted to be moved relative to one another, the relative movement serving to bring the first vehicle and the second vehicle into closer proximity.

In preferred embodiments the receptacle of the second member may comprise movable receiving means adapted to move from an open to a closed condition for receiving the guidance member in the closed condition during the relative movement of the first and second member and for releasing the guidance member in the open condition upon the first and second vehicle being brought into closer proximity. The receiving means may comprise sequentially collapsible portions. Further the receiving means may be slidably engageable with a body portion of the second member.

The second member according to preferred embodiments of the invention may comprise first alignment means for providing progressive alignment of the guidance, member within the second member upon cooperation of the guidance member with the second member. Also, the second member may further comprise second alignment means for providing final alignment of the guidance member within the second member upon cooperation of the guidance member with the second member such that the first vehicle and the second vehicle are brought into closer proximity. Examples of the first and second alignment means are best illustrated in FIGS. 57 to 60. In particular 571, 581, 591 and 601 indicate a preferred form of the first alignment means in these figures and 570, 580, 590 and 600 indicate a preferred form of the second alignment means. The first and second alignment means are shown as swing arms in these figures. Alternately, the first and/or second alignment means may be a tensionable chain means arrangement, for example see FIG. 62 to 80. A preferred form of the tensionable chain means arrangement is best shown in exploded view in FIG. 72, which assists in the initial alignment of the guidance member as it engages the accepting means or second member of the present invention. Final alignment of the guidance member is also provided by the present invention after the chain means arrangement or the first alignment means shown in FIGS. 57 to 60 for example, has provided the initial alignment.

In one particular embodiment there is provided auxiliary adjustment means adapted for manual operation to provide final alignment of the guidance member upon cooperation with the second member.

In a preferred embodiment the second member further comprises articulation means for providing movement of the second member relative to the second vehicle. A preferred articulation means is shown, for example, in FIGS. 81 to 94. In this preferred arrangement the articulation means comprises a turntable arrangement for rotation of a portion of the second member in a horizontal plane. In particular, the articulation means further comprises a tooth arrangement for engaging the guide member. The articulation means, preferably in the form of a turntable provides further freedom of movement of the second member up to about 45 degrees to enable the guidance of two vehicles into proximity where the two vehicles are situated at such angle. Ordinarily, vehicles separated by such an angle would require substantial realignment and relative movement before they could be guided into closer proximity for enabling coupling of the two.

Preferably, the guidance member is pivotally coupled to the first member so as to allow one or more of substantial free lateral movement, and limited vertical movement of the guidance member when cooperating with the second member. Most preferably the coupling of the guidance member with the first member also allows limited planar movement of the guidance member relative to the first member.

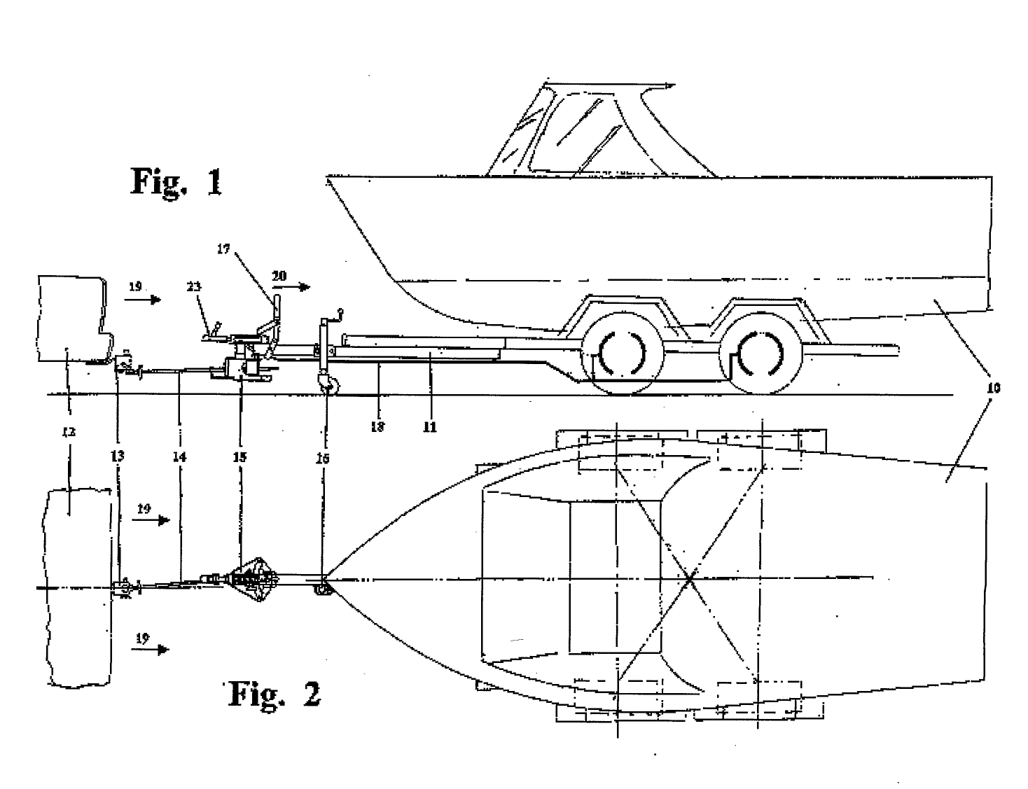

With particular reference to FIGS. 1 and 2, a side and aerial view is shown of a boat 10 and laden trailer 11, attached to the rear of a towing vehicle 12 in a stationary position, indicating the general relationship with a guidance device of an embodiment of the invention. FIGS. 1 and 2 show the basic elements of the guidance device, being a guidance member shown as rod 14, a second member shown as trailer-mounted guidance rod accepting means 15 and a first member shown as tow bar mounted guidance rod coupling means 13. Also shown are jockey wheels 16, trailer socket component 23 and a trailer braking system comprising handle 17 and braking cable 18. Arrows 19 on FIGS. 1 and 2 indicate the direction of travel of towing vehicle 12 relative to trailer 11 when the guidance device is used to couple the trailer 11 to the vehicle 12. Arrow 20 indicates the direction of travel of handle 17 to actuate the trailer braking system when the guidance device is in use.

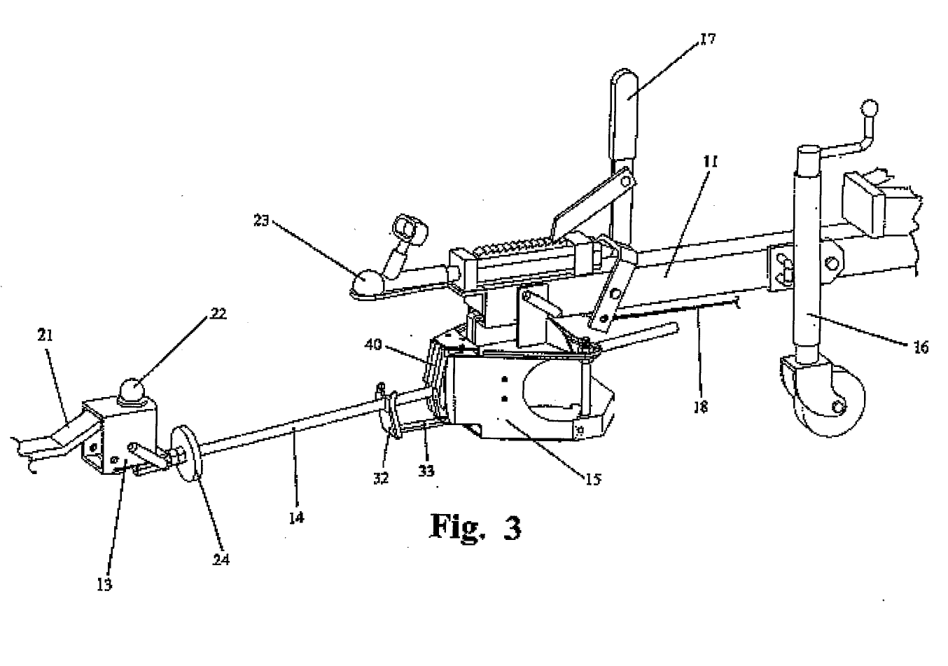

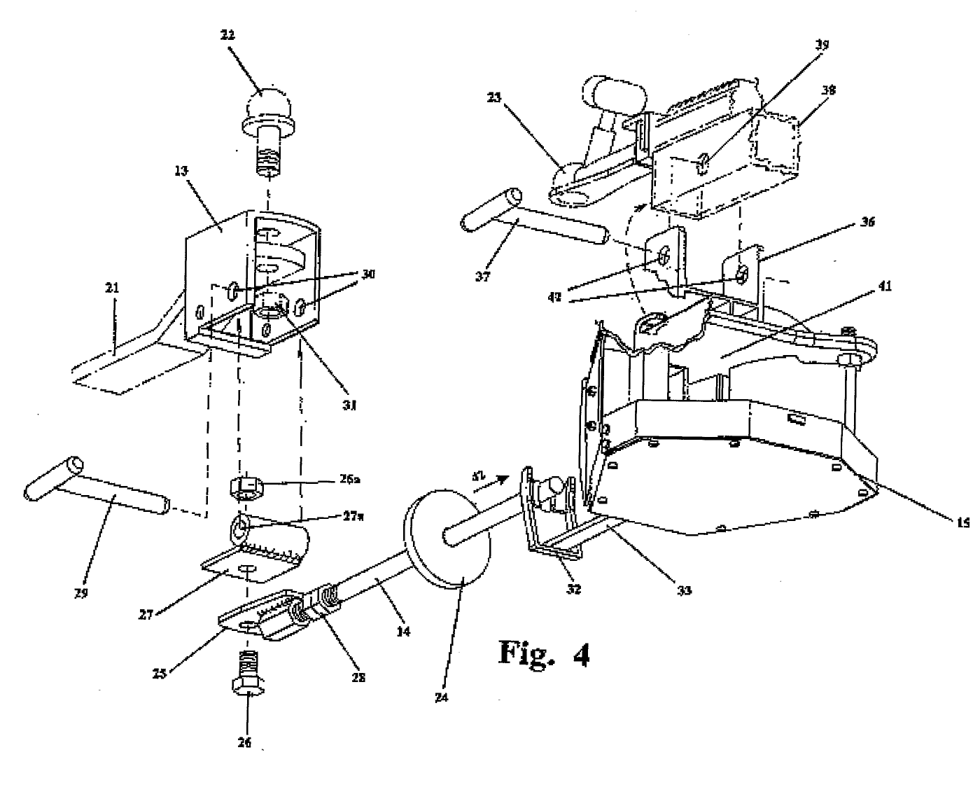

FIG. 3 shows a perspective view of the guidance member 14 as fixed to tow-bar 21 of vehicle 12 and inserted into accepting means 15 mounted to trailer 11. FIG. 4 provides an exploded view of components of the guidance device in relation to places of attachment only of tow-bar 21 of vehicle 12 and of accepting means 15 mounted to trailer 11. In particular reference to FIGS. 3 and 4, tow bar-mounted guidance member coupling means 13 fits over tow bar 21 by removal and replacement of tow bar ball 22, as held by threadable ball nut 31.

A first end of guidance rod 14 is adjustably mounted to coupling means 13 via attachment plate 25 by means of adjustable nuts 28, whereby the required length and position of stop member 24 on rod 14 can be fine tuned. Attachment plate 25 fits in a substantially complimentary fashion against vertical pivot means 27 and is secured by bolt 26 and nut 26a. Releasable tow-bar mounting pin 29 is inserted through passageway 27a of vertical pivot means 27 and openings 30 to releasably attach guidance rod 14 to coupling means 13, thereby allowing for substantial lateral and limited vertical movement of the rod 14.

In a preferred alternate arrangement, as best shown in FIGS. 54 and 56, a translational coupling arrangement is provided, which allows for vertical movement as indicated by arrow A. This arrangement effectively provides an extra degree of freedom of movement, which in combination with the pivotal mounting or coupling of guide rod 14 to coupling means 13 described herein, gives three-way movement of the guidance member relative to the first member 13. The apparatus comprising the guidance member and the accepting means as fixed in use to a trailer can then freely undergo limited vertical planar movement where the entire combination of these three elements can move in a limited fashion vertically up and/or down relative to the tow bar of a vehicle.

Again with reference to FIGS. 3 and 4, the second end of guidance rod 14 is received and support by U-shaped receiving means 32, which is attached to accepting means 15 by means of projecting bar 33 and fed firstly through front aperture 40 and then through rear aperture 41 of accepting means 15, until stop member 24 is brought into contact with receiving means 32, which is suitably shaped so as to enable the guidance rod 14 to facilitate alignment and engagement of receiving means 32 with pivot means 43. Arrow 42 of FIG. 4 indicates the direction of travel by guidance rod 14 as it enters the front aperture 40.

With particular reference to FIG. 4, locking pin 37 is inserted through openings 42 of channel flange 36 and openings 39 on a gooseneck portion of the trailer comprising trailer box beam 38, to removably attach accepting means 15 to trailer 11.

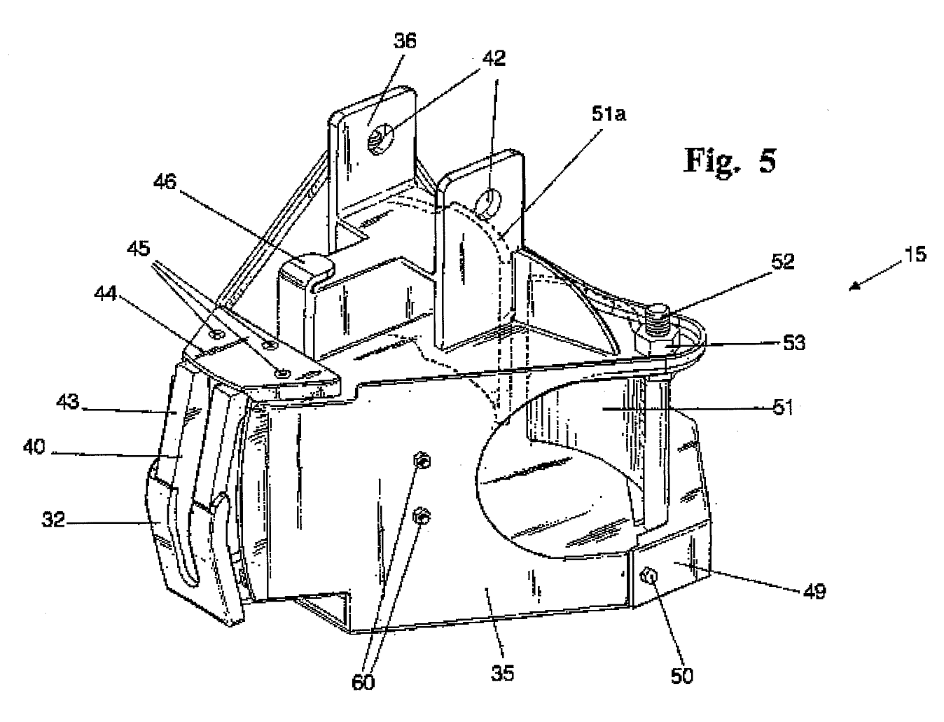

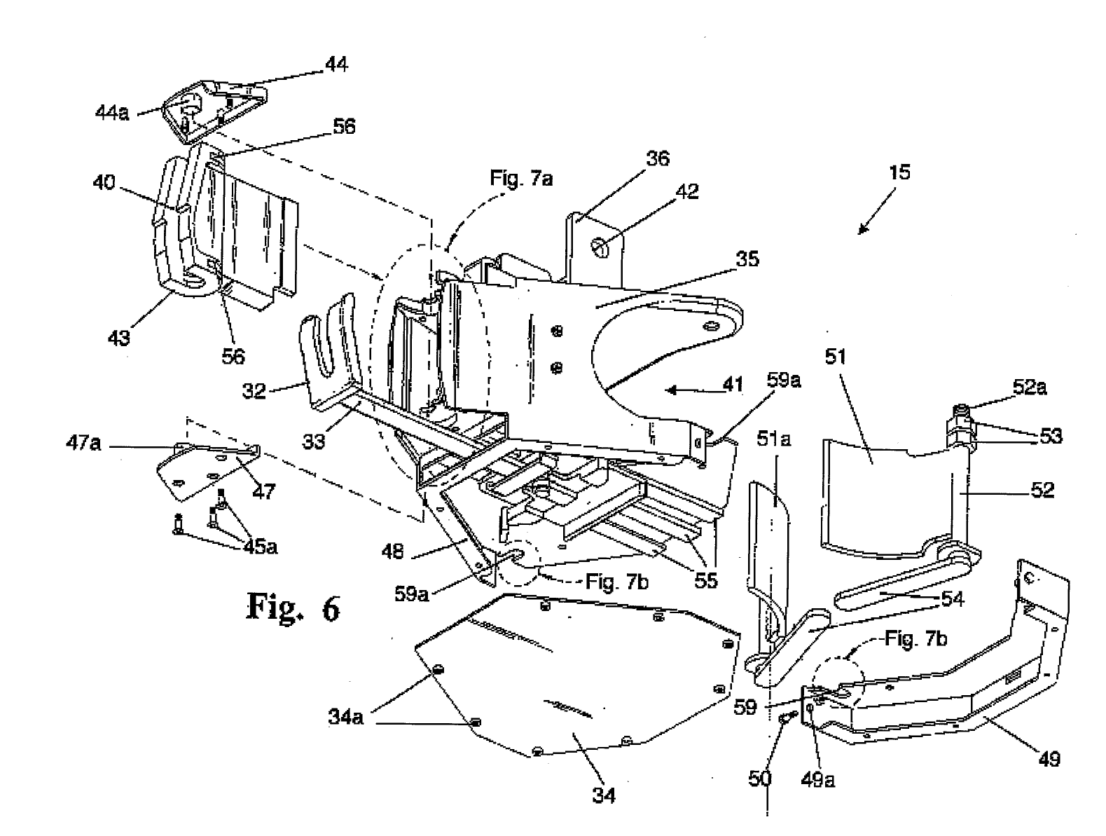

With particular reference to FIGS. 5 and 6, accepting means 15 comprises slidable receiving means 32, which when in the closed position, complementarily engages substantially horse-shoe spaced pivotal member 43 to constitute front aperture 40. Pivot member 43 is secured to the main body 35 of the accepting means 15 by removable retaining plates 44 and 47 by screws 45 and 45a, respectively. Retaining plates 44 and 47 comprise pivot means 44a and 47a, which are adapted to cooperate with pivot member 43 enabling it to pivot. The main body 35 of accepting means 15 is fitted with returns 48 for increased strength in use of the invention. Hook flange 46 cooperates with the leading end of trailer box beam 38 to assist cooperative interaction between guidance rod 14 and accepting means 15.

With particular reference to FIG. 6, components of the rear of accepting means 15 are shown. Rear aperture 41 is variable in size according to the open or closed state of doors 51 and 51a, which are pivotally mounted upon the main body 35 of accepting means 15 by pivot bolts 52a, as secured by nuts 53. The opening of doors 51 and 51a are directly controlled by movement of door levers 54, which cooperate with carriage means 57 slidably mounted on rails 55 upon insertion of guidance rod into the cavity of the accepting means 15. This mechanism is further explained in later figures.

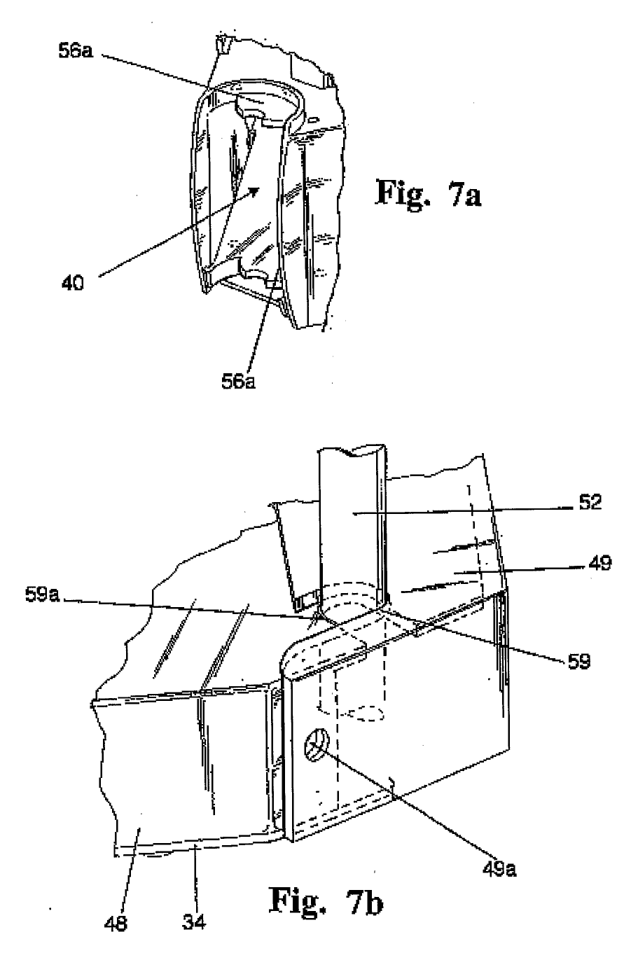

The underside of accepting means 15 is enclosed by a removable base plate 34, secured by a plurality of bolts 34a and base casing 49. The detail of how base casing 49 interacts with the supports 52 of doors 51 and 51a, return 48 and base plate 34 is shown by reference to FIG. 7b which shows complementary cut-out recesses 59 and 59a, which cooperate to create a passageway in which to accommodate and facilitate rotation of supports 52. Casing aperture 49a for bolt 50 is also shown in FIG. 7b. FIG. 7a indicates particular detail of the front aperture 40 of accepting means 15. Pivot member 43 is received and retained within front aperture 40 by means of slots 36 receiving tongue members 56a to facilitate movement of pivot member 43 relative to accepting means 15.

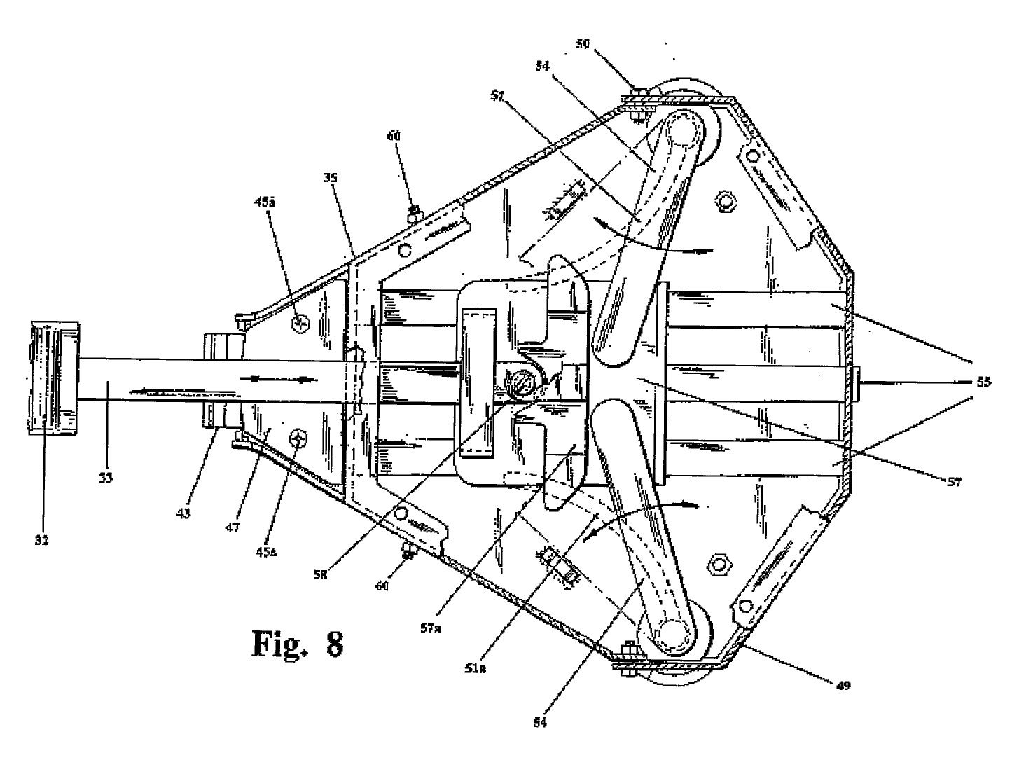

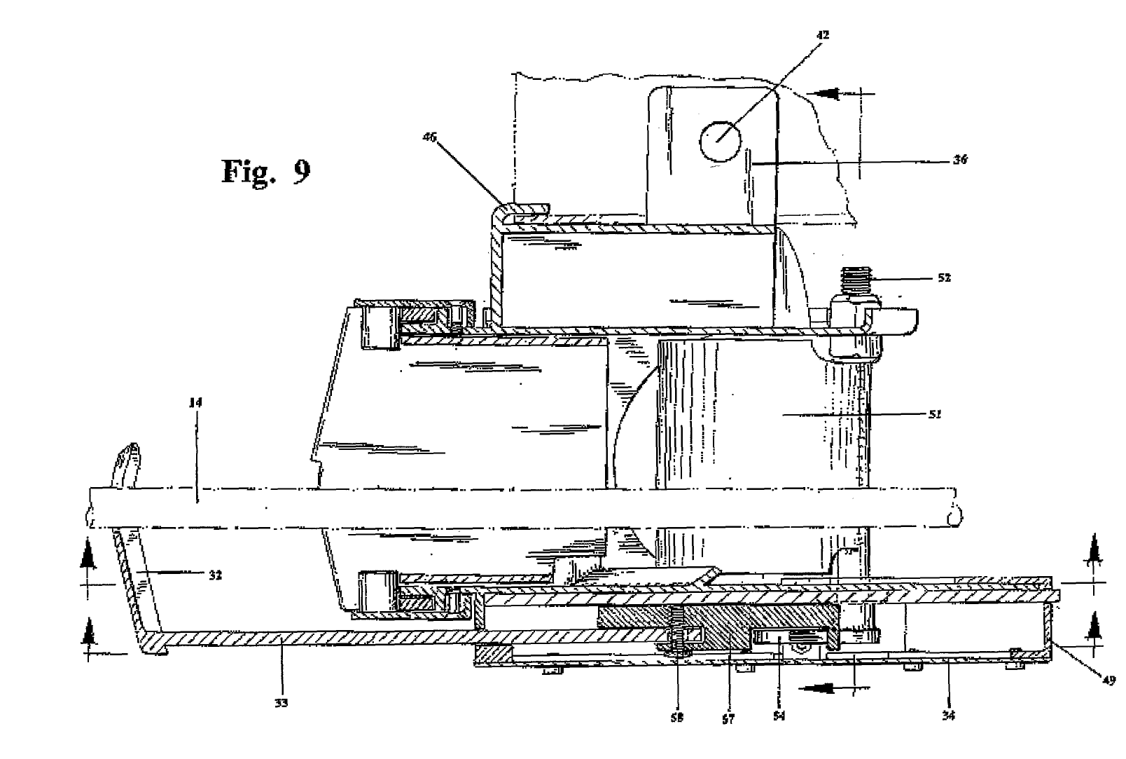

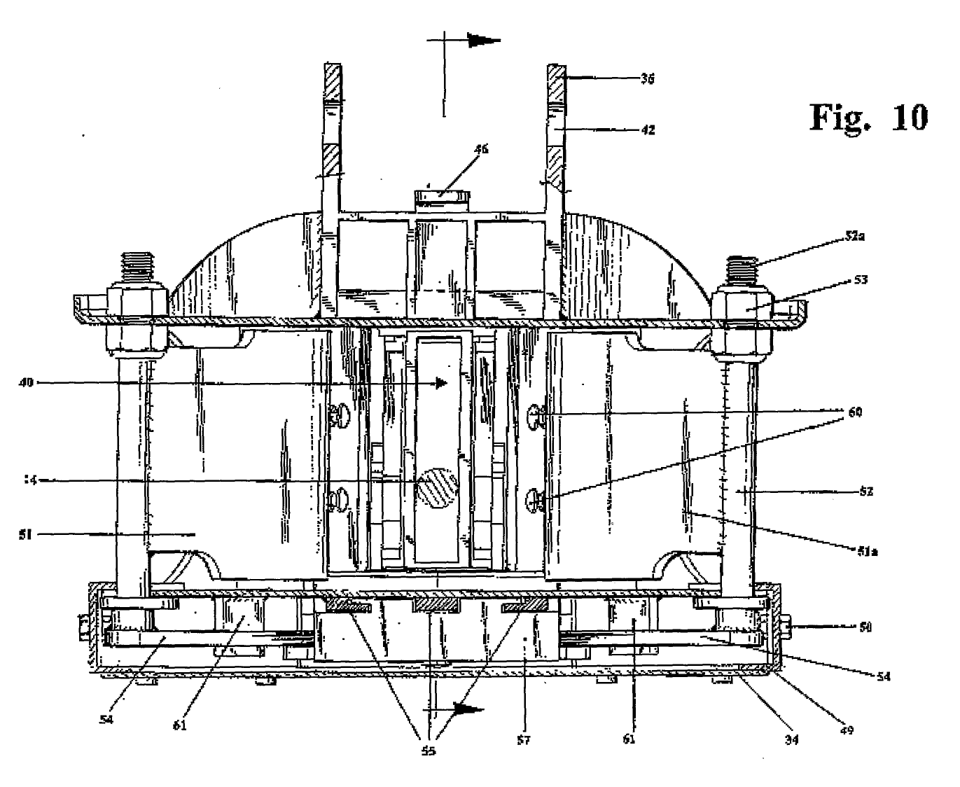

With particular reference to FIGS. 8, 9 and 10, guidance rod 14 is inserted through front aperture 40, having been received by receiving means 32 and then through the rear aperture 41, until stop member 24 contacts receiving means 32, which is caused to move towards the acceptance means 15 by slidable engagement with carriage 57 which, moving on rails 55, simultaneously actuates door levers 54. Door levers 54 cause corresponding pivotal movement of doors 51 and 51a, which in turn close rear aperture 41 to engage guidance rod 14 in a substantially rigid abutment. Rails 55 provide alignment and restrict vertical movement of the carriage 57 by means of a hook and eye arrangement. Bar 57a, which is pivotally mounted to projecting bar 33 in a substantially T-shaped configuration and also to carriage 57 by pivot means 58, is able to pivot laterally about pivot means 58 when acted upon by door levers 54. Rails 55 further provide structural support to accepting means 15.

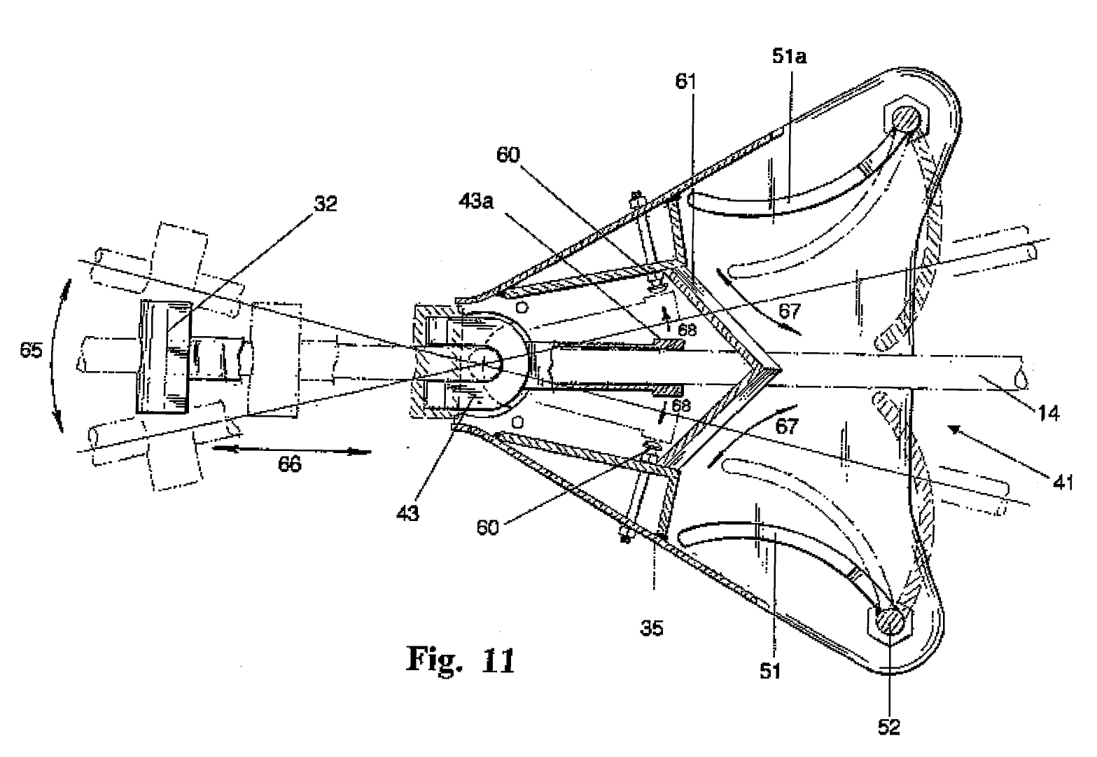

With reference to FIG. 11, arrow 65 indicates the lateral movement of rod 14 relative to acceptance means 15. Arrow 66 indicates the potential movement of rod 14 in and out of acceptance means 15. Arrows 67 indicate the potential movement of doors 51 and 51a in response to indirect interaction with rod 14, as described above. Arrows 68 indicate the movement of pivotal member 43 when in support of guidance rod 14. Lateral movement of pivotal member 43 is adjustably limited by bolts 60 to open or restrict the lateral movement of the guidance rod 14 and pivotal member 43 within the rear aperture 41, or as determined by the state of doors 51 and 51a. A kick plate 61 coacts with rod 14 to direct correct movement thereof through to the rear aperture 41 thereby providing rigid support to acceptance means 15.

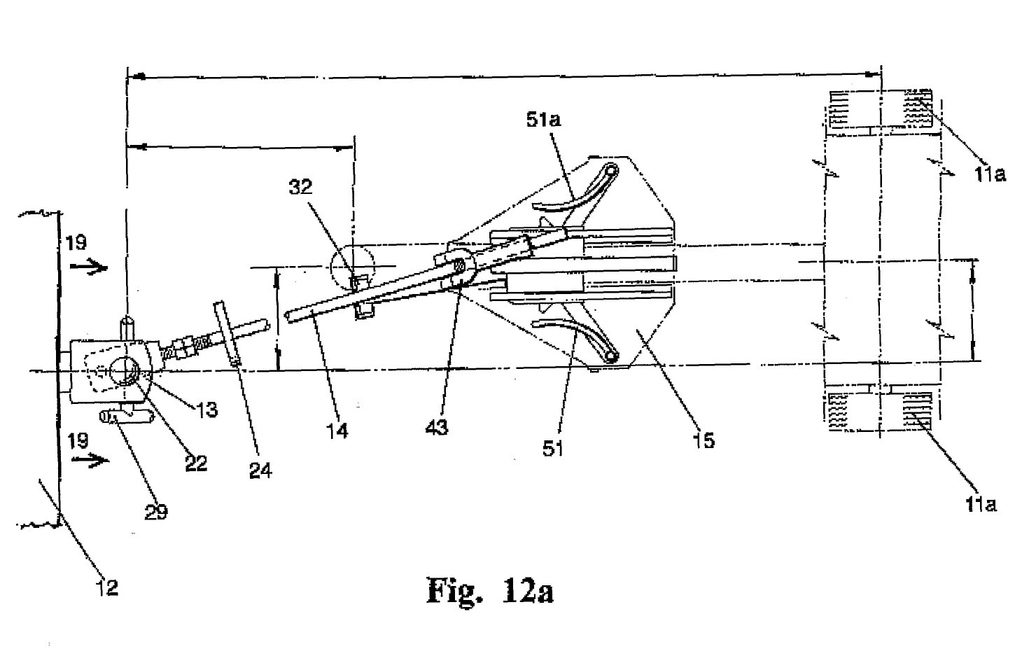

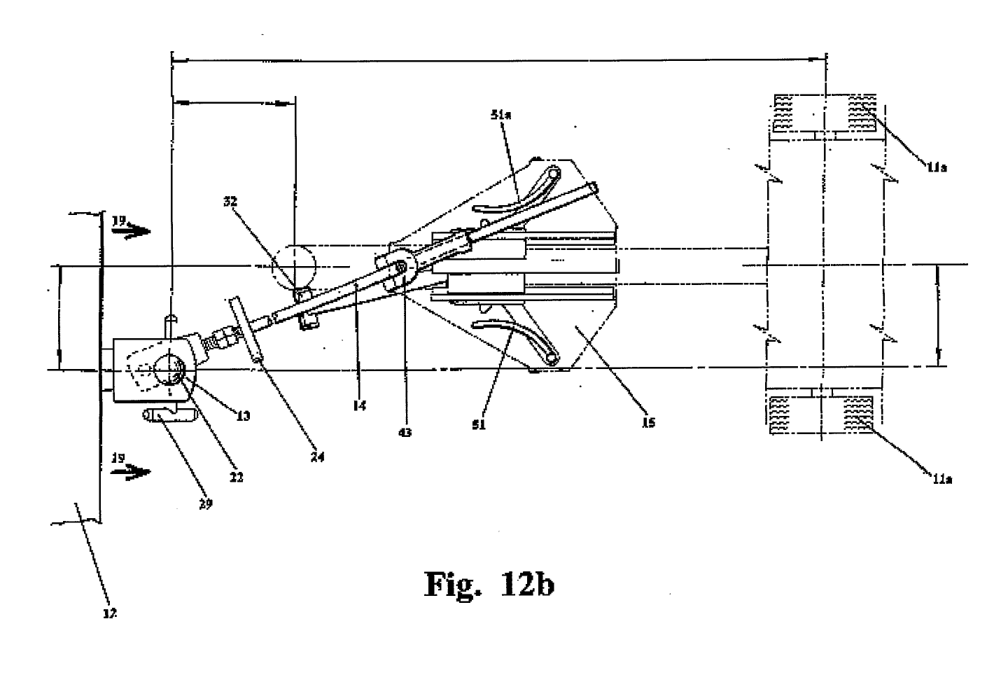

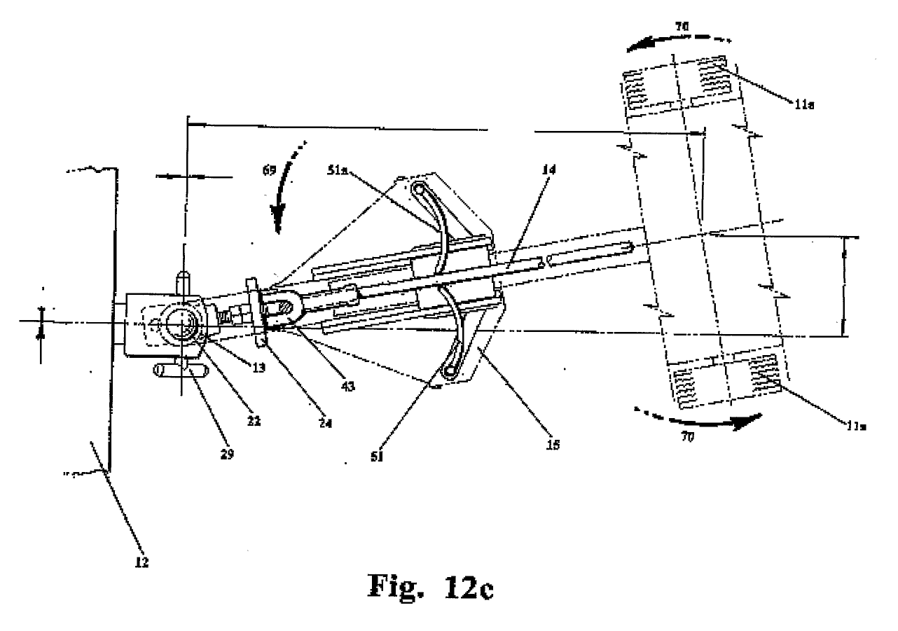

FIGS. 12a, 12b and 12c show the sequential movement of components of the invention in use according to one embodiment. An operator must initially. affix coupling means 13 and accepting means 15 to their respective mounting positions on both towing and towed vehicle, as particularly shown in FIG. 4. To begin the vehicle coupling process, an operator engages the trailer brake handle 17 to set trailer braking system 18 in place. This prevents the wheels 11a from rolling and trailer 11 from moving whilst the coupling process is occurring. The operator then moves the towing vehicle 12 to substantially within coupling distance from the trailer 11, as indicated particularly by FIG. 12a. The leading end of rod 14 is first connected to coupling means 13 by operation of releasable mounting pin 29. The operator then places the second end of guidance rod 14 into the supporting member 32 and through front aperture 40 of acceptance means 15. With rod 14 connected and associated with both coupling means 13 and accepting means 15, the operator then proceeds to reverse the towing vehicle 12 backwards (arrows 19) towards the trailer 11, at which point the respective coupling devices of each are still unaligned, as shown in FIG. 12a. With particular reference to FIG. 12b, rod 14 continues to penetrate accepting means 15 as the towing vehicle reverses backwards. Rod 14 is capable of substantial lateral and limited vertical movement to accommodate differences in height, as approximately pre-determined by jockey wheel 16, and alignment between each vehicle. FIG. 12b shows positioning of rod 14 in substantial abutment against door 51a in the open position.

FIG. 12c indicates the final position of the towed and towing vehicles, which enables coupling of tow bar ball 22 and trailer socket 23. In this position, trailer wheels 11a have been caused to move in the directions indicated by arrows 70. Arrow 69 indicates the direction of which trailer 11 has moved to allow respective alignment of coupling means 13 and acceptance means 15. With the reversing of the towing vehicle, stop member 24 is brought into contact with receiving means 32, which moves towards the acceptance means 15 to cooperate with doors 51 and 51a, as described above, such that doors 51 and 51a close to engage and centrally position guidance rod 14 in both rear aperture 41 and front aperture 40. This process of alignment moves the free attachable end of the trailer 11 to pivot about the braked wheels 11a as shown by arrows 70, thereby aligning the trailer with the towing vehicle. With alignment complete, under the power of the towing vehicle, the coupling of tow bar ball 22 and trailer socket 23 can be completed and coupling guidance device of the Invention removed and stored for later use. It should be noted that each component of the device is capable of separation from each other component, and from the towed and towing vehicles.

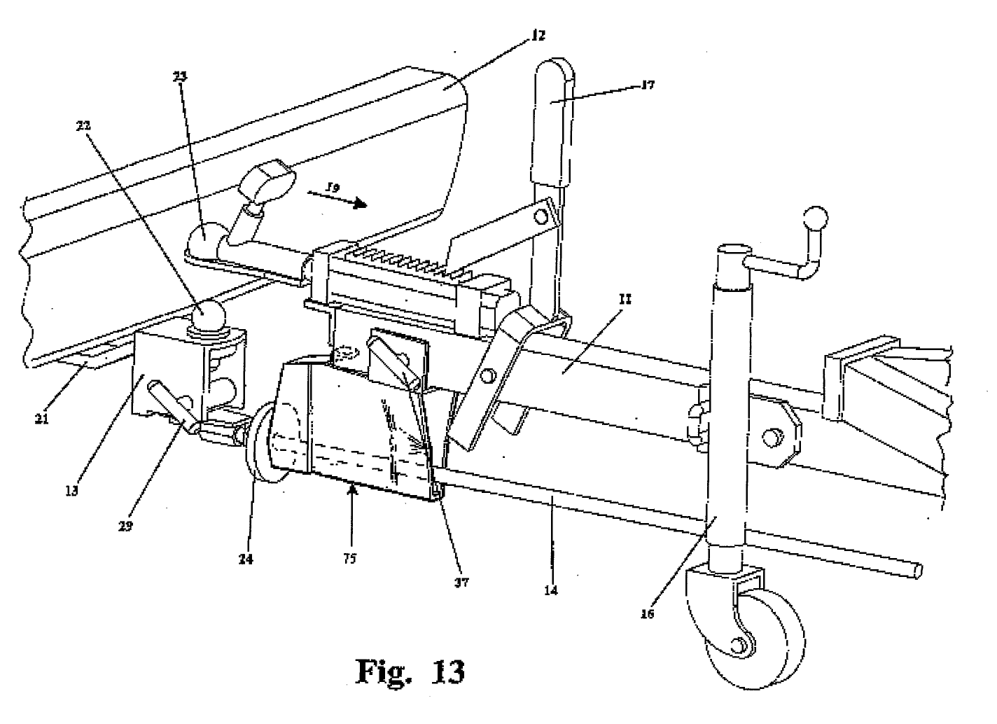

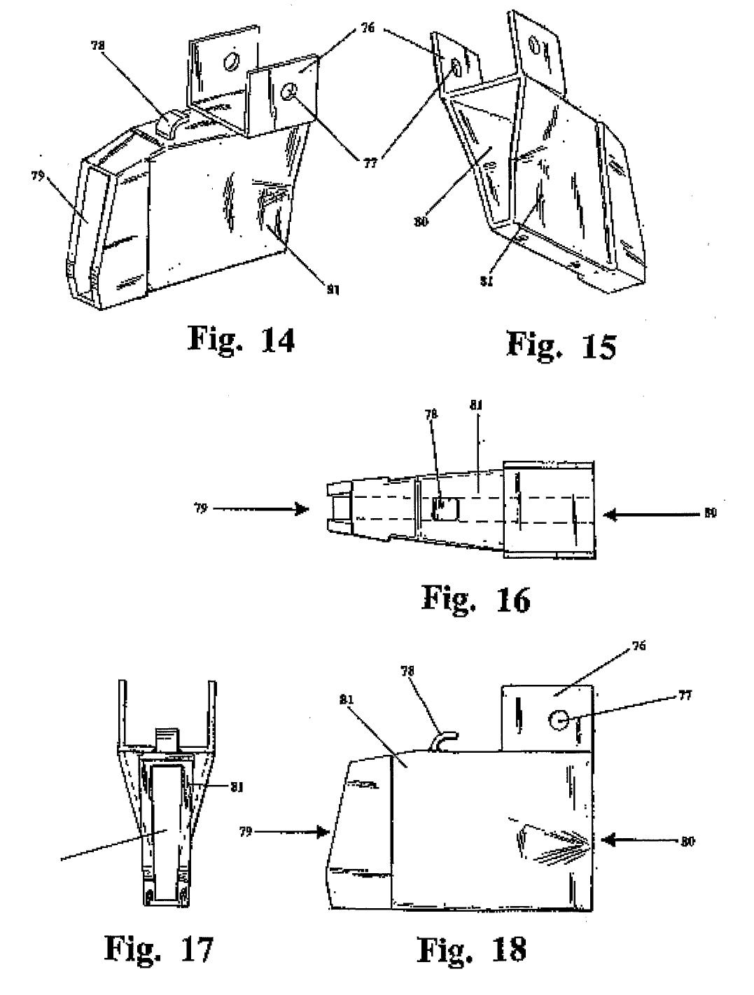

FIG. 13 shows a second preferred embodiment of the guidance acceptance means 75 in use with each previously described component of the invention and respective vehicles. FIG. 13 shows both vehicles in alignment following use of the second preferred embodiment. Referring to each of FIGS. 14 to 18, acceptance means 75 comprises a solid main body 81 that is of rigid construction, defining a substantially V-shaped interior with a front aperture 79 and rear aperture 80, a U-shaped bracket 76 with opening 77 for removable attachment to trailer 11. Hook flange 78 engages with trailer 11 for additional strength and alignment of the device.

In use, acceptance means 75 is attached to trailer 11. An operator must initially affix coupling means 13 and accepting means 75 to their respective mounting position on both towing and towed vehicle, respectively, as previously described for the first preferred embodiment. To begin the vehicle coupling process, an operator engages the trailer brake handle 17 to set trailer braking system 18 in place. This prevents the wheels 11a from rolling and trailer 11 from moving whilst the coupling process is occurring. The operator then moves the towing vehicle 12 to substantially within coupling distance from the trailer 11, and connects the leading end of guidance rod 14 to coupling means 13 by operation of releasable mounting pin 29. The second end of rod 14 is then fed through front aperture 79 of acceptance means 75. With rod 14 connected and associated with both coupling means 13 and accepting means 15, the operator then proceeds td reverse the towing vehicle 12 backwards (arrow 19) towards the trailer 11. Rod 14 proceeding through accepting means 75 as the towing vehicle 12 reverses backwards is capable of lateral and vertical movement to accommodate the differences in height, as approximately pre-determined by jockey wheel 16, and alignment between each vehicle. It is also noted that an arrangement as mentioned with reference to FIGS. 54 and 66 may also allow limited vertical planar movement of rod 14. The reversing of the towing vehicle continues until stop member 24 engages directly with front aperture 79. With alignment complete, under the power of the towing vehicle, the coupling of tow bar ball 22 and trailer socket 23 can be completed and the coupling guidance device of the invention removed and stored for later use. As previously described, each component of the device is capable of separation from each other component, and from the towed and towing vehicles.

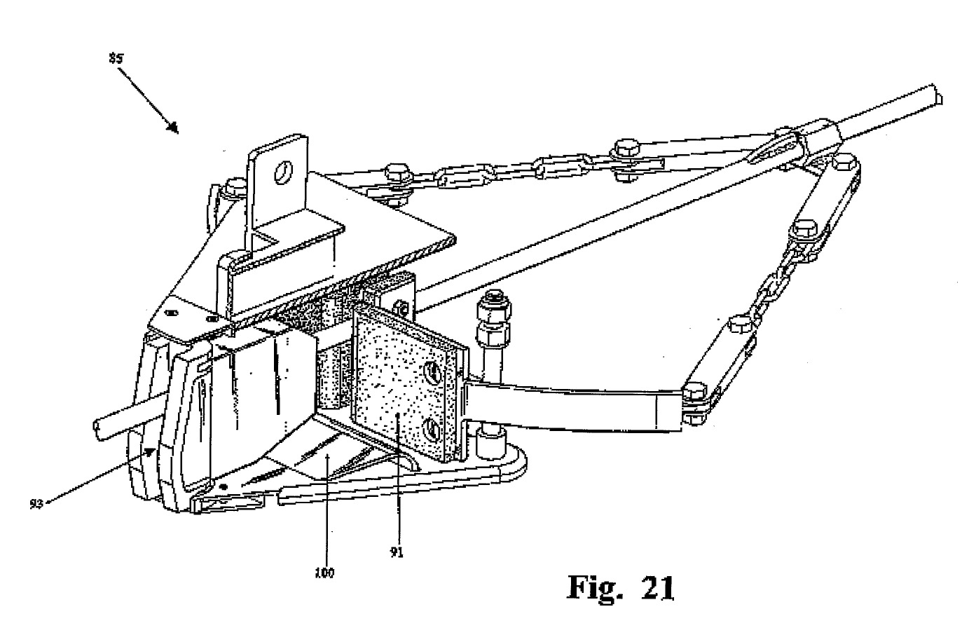

With particular reference to each of FIGS. 19 to 23, and further reference to preceding figures as necessary, a third preferred embodiment of guidance acceptance means 85 is described. Acceptance means 85 comprises the same basic structure as that of acceptance means 15. Acceptance means 85 differs from component 15 in the use of pivoted gripping arms 86a and 86b, which are caused to close by interaction with arm tethers 87a and 87b and guidance rod 92. Arm pads 91 complementarily fit against portions of arm tethers 87a and 87b that interact with guidance rod 92. Guidance rod 92 differs from guidance rod 14 only by the addition of a protrusion 90, which resiliently interacts with guidance member socket 87 of acceptance means 85.

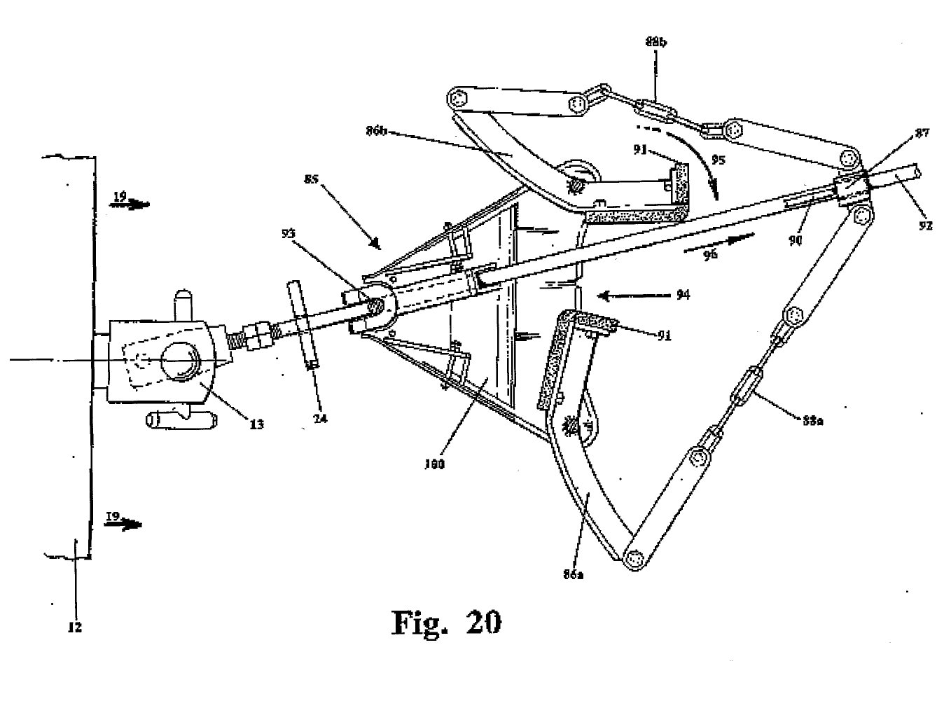

In use, acceptance means 85 is attached and assembled with each other previously described component of the invention in same manner as other preferred embodiments described above. An operator must initially affix coupling means 13 and accepting means 85 to their respective mounting positions on both the towing and towed vehicle, respectively. To begin the vehicle coupling process, an operator engages the trailer brake handle 17 to set trailer braking system 18 in place. This prevents the wheels 11a from rolling and trailer 11 from moving whilst the coupling process is occurring. The operator then moves the towing vehicle 12 to substantially within coupling distance from trailer 11 and connects the leading end of guidance rod 92 to coupling means 13 by operation of releasable mounting pin 29. The second end of rod 92 is then fed through front aperture 93 of acceptance means 85 to allow movement towards rear aperture 94 by contact with guiding plate 100, as shown in FIG. 20. Rod 92 is then guided to penetrate guidance member socket 87, with flexibility in this attachment being provided by tether chains 88a and 88b. With rod 92 connected and associated with both coupling means 13 and accepting means 85, the operator then proceeds to reverse the towing vehicle 12 backwards towards the trailer 11. As rod 92 continues to proceed through accepting means 85 as the towing vehicle 12 reverses backwards, it is capable of lateral and vertical movement to accommodate the differences in height, as approximately pre-determined by jockey wheel 16, and alignment between each vehicle. It is also noted that an arrangement as mentioned with reference to FIGS. 54 and 56 may also allow limited vertical planar movement of rod 92.

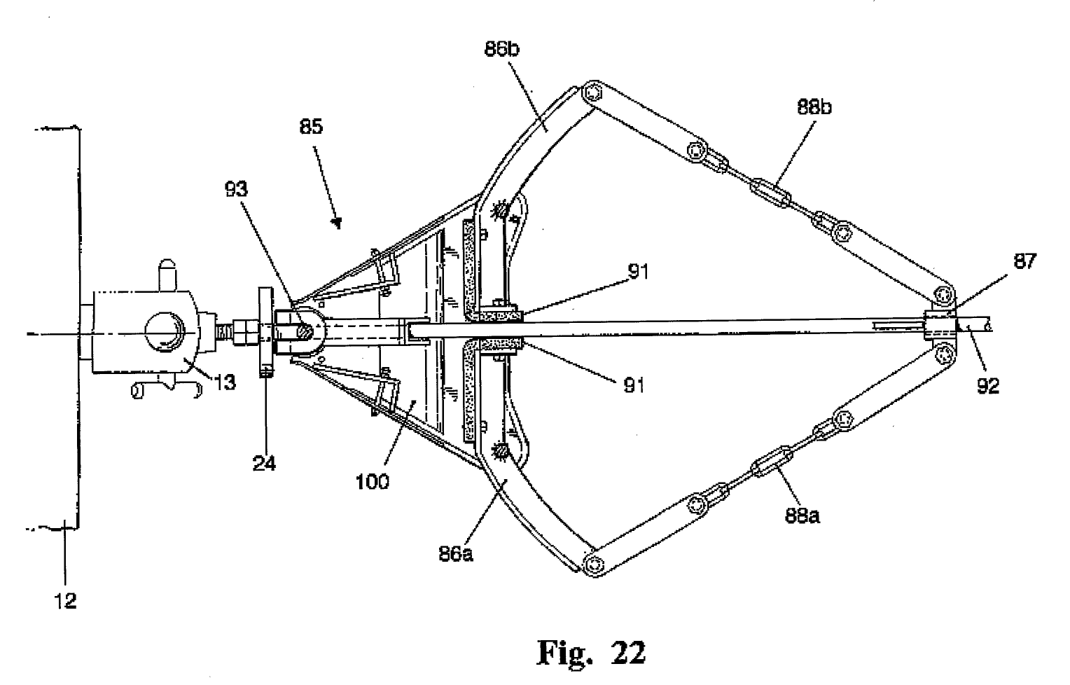

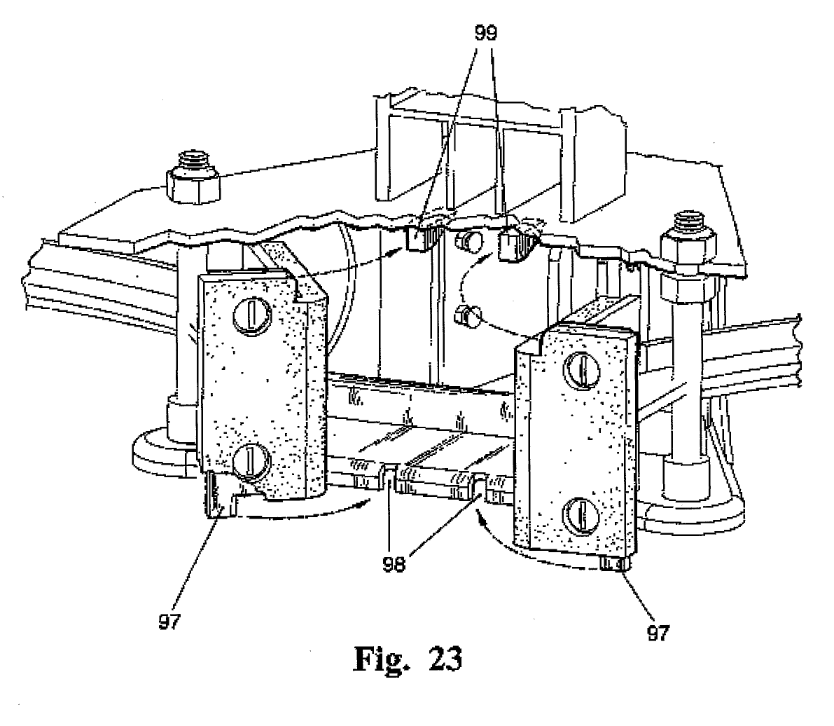

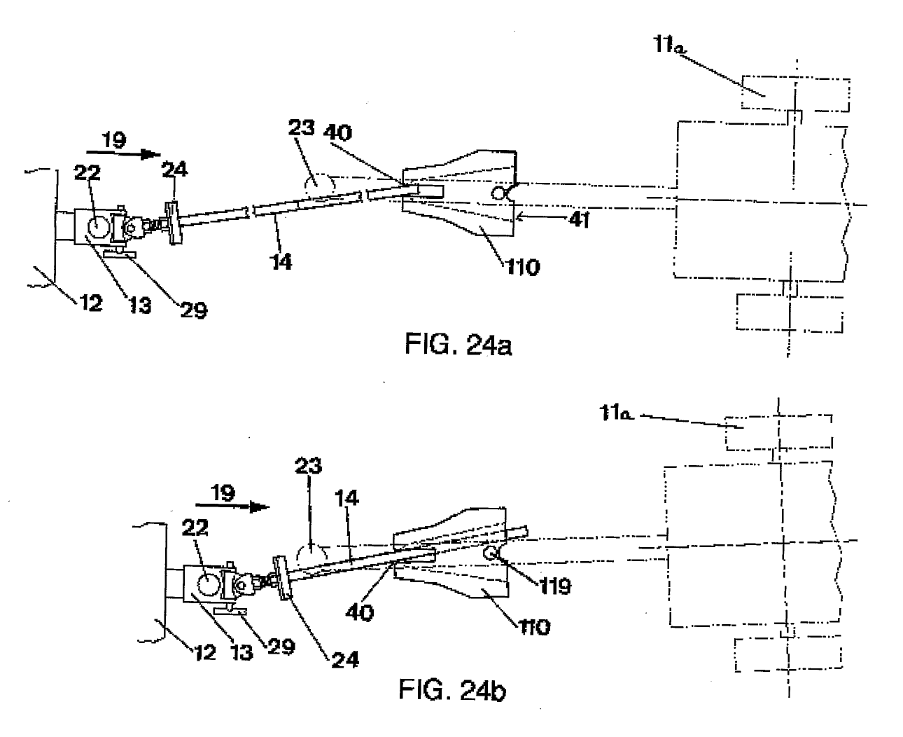

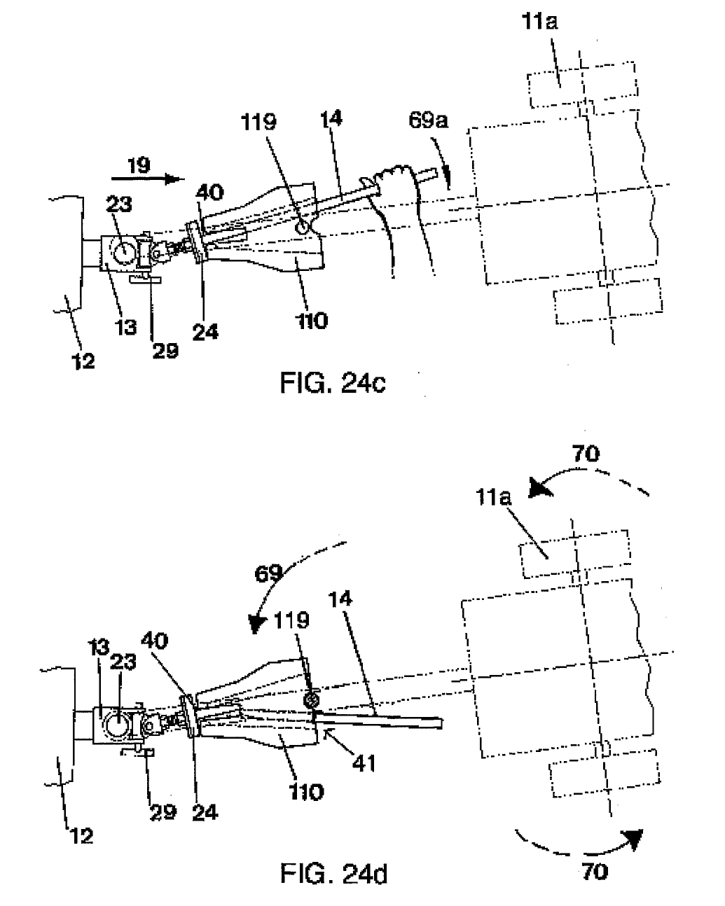

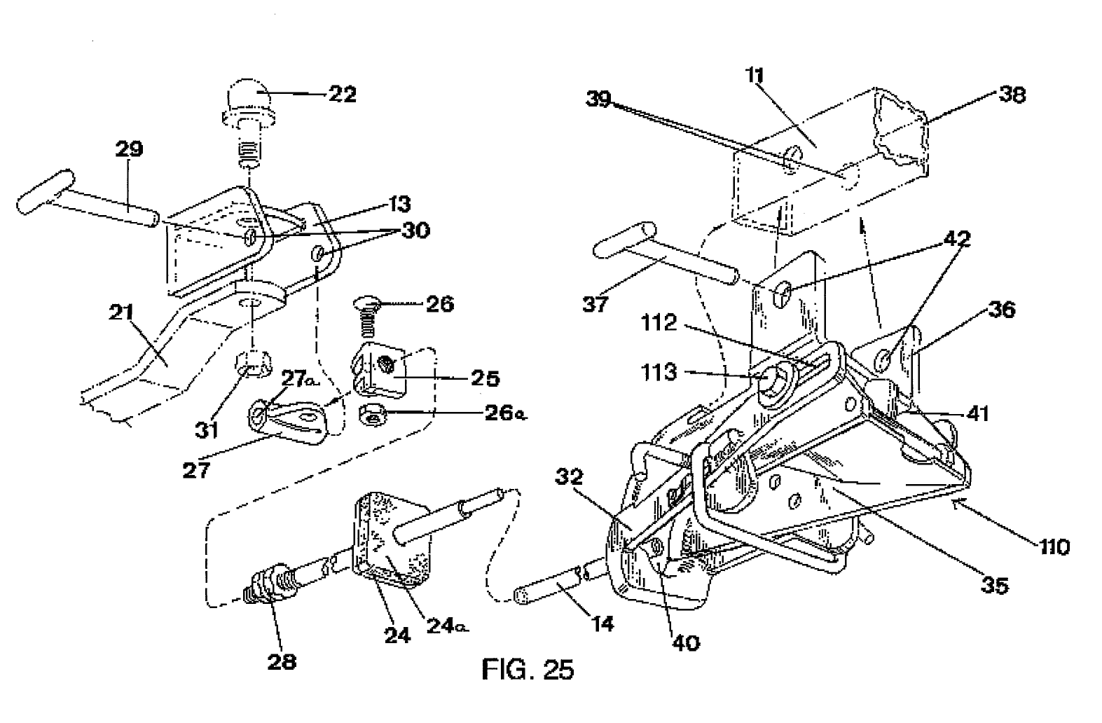

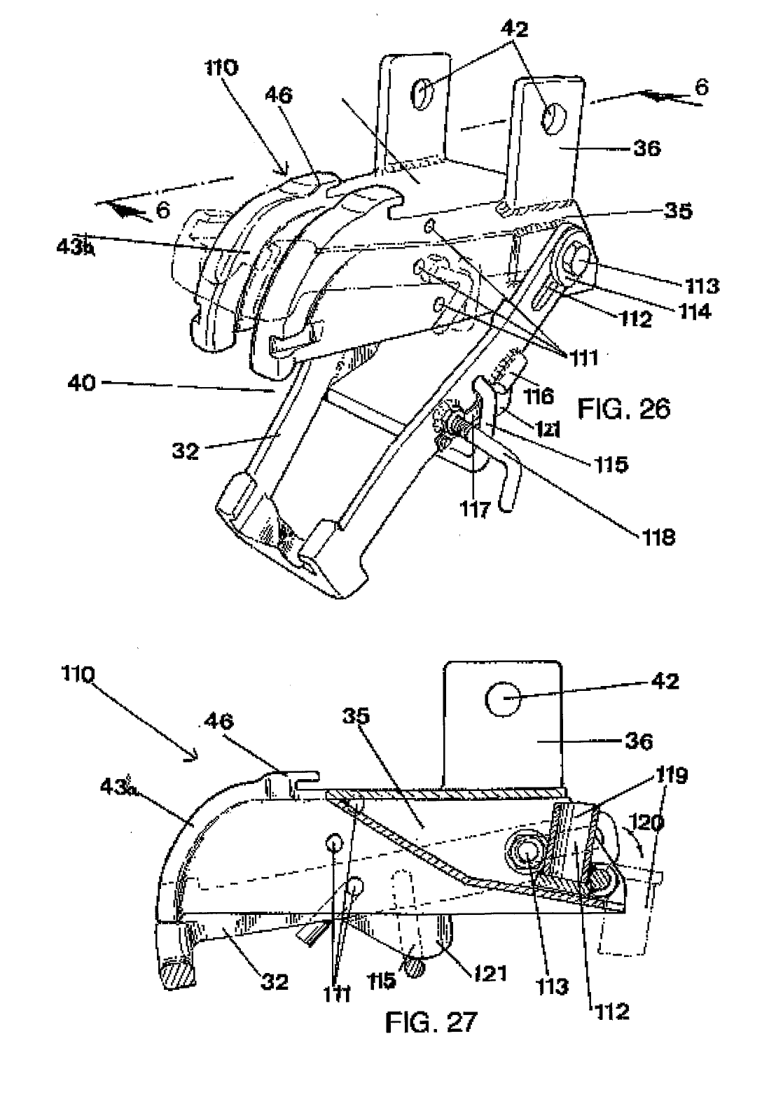

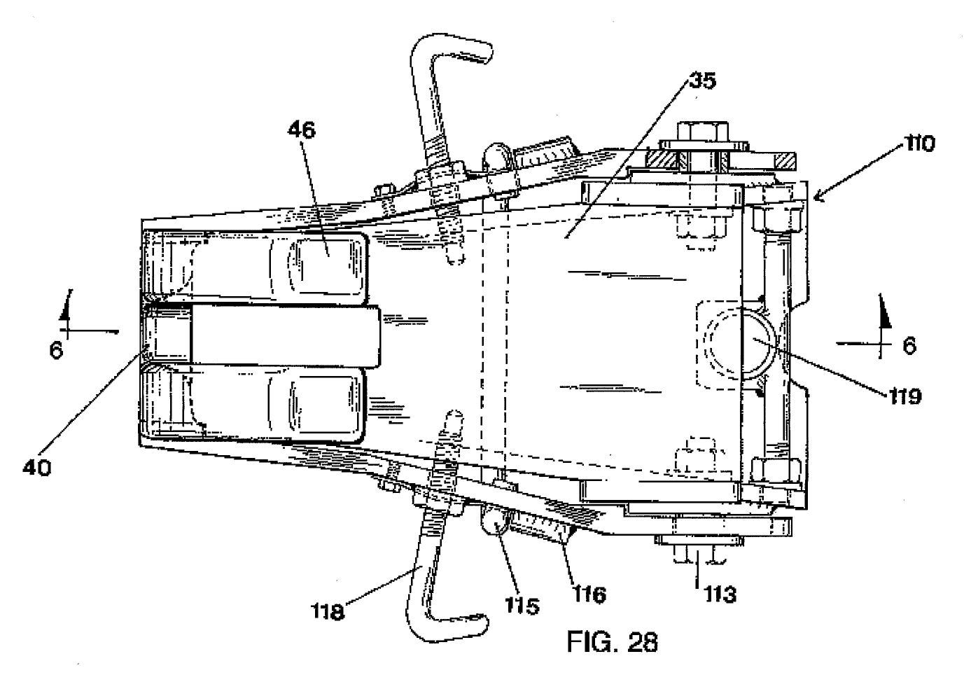

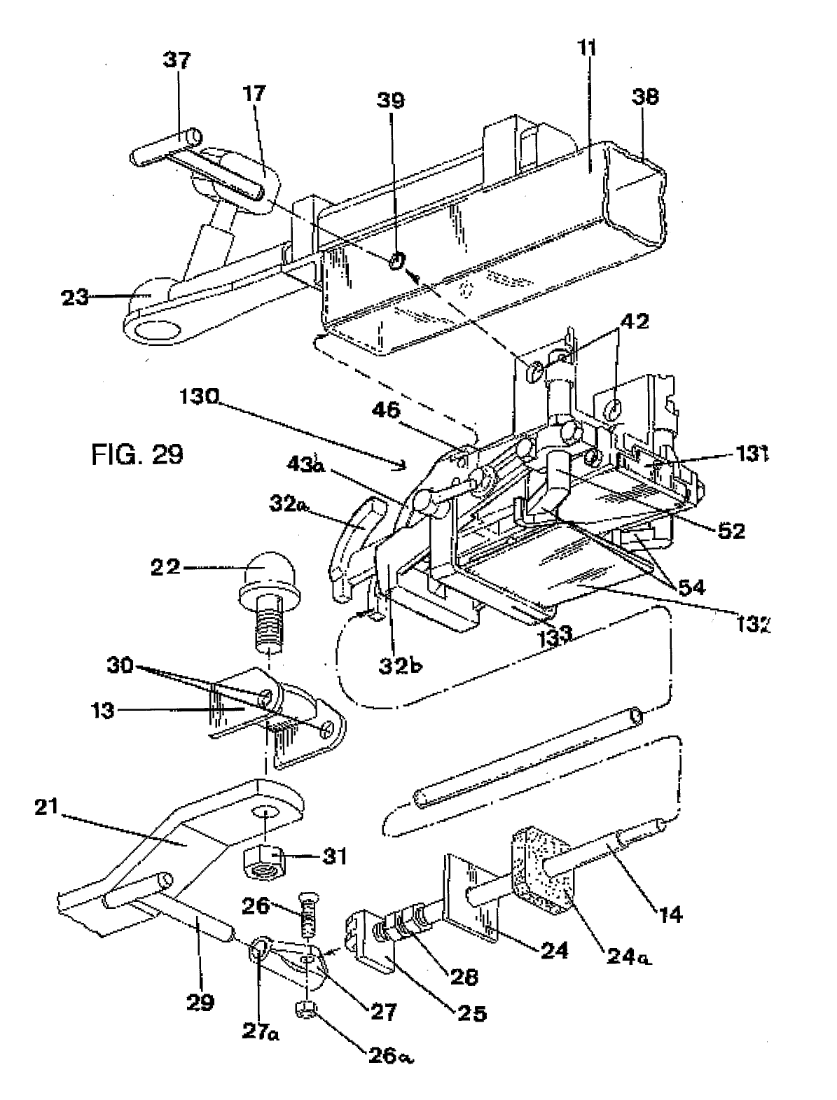

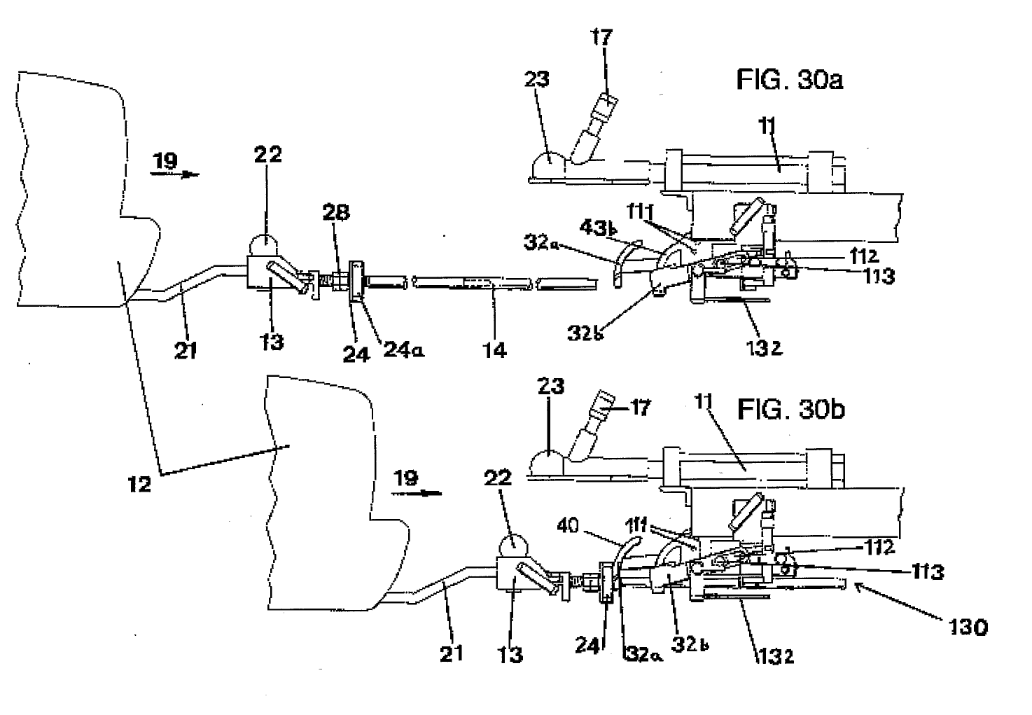

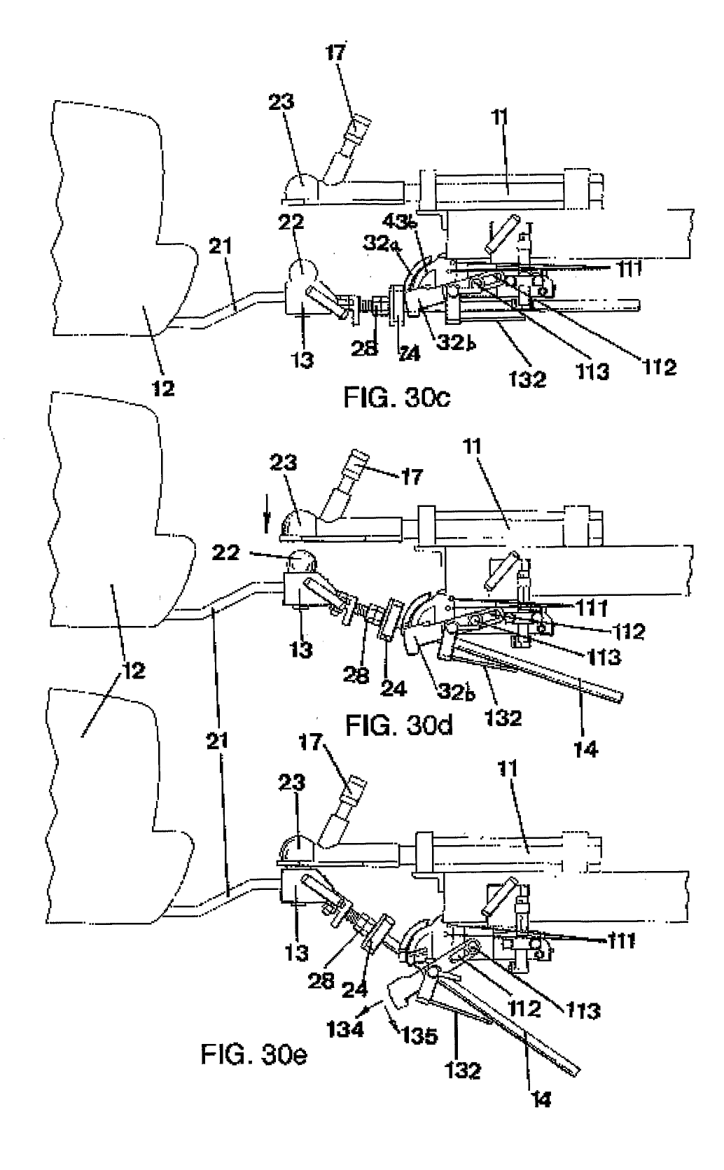

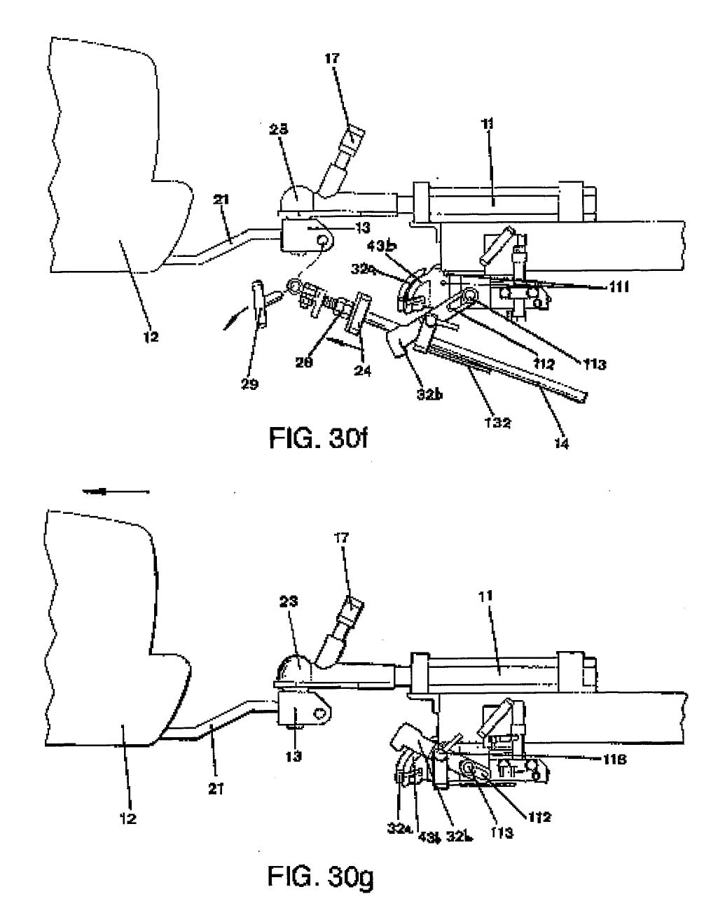

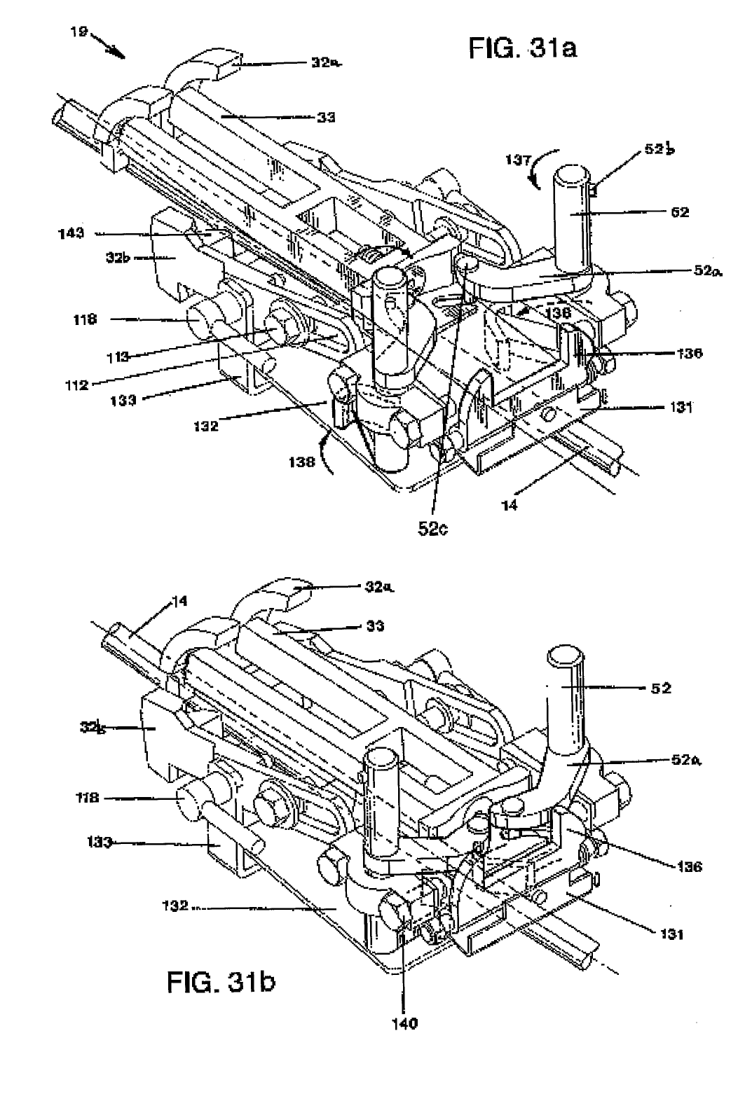

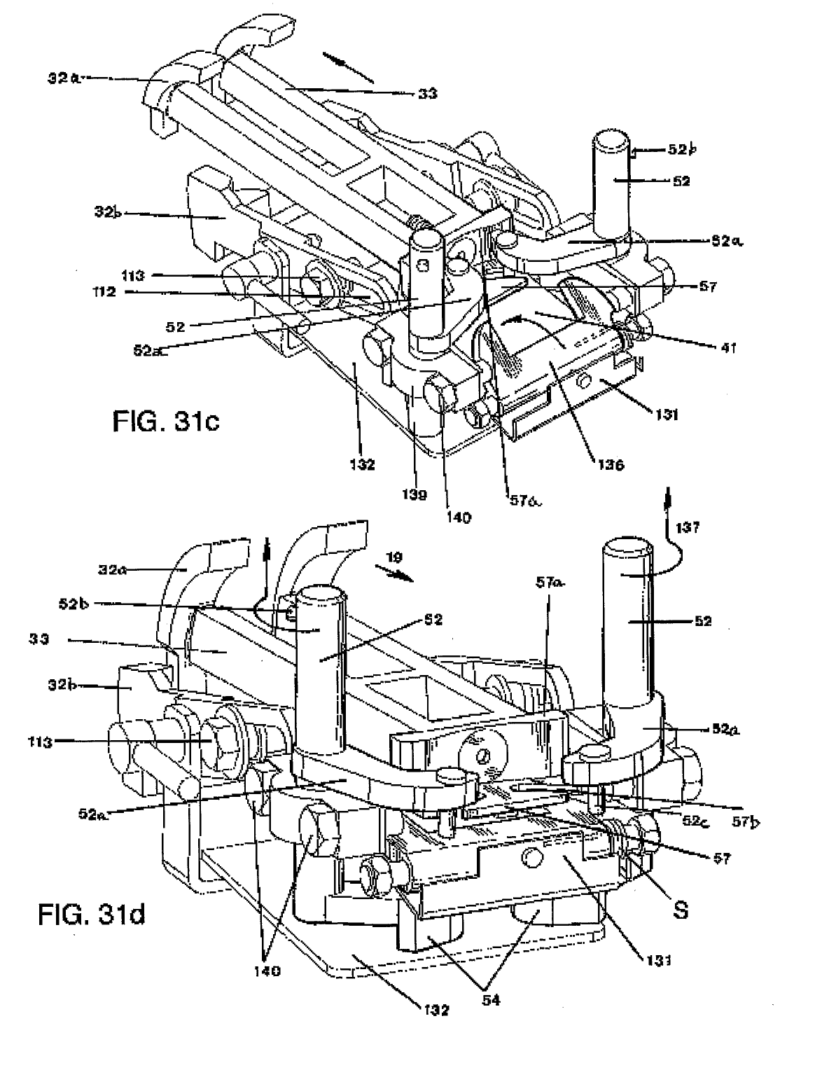

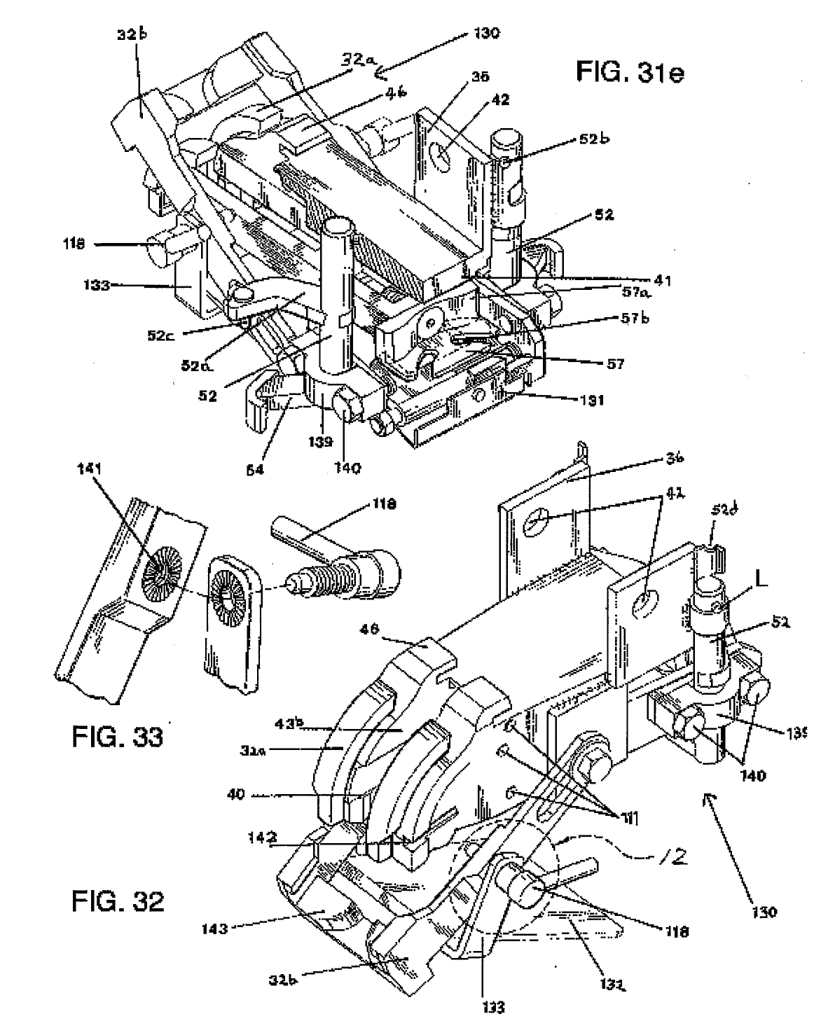

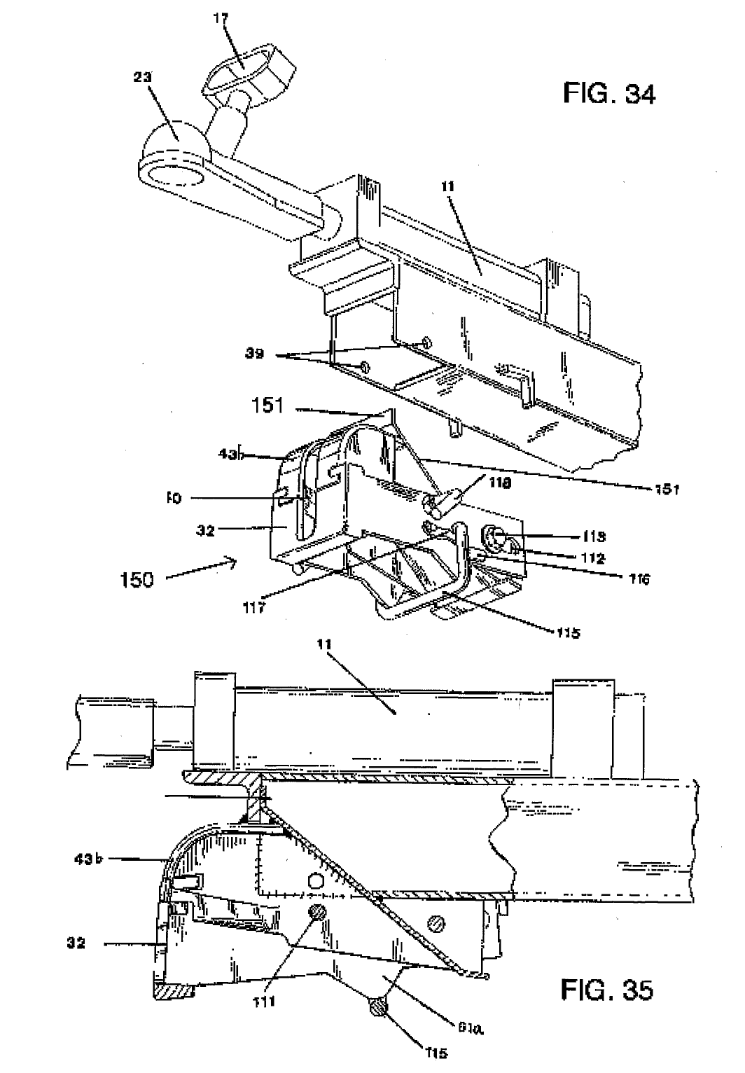

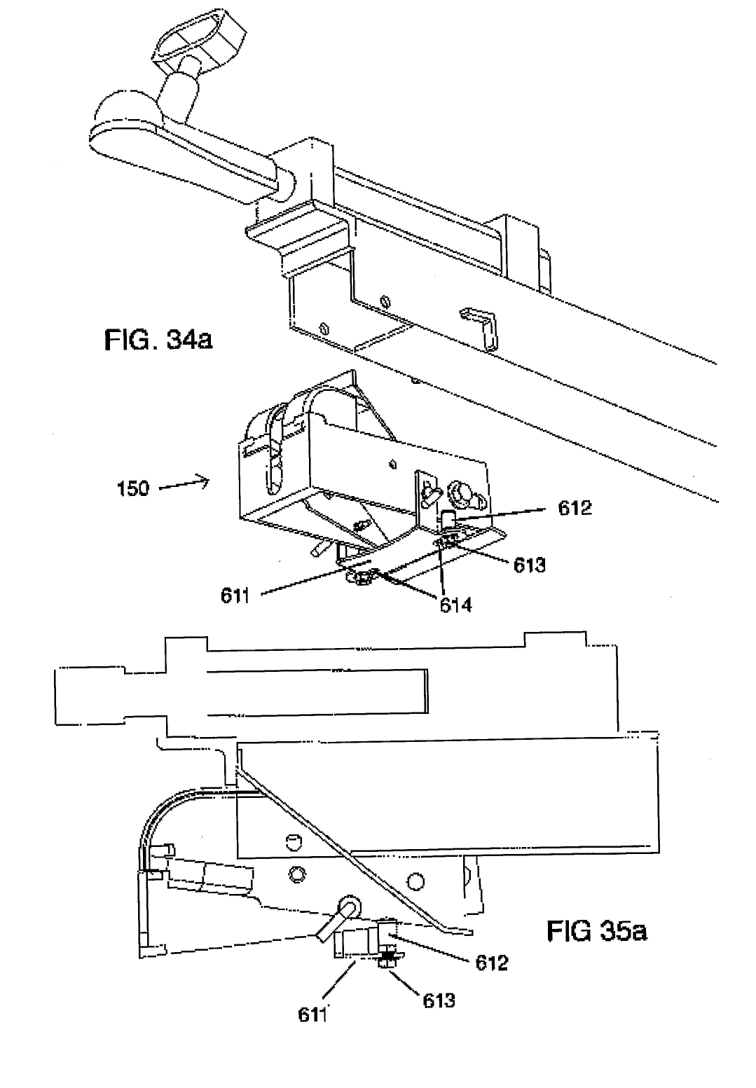

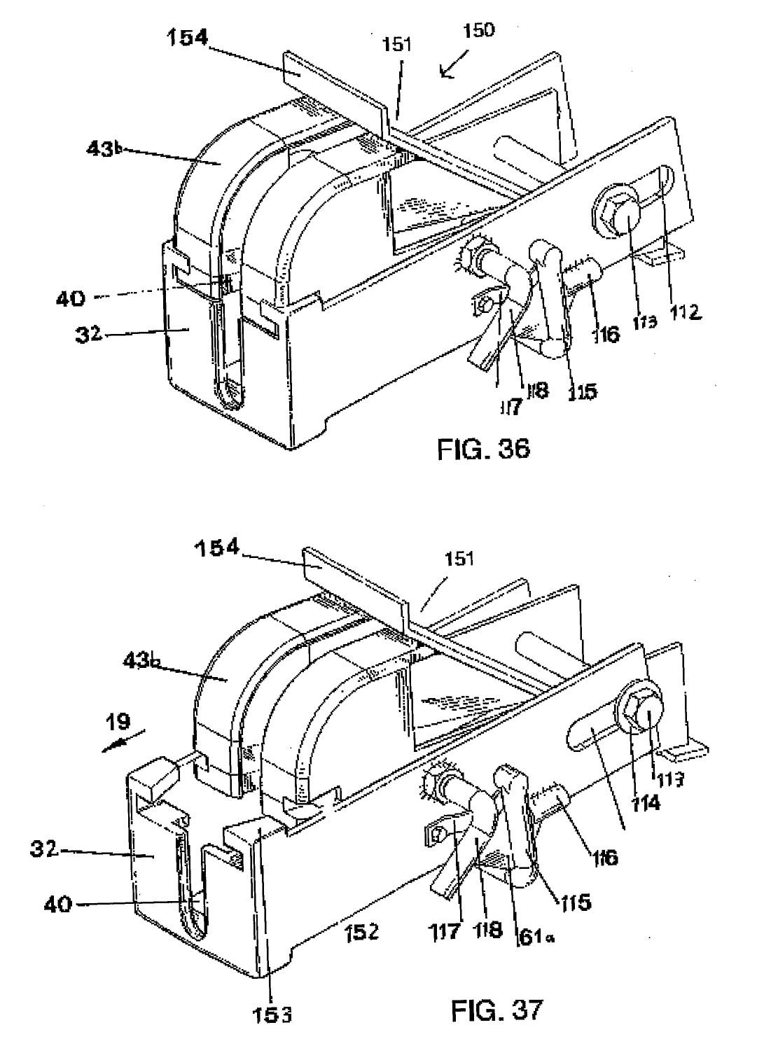

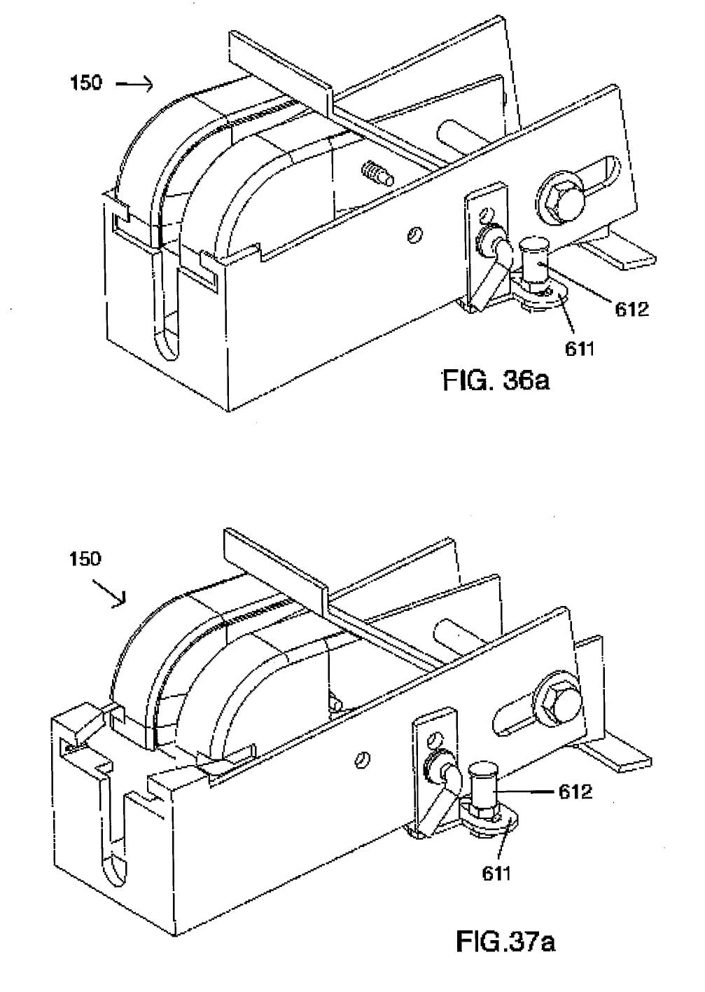

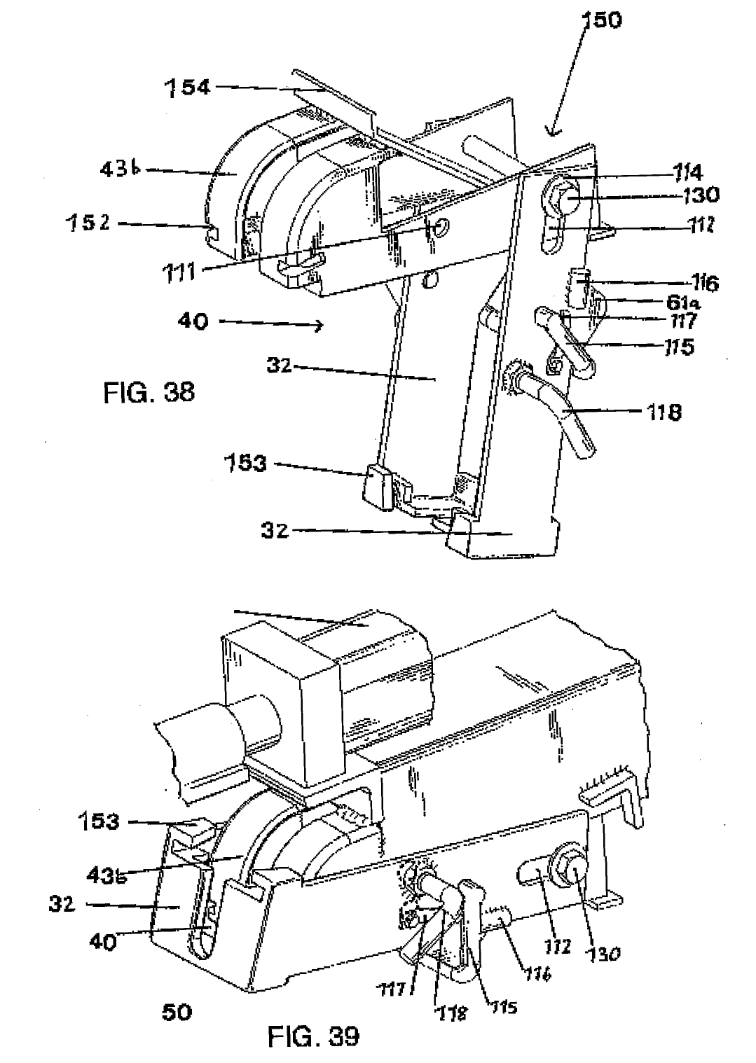

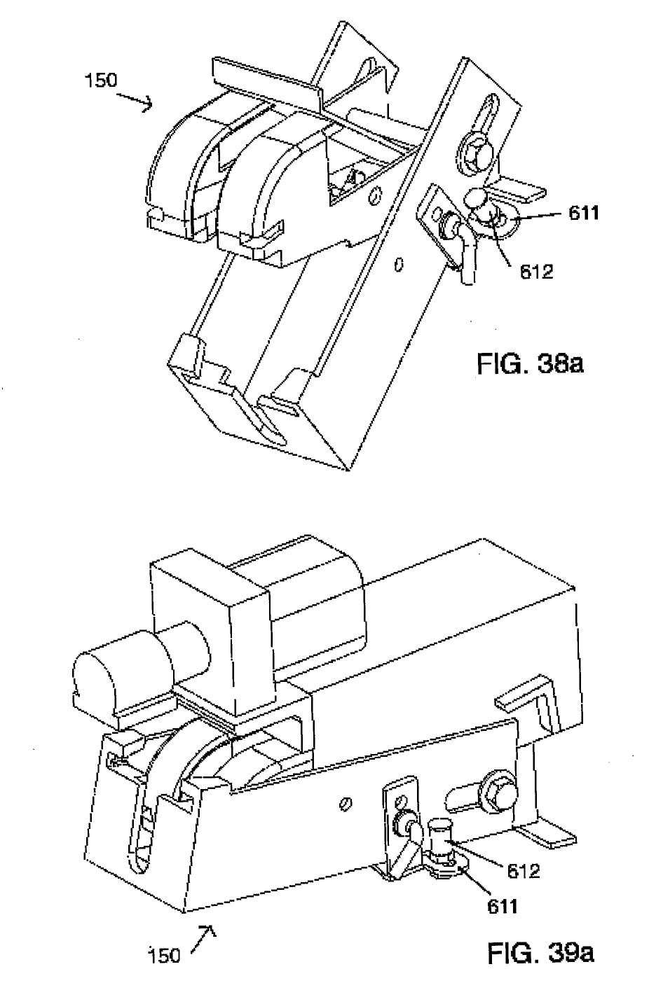

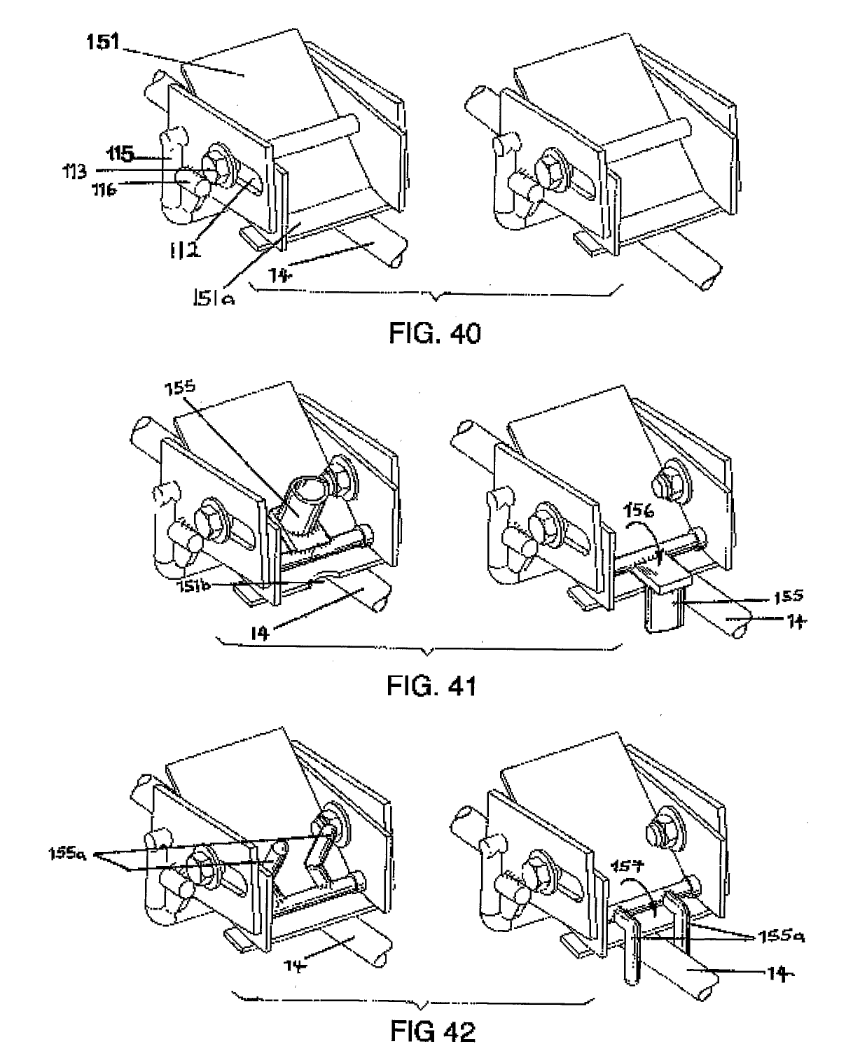

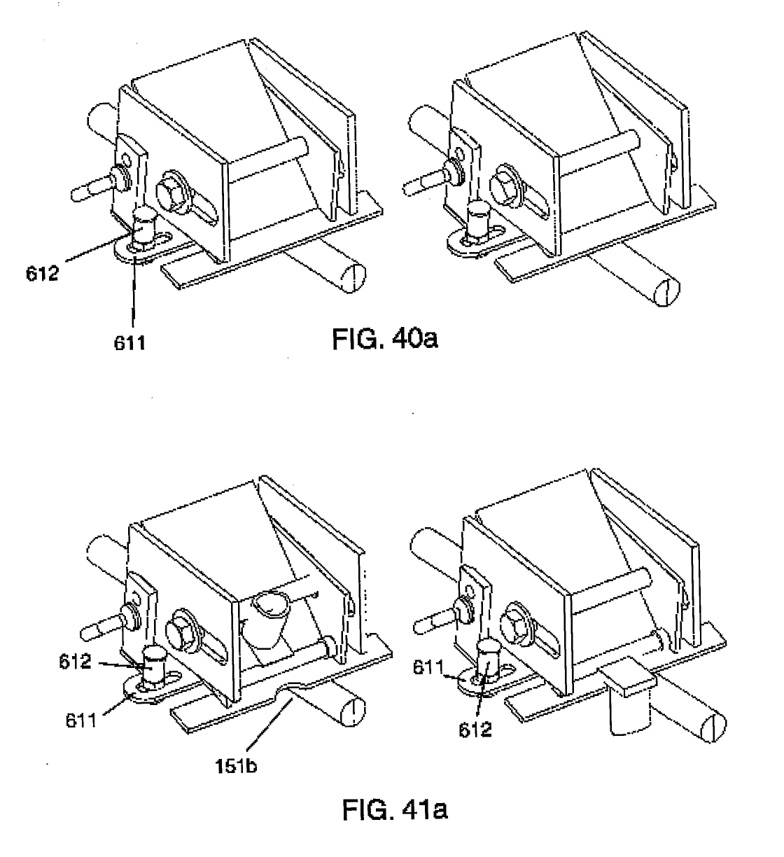

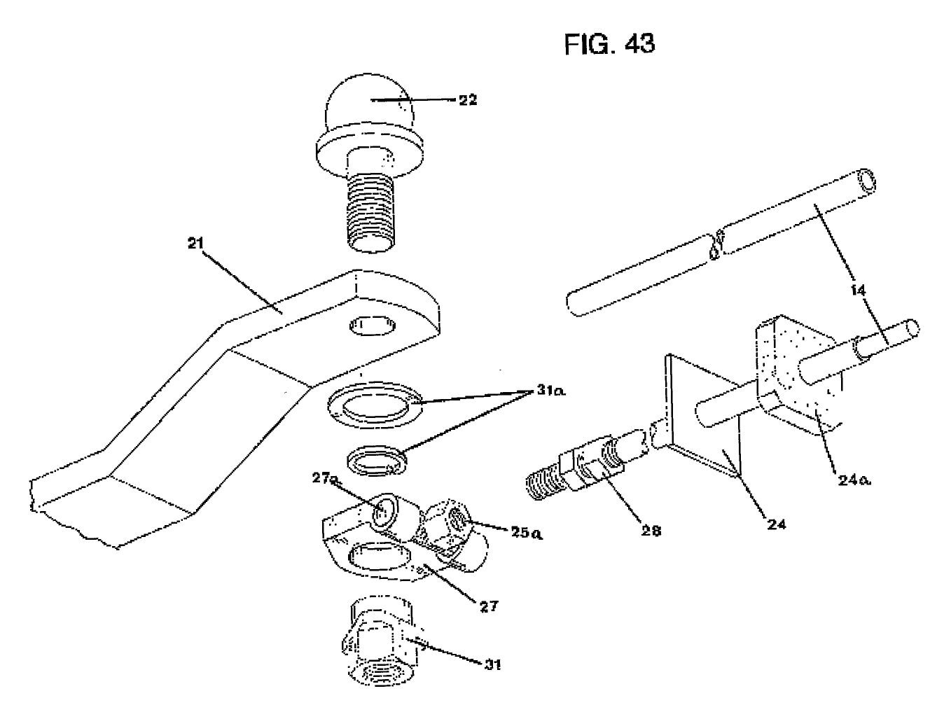

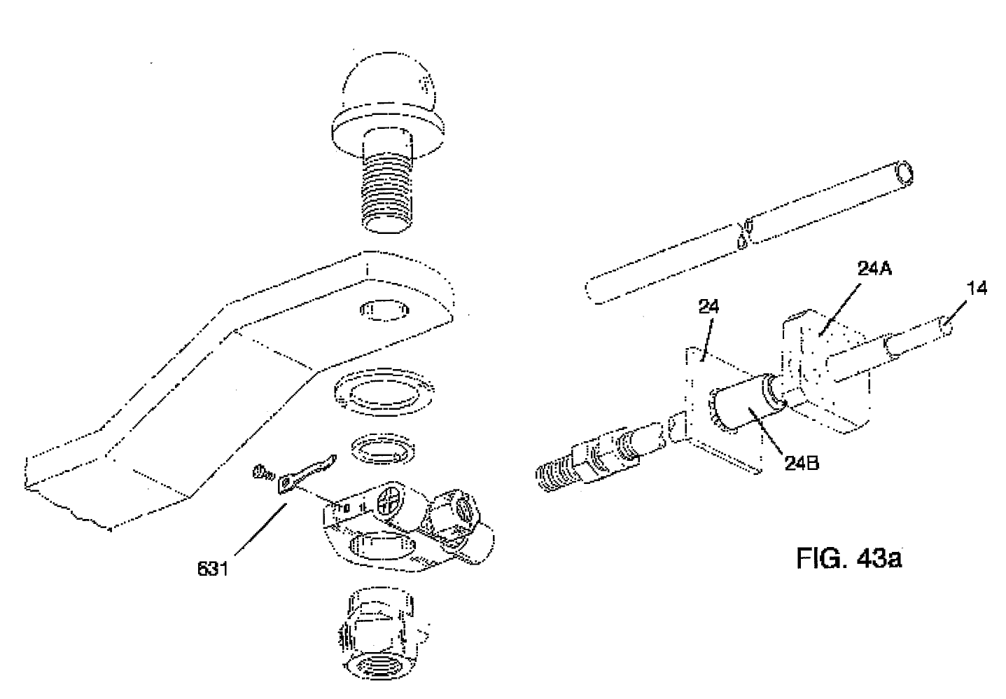

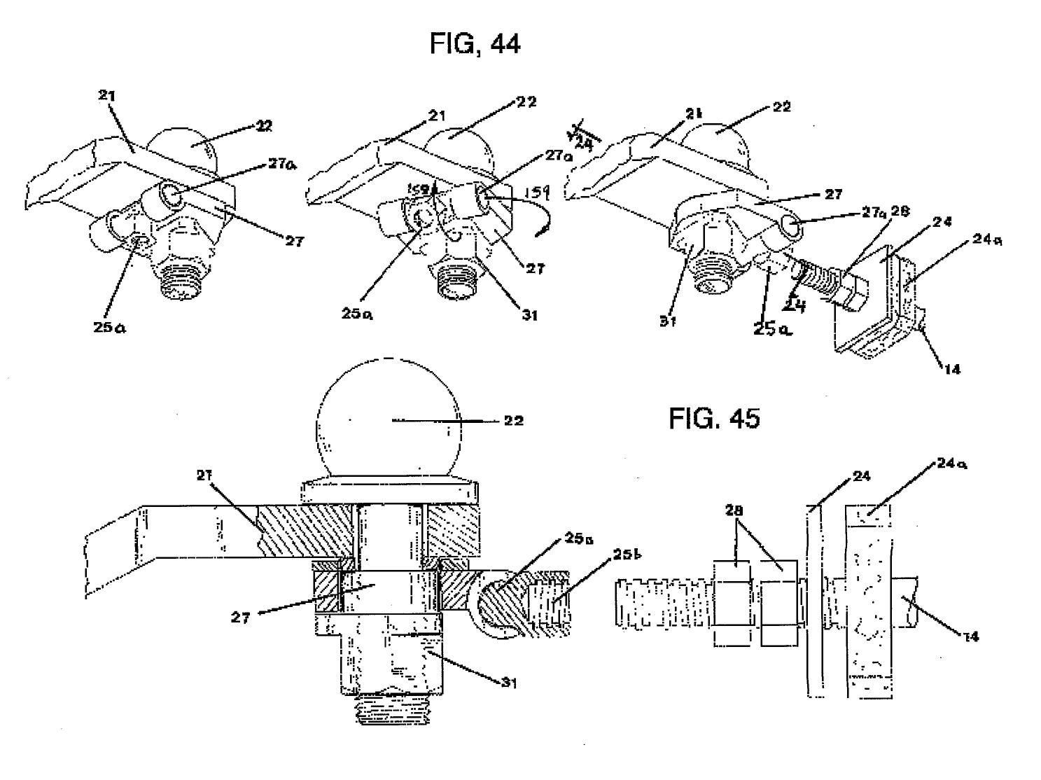

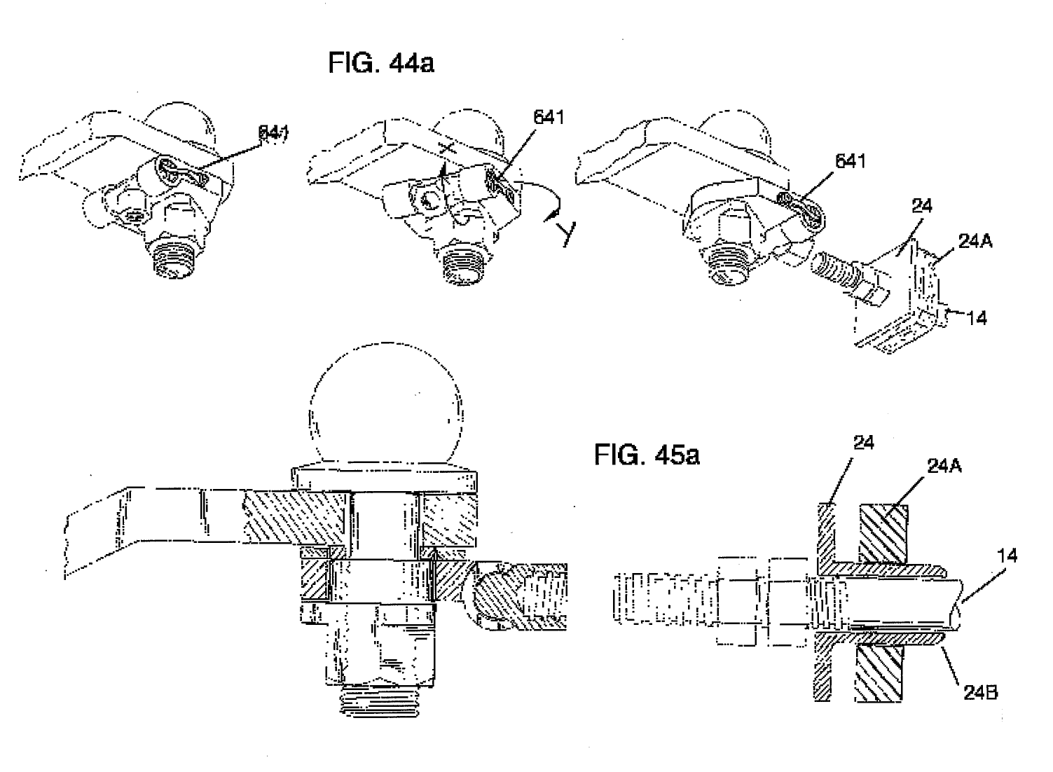

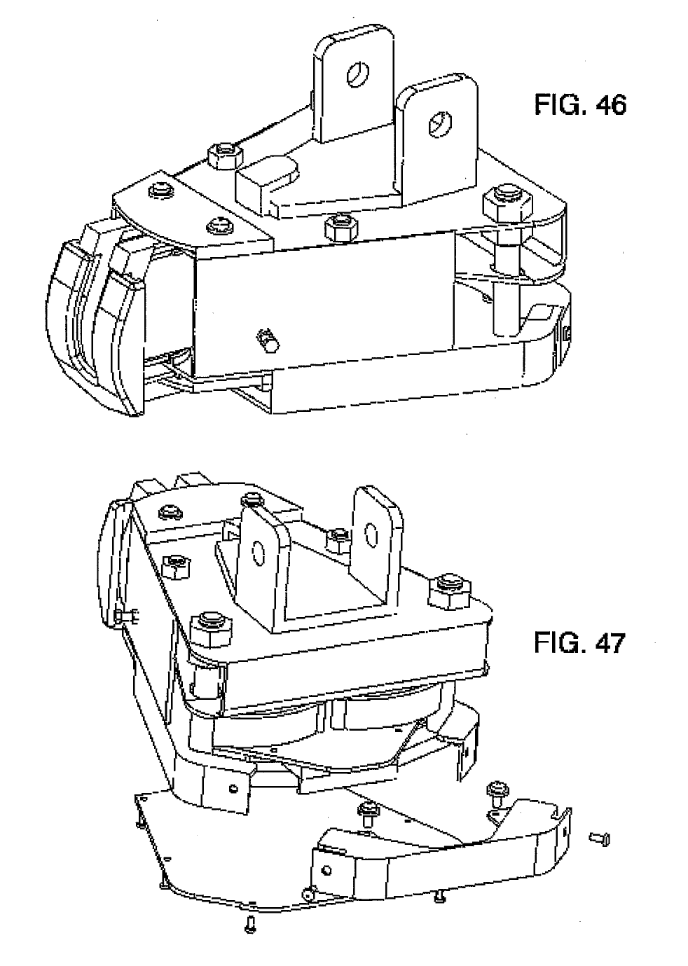

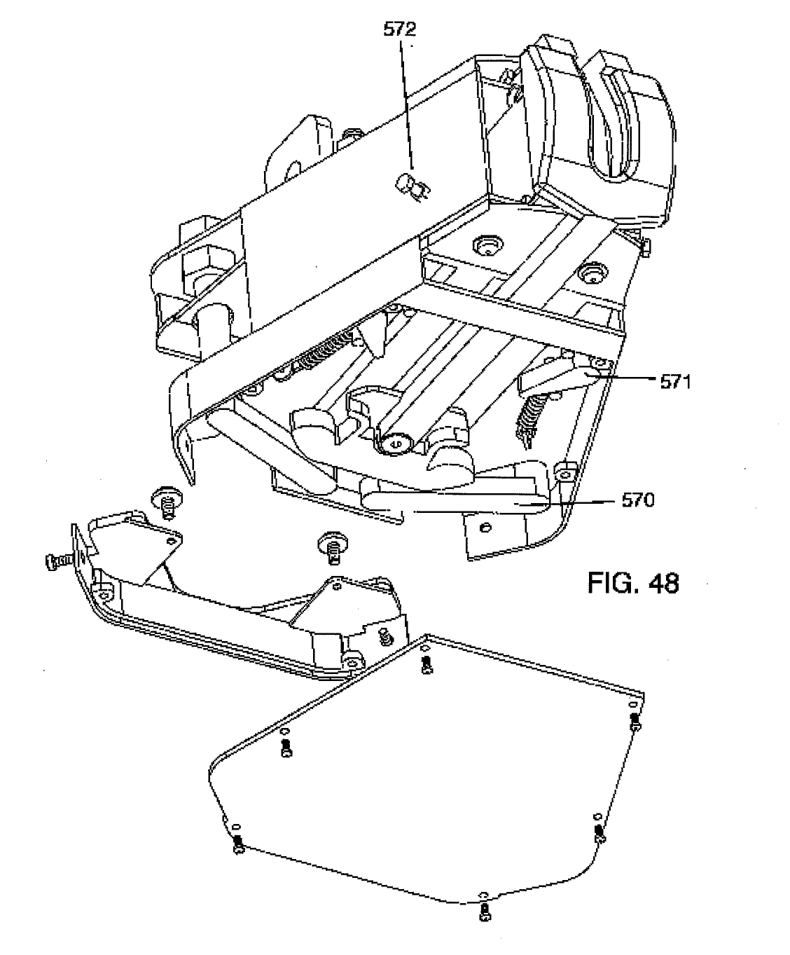

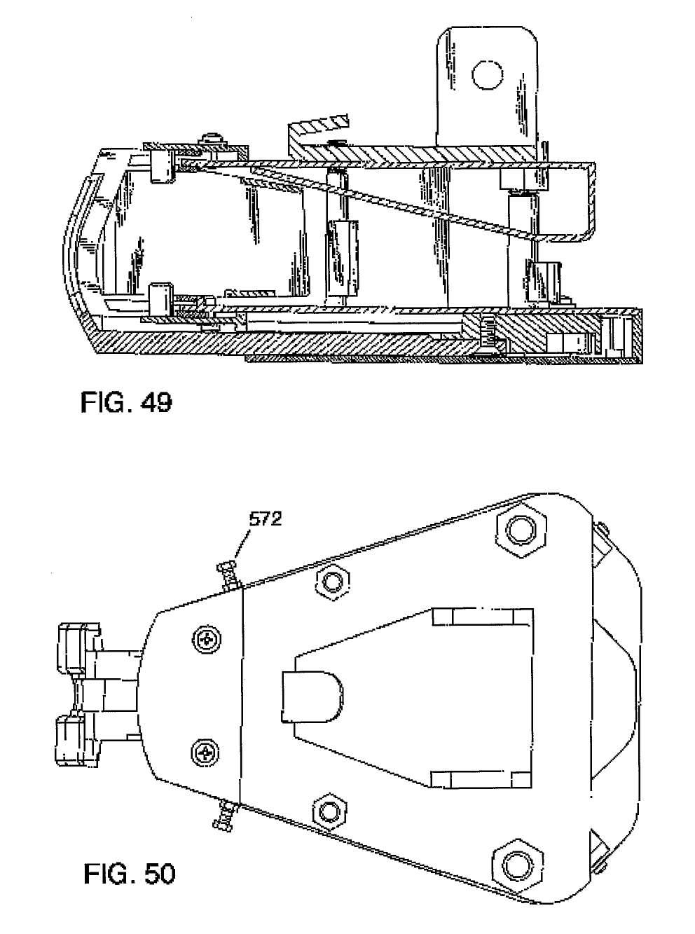

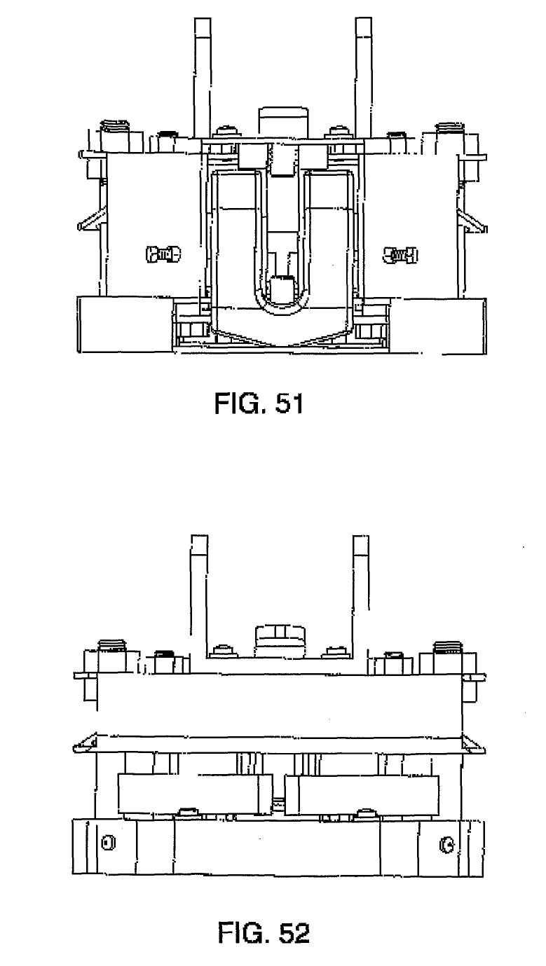

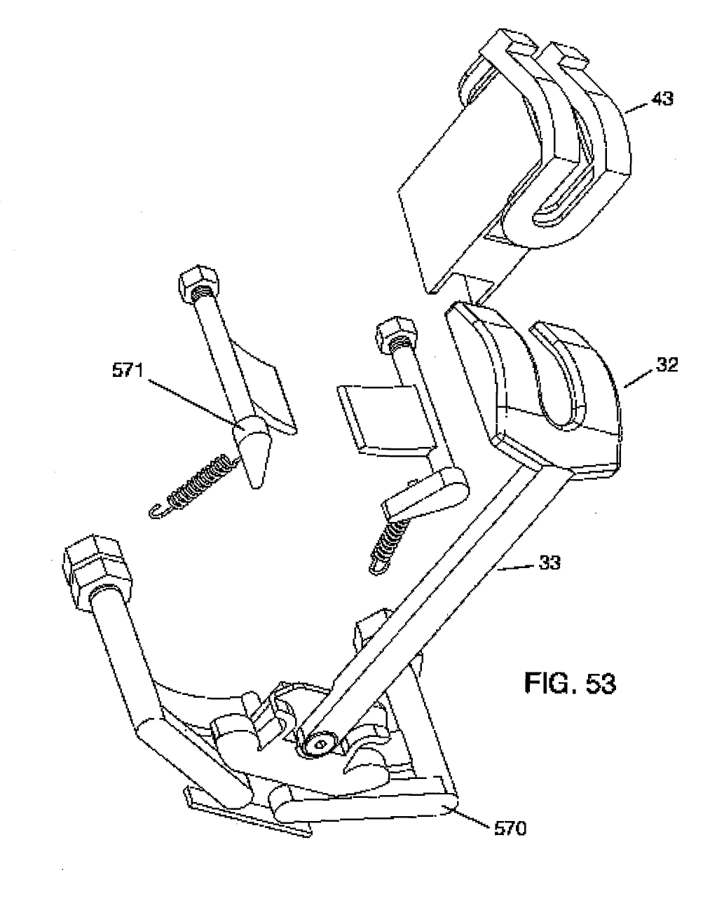

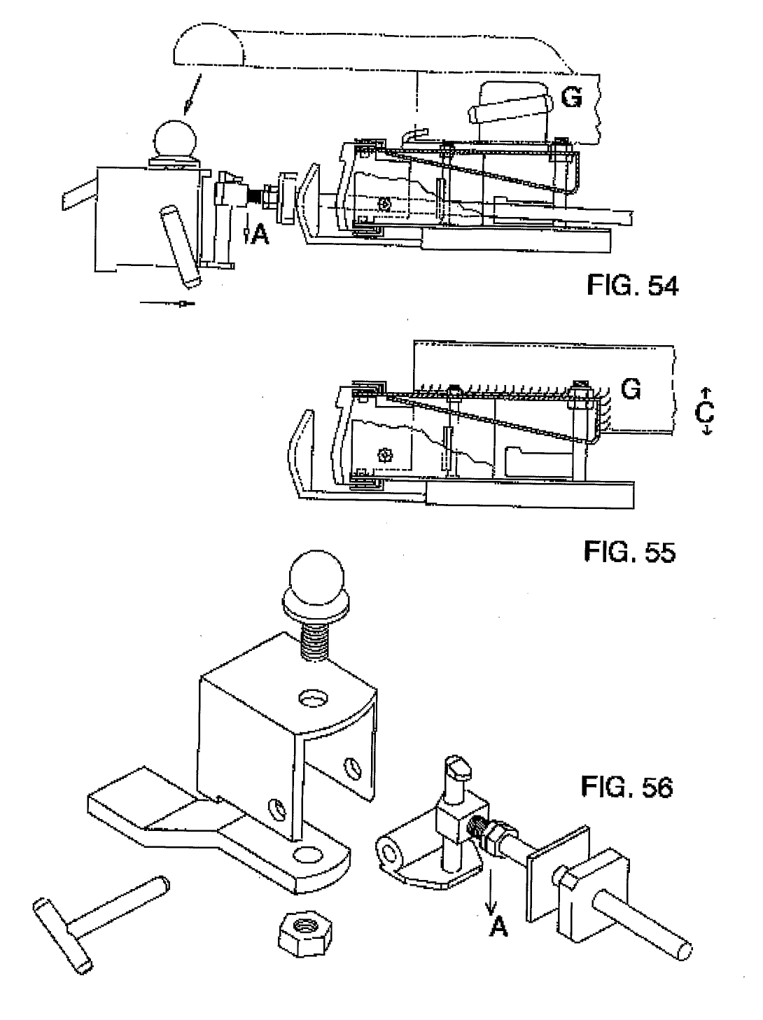

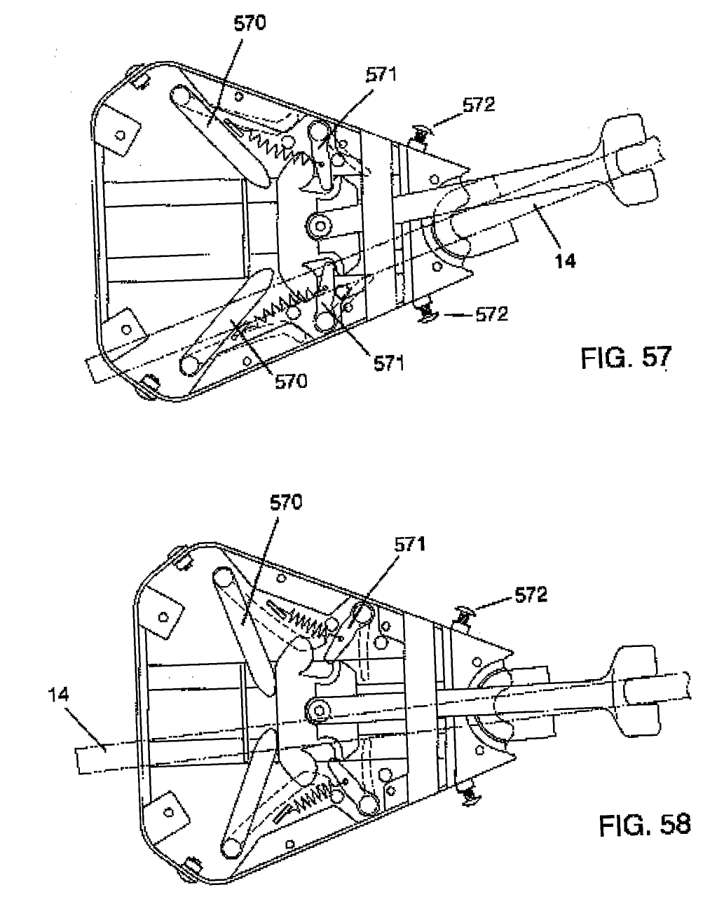

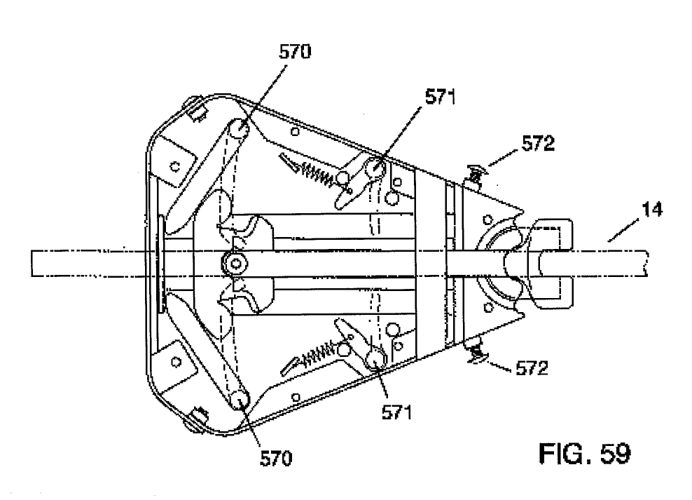

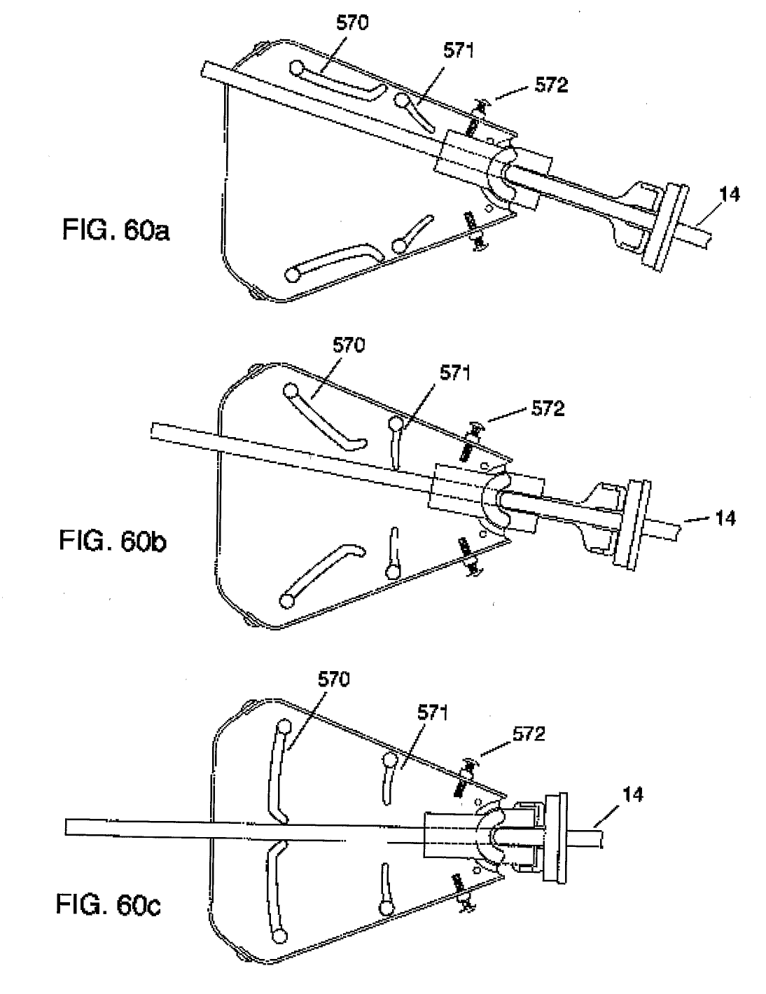

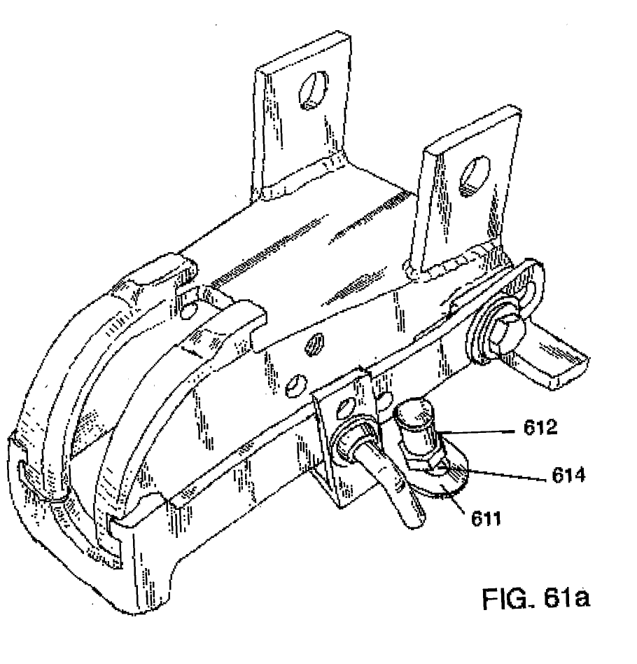

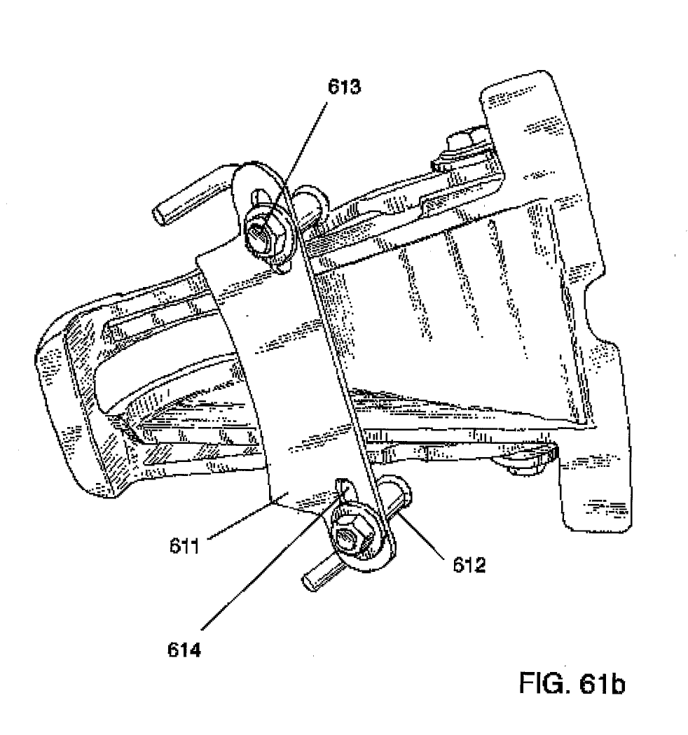

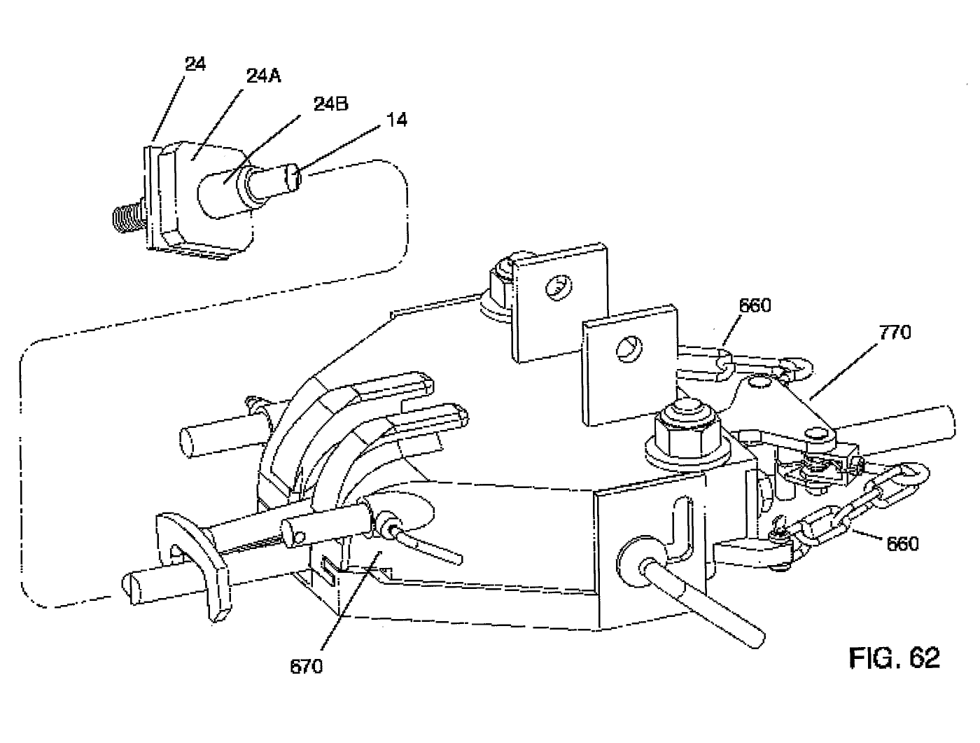

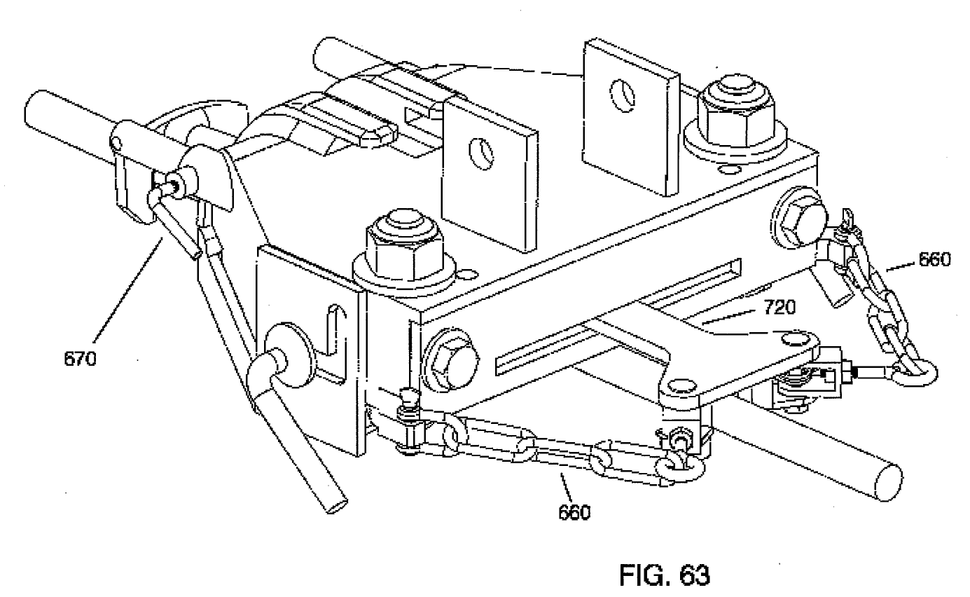

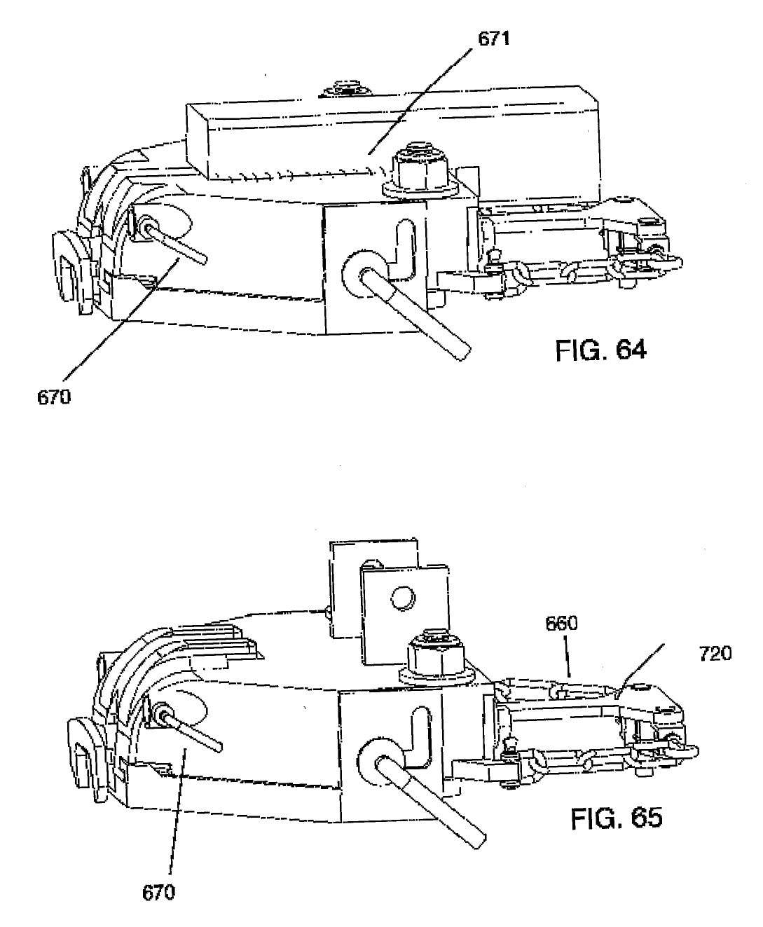

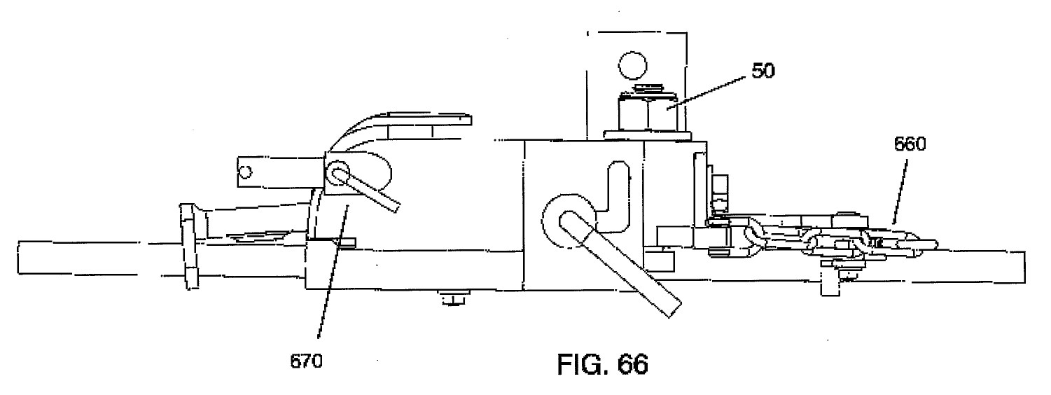

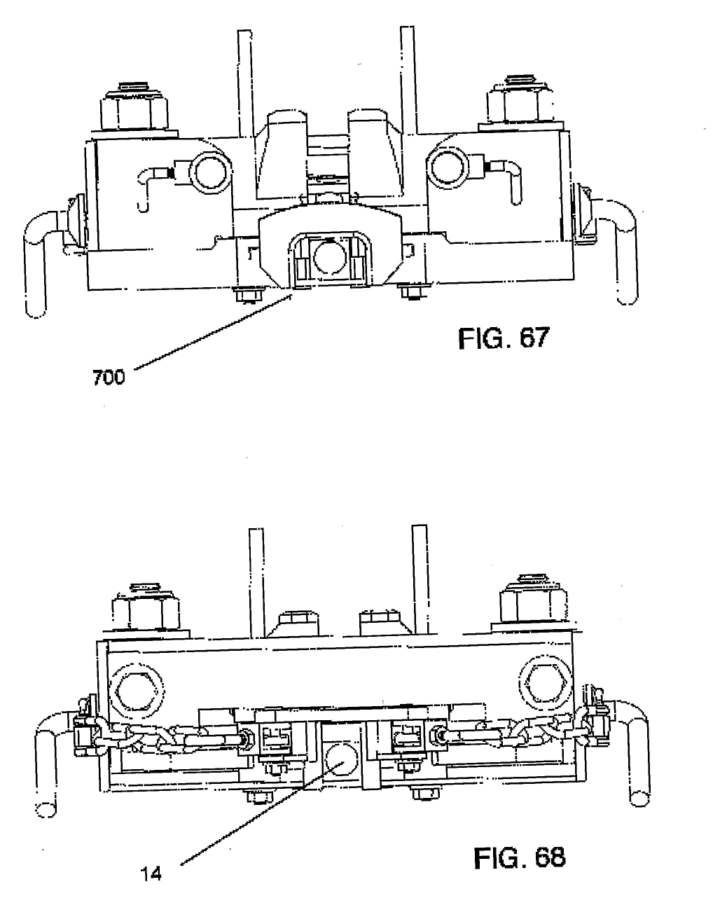

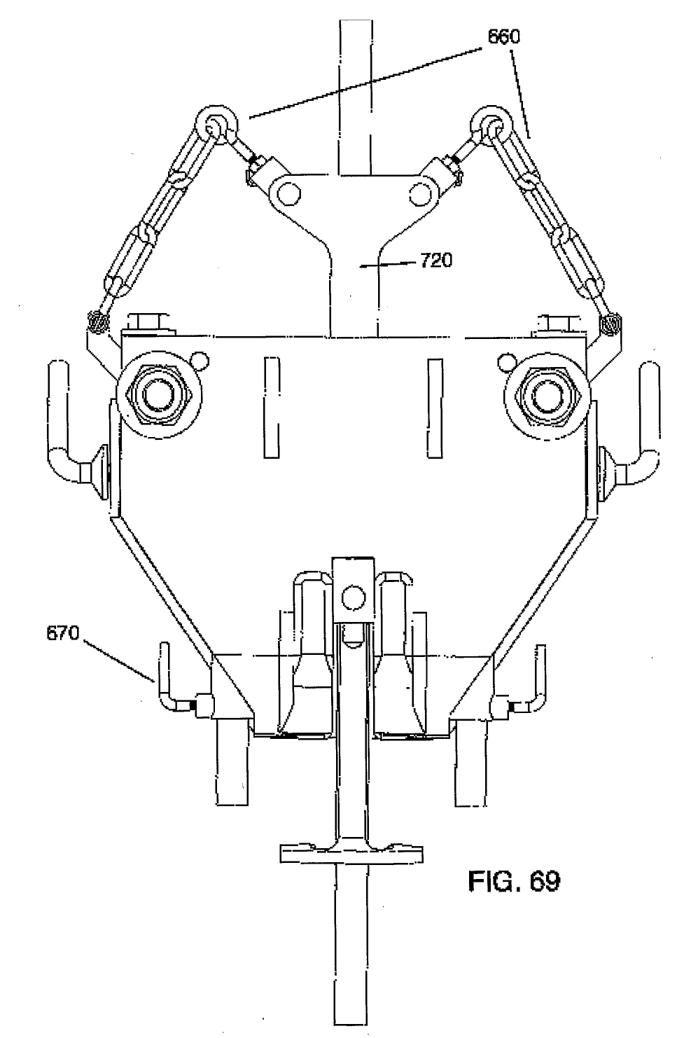

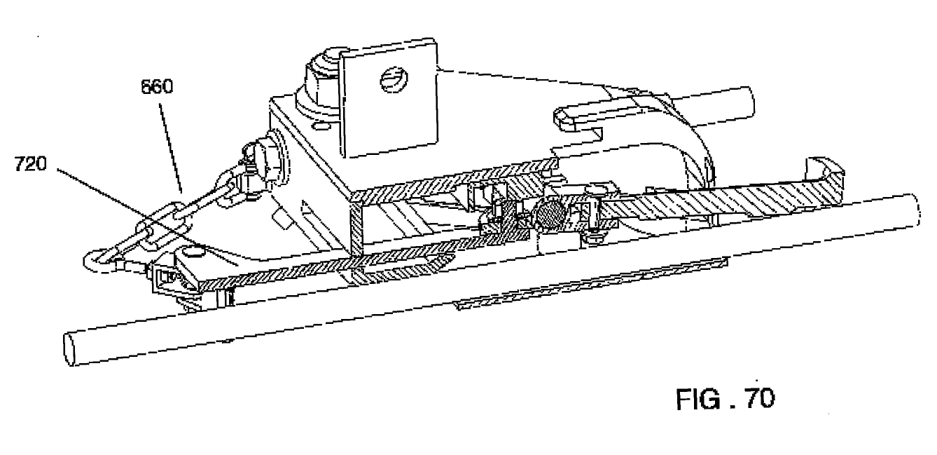

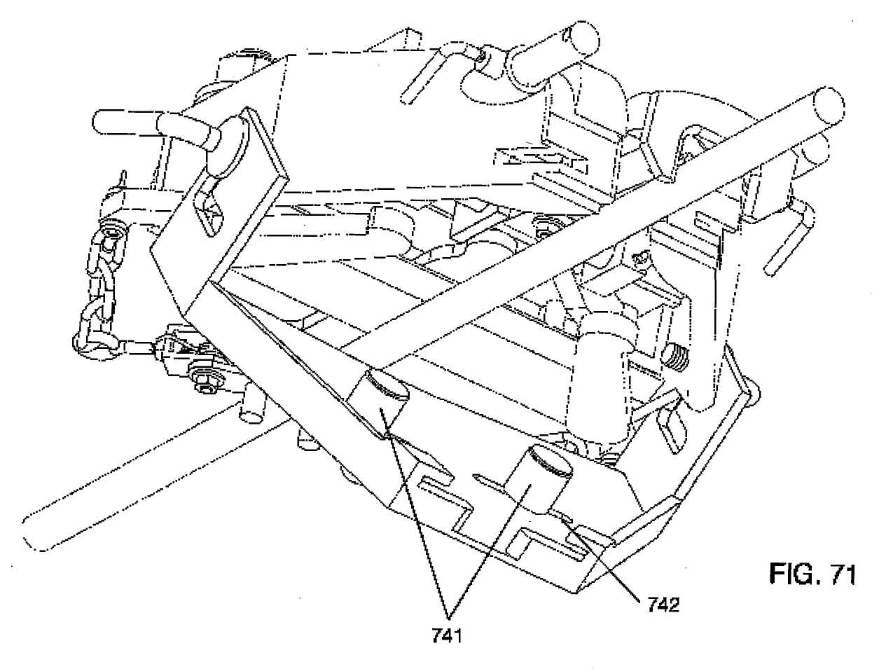

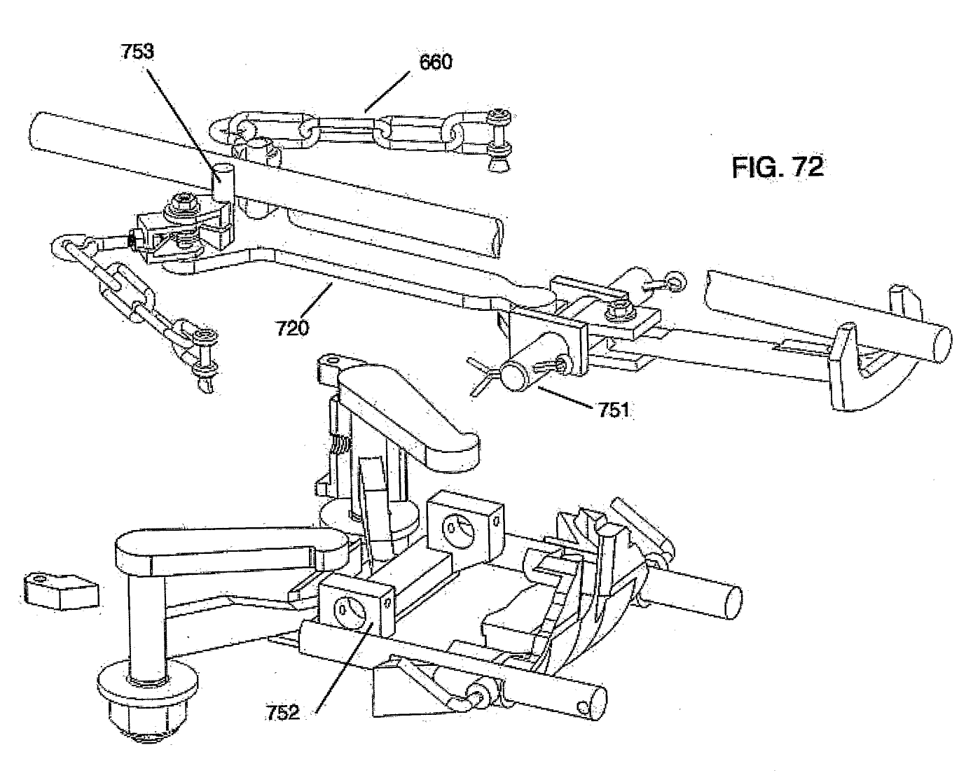

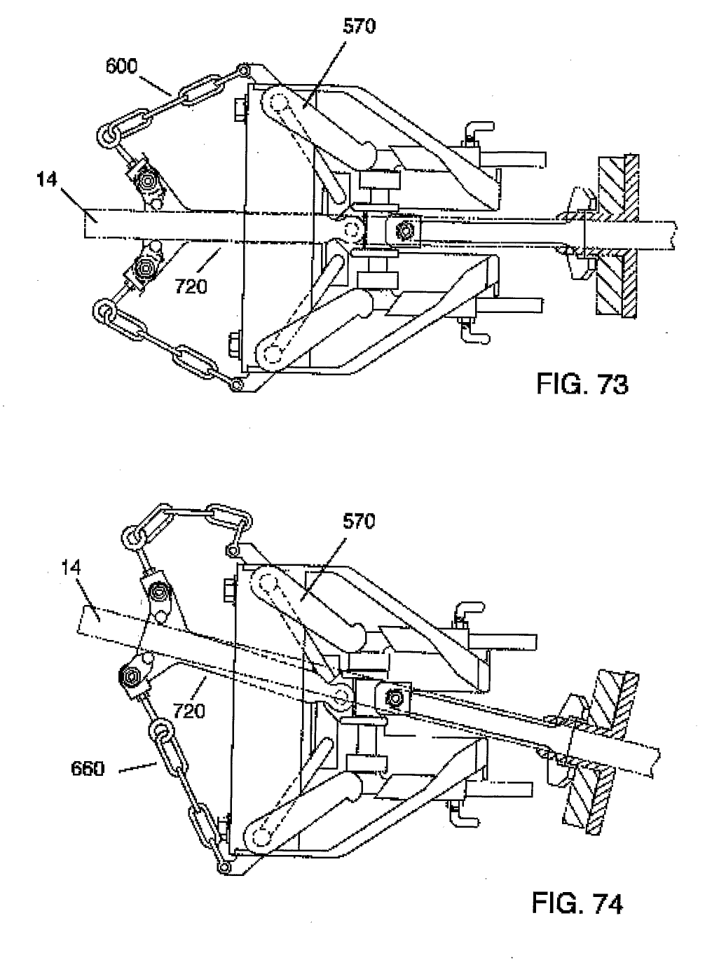

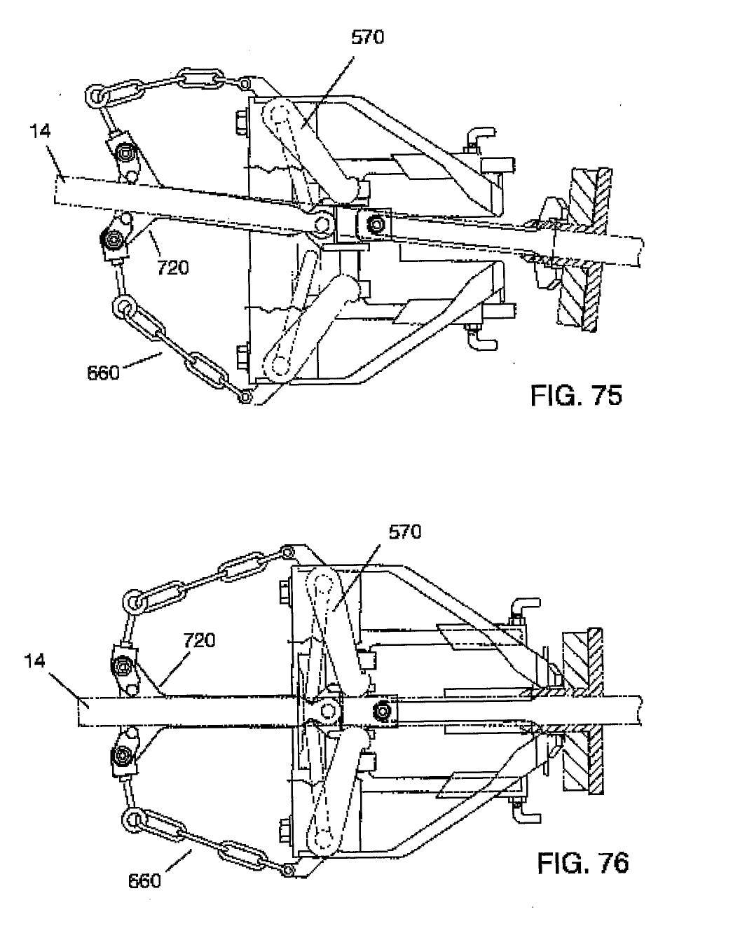

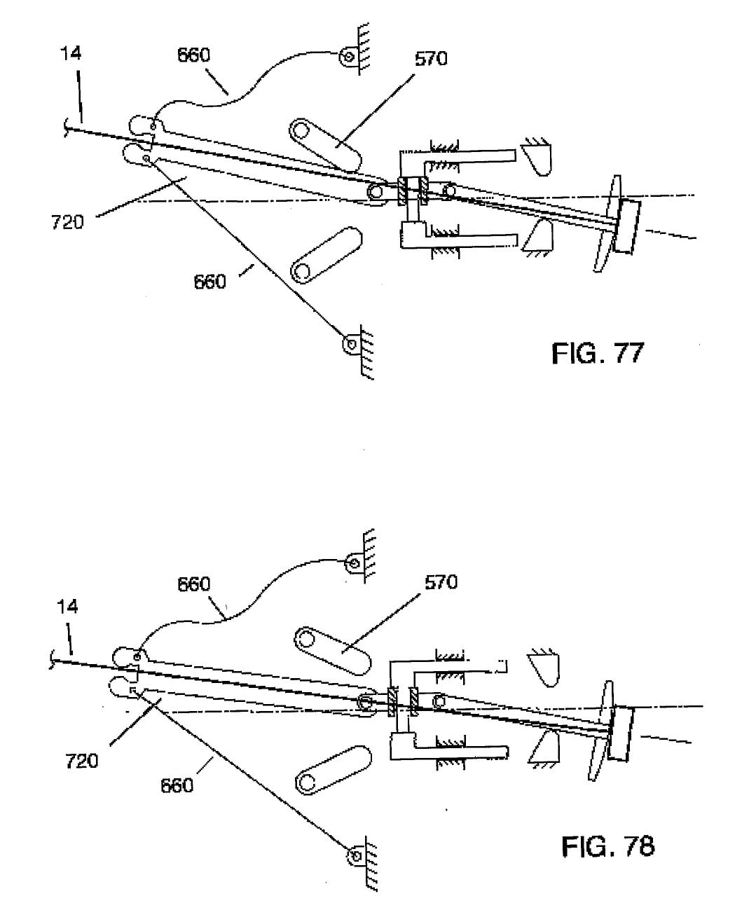

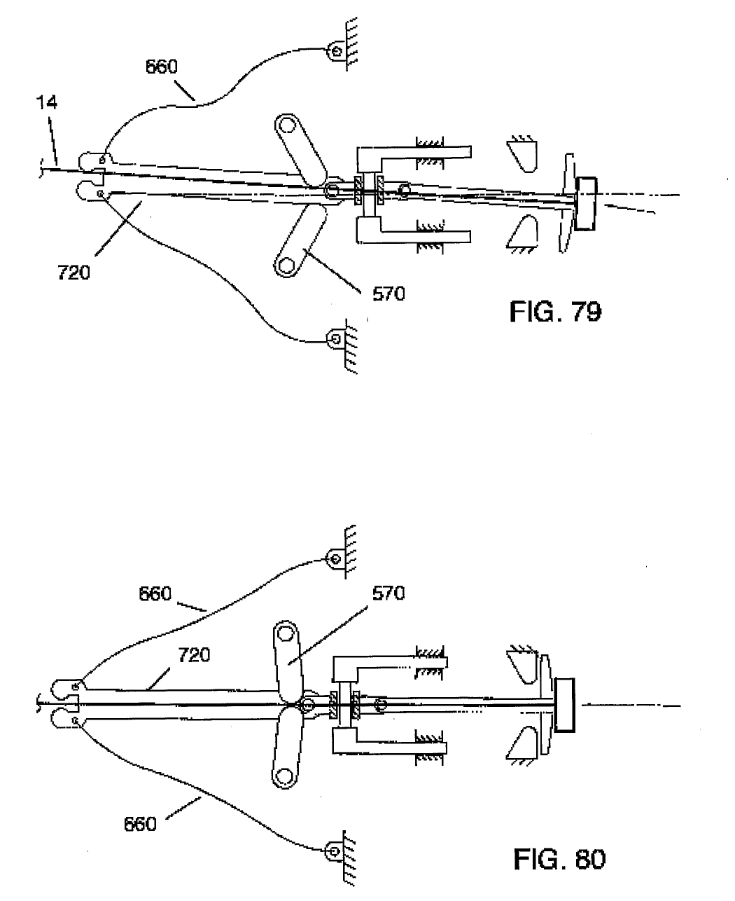

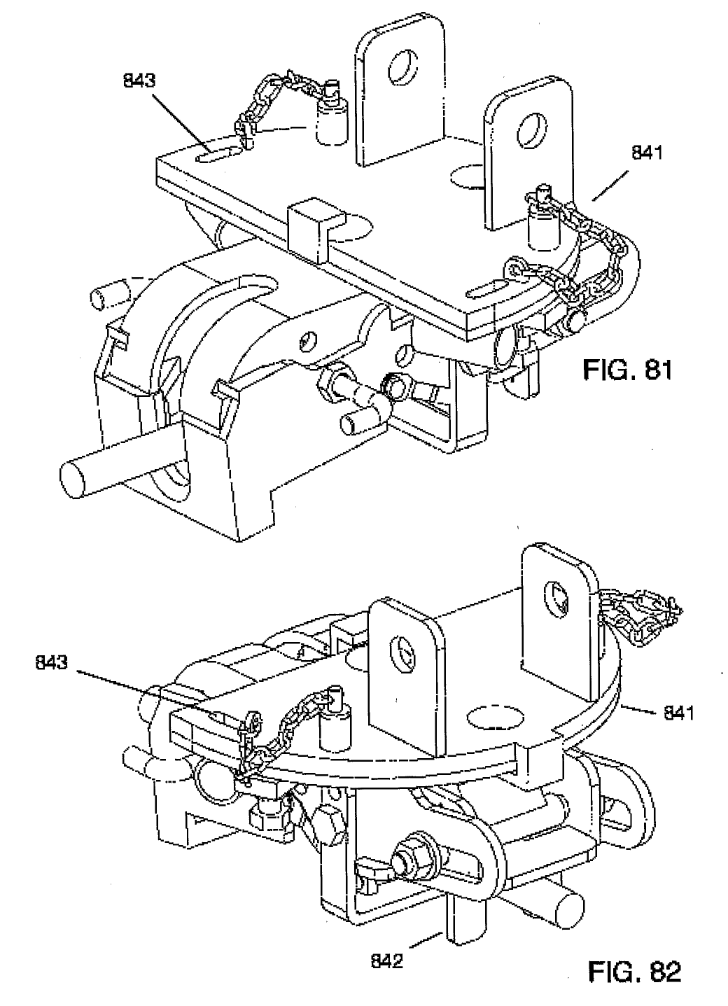

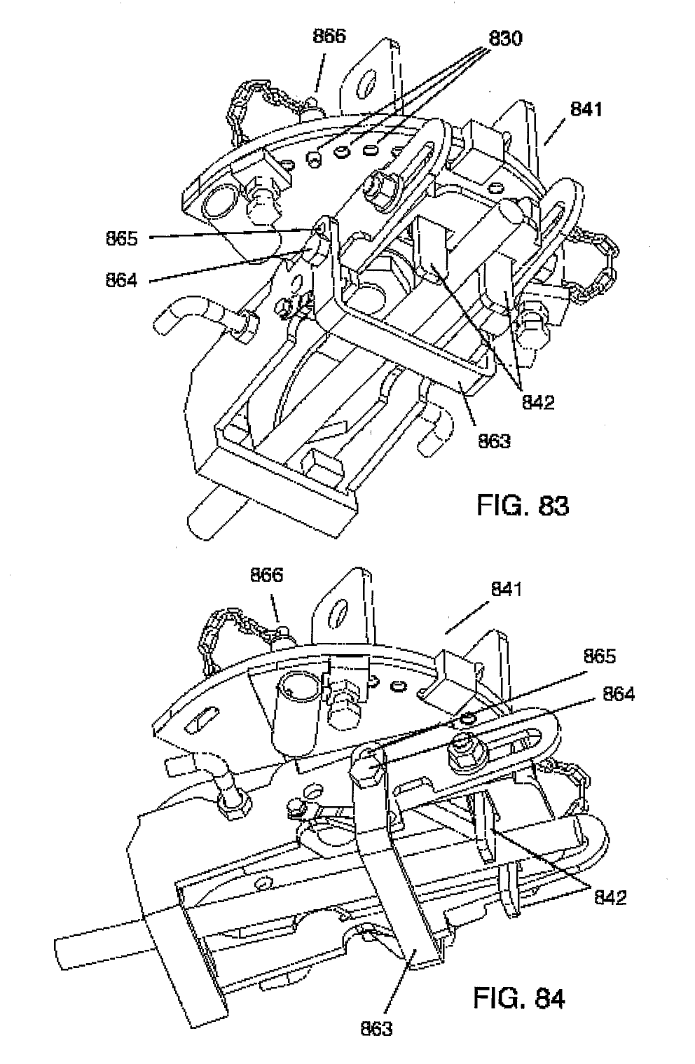

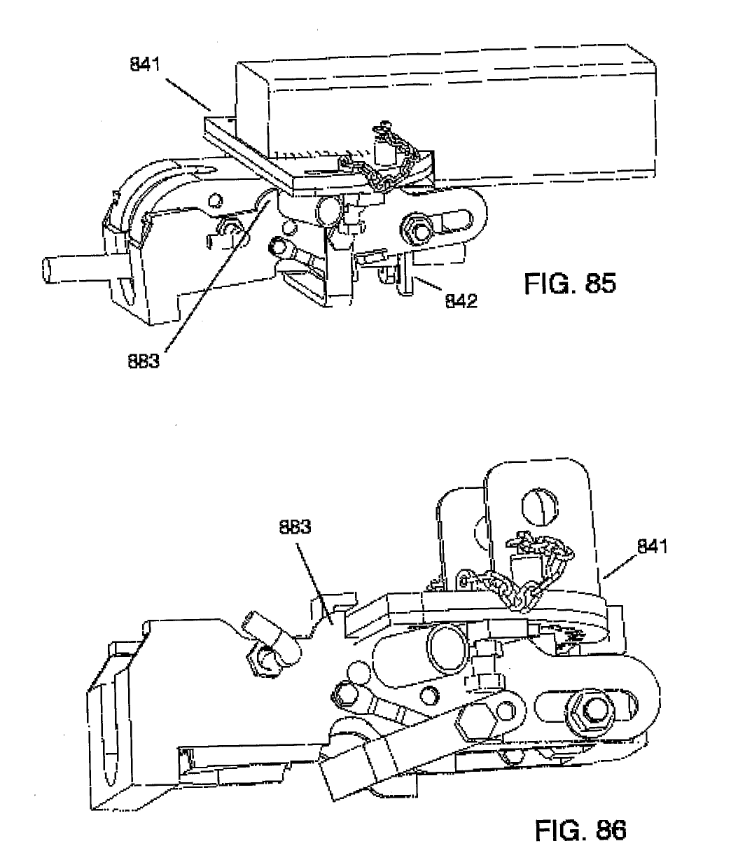

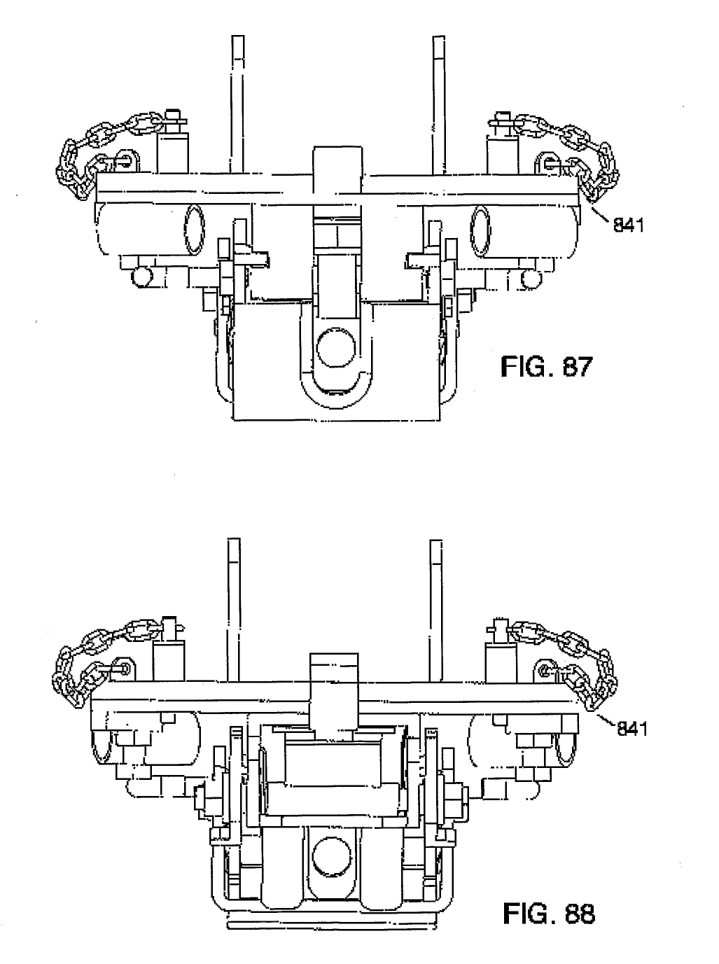

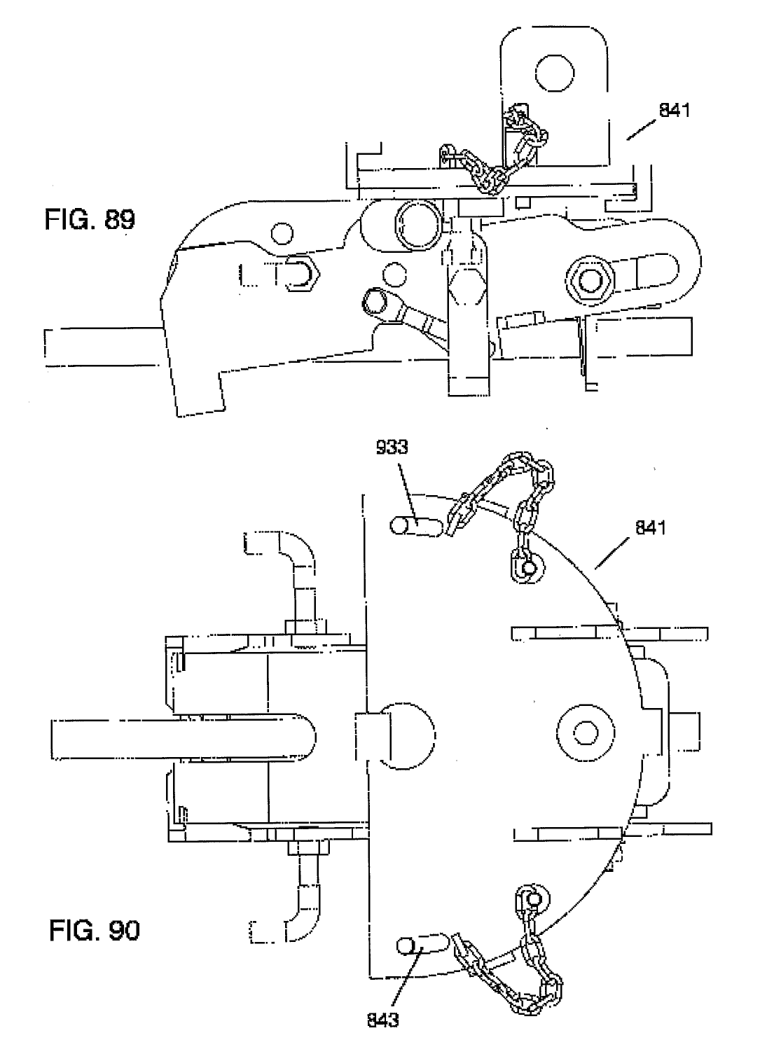

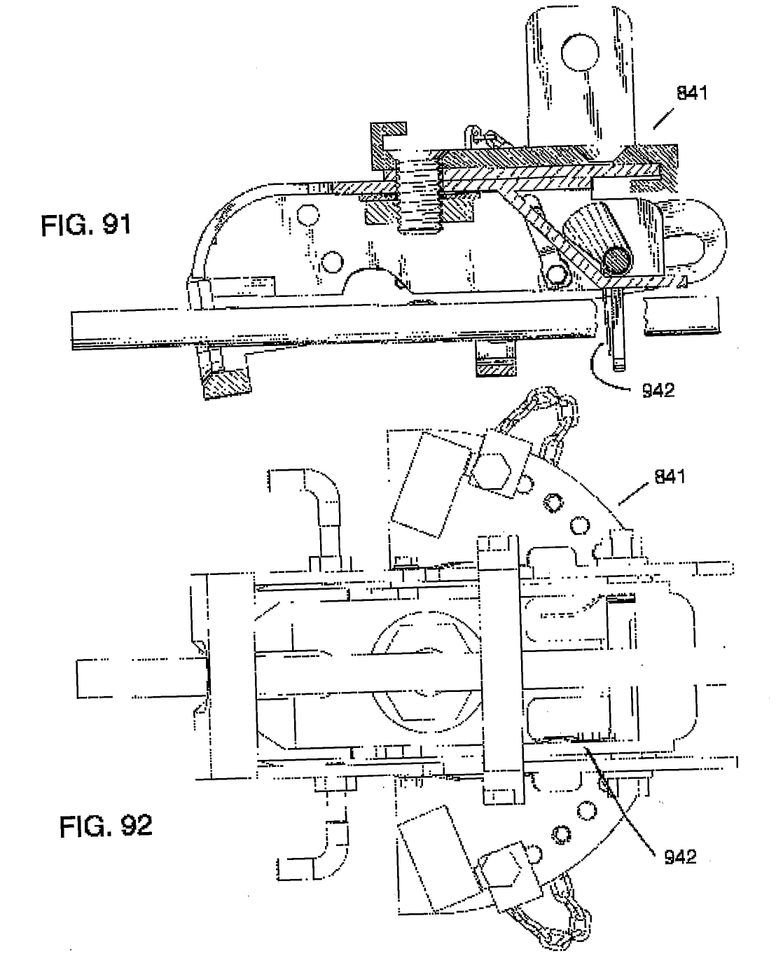

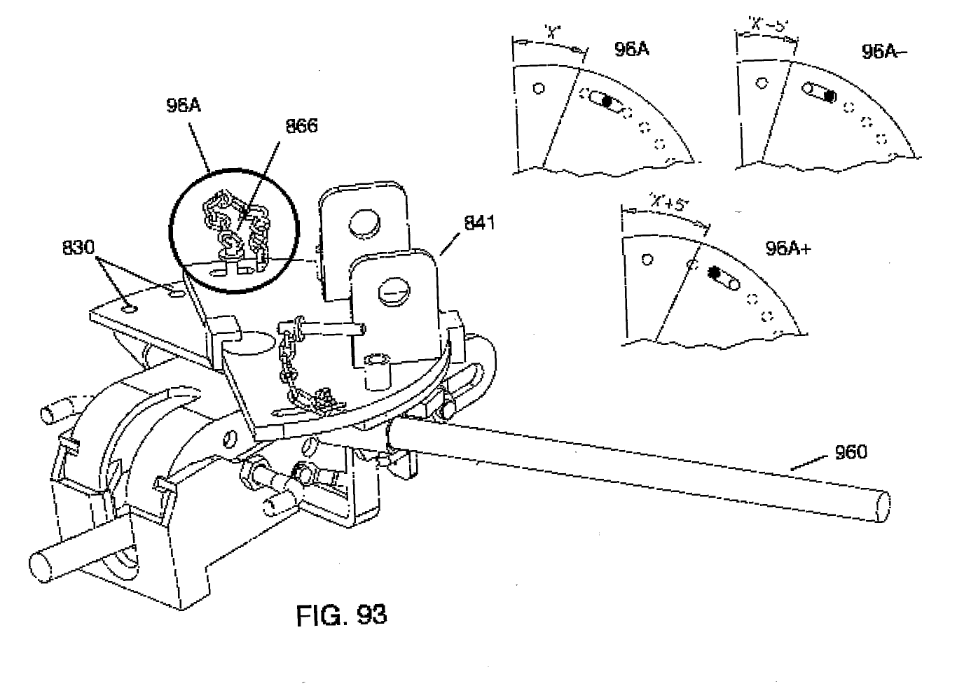

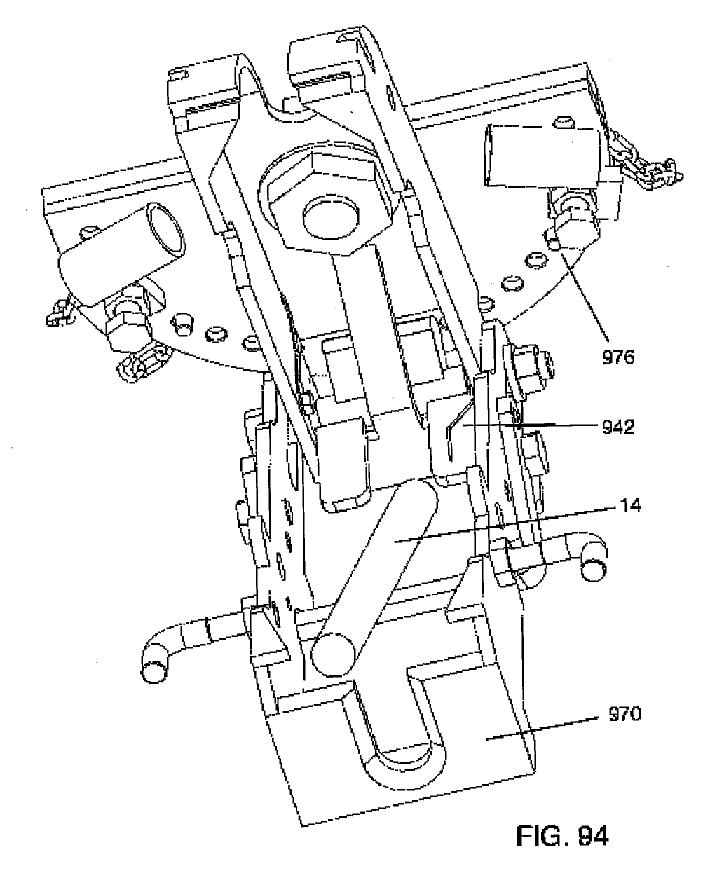

With particular reference to FIG. 20, guiding rod 92 is located within acceptance means 85 (arrow 96), urging socket 87 away from means 85 by resilient interaction with protrusion 90, causing gripping arms 86a and 86b to close upon rod 92 (arrow 95) and forcing said rod into alignment with the front aperture 93. Alignment of rod 92 causes alignment of coupling means 13 and accepting means 85 until stop member 24 engages directly with front aperture 93, to complete the alignment process. FIG. 22 shows an aerial view of acceptance means 85 and rod 92 in the final alignment position. FIG. 23 shows a detailed view of the rear of acceptance means 85 and indicates that protruding lugs 97 and mating slots 98 or stops 99 may be implemented in the design of accepting means 85 to provide locking devices for arms 86a and 86b once in the closed position, as shown in FIG. 22.

With alignment complete, under the reversing power of the towing vehicle, tow bar ball 22 can be coupled to trailer socket 23 and the coupling guidance device of the invention removed and stored for later use. As previously described, each component of the device is capable of separation from each other component and from the towed and towing vehicles.

Further alternate embodiments that are within the spirit and scope of the present invention are now described with reference to FIGS. 24 to 94 and which provide similar functions to those components as described thus far. FIG. 24a shows an aerial view of the guidance device of FIG. 1 as fixed to tow-bar 21 of vehicle 12 and inserted into accepting means 110 mounted to trailer 11. FIG. 24b shows an aerial view of the guidance device after the motor vehicle 12 has been reversed from the position shown in FIG. 24a and the guidance rod 14 has penetrated into the accepting means 110. FIG. 24c shows an aerial view of the guidance device with the front portion of the accepting means 110 placed in contact with the stop member 24. FIG. 24d shows an aerial view of the guidance device of FIG. 1 with the guidance rod 14 fully engaged in the accepting means 110 and the trailer wheels 11a fully aligned. FIGS. 24a, 24b, 24c and 24d show the sequential movement of components of the invention in use. An operator must initially affix coupling means 13 and accepting means 110 to their respective mounting positions on both towed and towing vehicle, as particularly shown in FIG. 1. To begin the vehicle coupling process, an operator engages the trailer brake handle 17 to set trailer braking system 18 in place. This prevents the wheels 11a from rolling and trailer 11 from moving whilst the coupling process is occurring. The operator then moves the towing vehicle 12 substantially within coupling distance from the trailer 11, as indicated particularly by FIG. 24a. The leading end of rod 14 is first connected to coupling means 13 by operation of releasable mounting pin 29. The operator then places the second end of guidance rod 14 through front aperture 40 of acceptance means 110. With rod 14 connected and associated with both coupling means 13 and accepting means 110, the operator then proceeds to reverse the towing vehicle 12 backwards (arrows 19) towards the trailer 11, at which point the respective coupling devices of each are still unaligned, as shown in FIG. 24a. With particular reference to FIG. 24b, rod 14 continues to penetrate accepting means 110 as the towing vehicles reverses. Rod 14 is capable of substantial lateral and unlimited vertical movement to accommodate differences in height, as approximately pre-determined by jockey wheel 16, and alignment between each vehicle. FIG. 24b shows the movement of rod 14 and the alignment means 119 in the rear aperture 41 of accepting means 110.

FIGS. 24c and 24d indicate the final position of the towed and towing vehicle, which enables coupling of tow bar ball 22 and trailer socket 23. In this position, trailer wheels 11a have been caused to move in the directions indicated by arrows 70. Arrow 69 indicates the direction of which trailer 11 has moved to allow respective alignment of coupling means 13 and acceptance means 110. With the reversing of the towing vehicle, stop member 24 is brought into contact with the front aperture 40 of the accepting means 110. FIG. 24c shows the manual fine-tuning of the alignment process where the guidance rod is brought into contact with the alignment means 119. In use, the guidance rod 14 is manually caused to pass through the. centre axis resting point indicated at 119 to enable the final alignment and centering of the trailer socket component 23 over the tow ball, which is shown in outline in FIGS. 24a to 24d. FIG. 24d shows the guidance rod engaged and correctly positioned in both rear aperture 41 and front aperture 40. This process of alignment enables the free attachable end of the trailer 11 to pivot about the braked wheels 11a as shown by arrows 70, thereby aligning the trailer with the towing vehicle. With alignment complete, under the power of the towing vehicle, the coupling of tow bar ball 22 and trailer socket 23 can be completed and the coupling guidance device of the invention placed into a collapsed condition for later use. It should be noted that each component of the device is capable of separation from each other component, and from the towed and towing vehicles.

With particular reference to FIG. 25, a first end of guidance rod 14 is adjustably mounted to coupling means 13 via attachment plate 25 by means of adjustable nuts 28, whereby the required length and position of stop member 24 on rod 14 can be fine tuned. Attachment plate 25 fits in a substantially complimentary fashion against vertical pivot means 27 and is secured by bolt 26 and nut 26a. Releasable tow-bar mounting pin 29 is inserted through passageway 27a of vertical pivot means 27 and openings 30 to releasably attach guidance rod 14 to coupling means 13, thereby allowing for substantial lateral and limited vertical movement of the rod 14.

The second end of guidance rod 14 is received and supported by U-shaped receiving means 32, which is attached to accepting means 110 by means of slidable substantially oblong-shaped side mounting means 112 attachable by bolt 113, and fed firstly through front aperture 40 and then through rear aperture 41 of accepting means 110, until stop member 24 is brought into contact with receiving means 32, which is suitably shaped so as to enable the guidance rod 14 to facilitate alignment and engagement of receiving means 32 with arcuate-shaped member 43b having substantially parallel rocker arm elements over which the receiving means 32 is able to slide and forming a slit therebetween to receive the guidance rod 14. Locking pin 37 is inserted through openings 42 of channel flange 36 and openings 39 on trailer box beam 38, to removably attach accepting means 110 to trailer 11.

With particular reference to FIGS. 26 and 27, accepting means 110 comprises slidable receiving means 32, which when in the closed position, complementarily engages substantially arcuate-shaped member 43b to constitute front aperture 40. Arcuate member 43b is formed integral with the main body 35 of the accepting means 110. Hook flange 46 on main body 35 cooperates with the leading end of trailer box beam 38 to assist cooperative interaction between guidance rod 14 and accepting means 110. Openings 111 situated on the side walls of body 35 cooperate with lock means 118 to allow the receiving means 32 to be placed in at least one of three stages of collapse as required. Rest or support member 115 is attached to the receiving member to support the guidance rod when placed in the accepting means 110. Stop means 116 limits the backward movement of rest member 115. Stop means 117 bolted onto the receiving means 32 limits the forward movement of rest member 115. Kick plate guide means 121 assists the passage of guidance rod 14 through to the rear aperture 41 of accepting means 110. An alternate arrangement for the rest member 115, and stop means 116 and 117 is shown in FIGS. 61a and 61b where a plate rest 611 is utilized with rollers 612 adjustably secured in slots 614 by bolts 613 to provide enhanced angular adjustment as guidance rod engages accepting means 110.

FIG. 26 shows bolt 113 in slot 112 when the receiving means 32 is in the open condition, whereas FIG. 27 shows the location of parts 112 and 113 when the receiving means is in the closed position. FIG. 26 shoes the receiving means 32 in ghosting in its first collapsed state.

With particular reference to FIG. 27, the direction of the sliding movement of receiving means 32 over the arcuate member 43b is illustrated by arrow 120.

FIG. 28 shows the receiving means in the closed condition with the lock means 118 inserted into one of the openings 111 and rest member 115 held in position by stop means 116.

With particular reference to each of FIG. 29 to 33, and further reference to preceding Figures as necessary, a further embodiment of guidance acceptance means 130 is described. Acceptance means 130 comprises the same basic structure as that of acceptance means 110. Acceptance means 130 differs from acceptance means 110 in that receiving means 32 is now composed of two parts, receiving means 32a and 32b. Receiving means 32a is able to move forwardly to receive the guidance rod 14 therein and then slide backwardly to engage arcuate member 43b in a complementary fashion. Receiving means 32b is able to move slidably upwardly and over receiving means 32a and arcuate member 43b when positioned substantially forwardly of receiving means 32a or it is able to move downwardly to provide a variable opening to allow guidance rod 14 to be removed. The underside of accepting means 130 comprises a support plate 132 attached to support bar 133 to support guidance rod 14 once inserted into the front aperture 40 of accepting means 130. Accepting means 130 further provides supports 52 positioned thereon by retaining member 139 fixed to the main body 35 of accepting means 130 by at least one bolt/s 140 and having support arms 52a and pin members 52b. Supports 52 are formed with flipper arms 54 at the base thereof. At the rear aperture 41 of the accepting means 130 there is located a back stop member 131 and a spring-loaded substantially U- or C-shaped stop member. Similarly to accepting means 110, there is a substantially oblong-shaped slot means attachable to receiving means 32b by bolt 113. Lock means 118 can be actioned to place receiving means 32b in at least one stage of collapse.

With particular reference to FIGS. 30a to 30g and 31a to 31e, the second preferred embodiment of accepting means 130 is illustrated in use as follows: guidance rod 14 is inserted through front aperture 40, having been received by receiving means 32 and then passes through the rear aperture 41, until stop member 24 fitted with rubber pad 24a contacts receiving means 32a, which is caused to move towards the acceptance means 130 by slidable engagement of substantially parallel projecting bars 33 having carriage 57 which simultaneously actuates flipper arms 54. Flipper arms 54 moving in the direction of arrow 138 cause corresponding pivotal movement of support arms 52a, which in turn have protruding lugs 52c which engage mating slots 57b in bar or plate 57 at the rear aperture 41 to engage guidance rod 14 in a substantially rigid abutment. Supports 52 may rotate in the direction of arrow 137 and be raised upwardly whereupon pin means 52b can be retained in cut out means 52d. Bar 57a, which is pivotally mounted to projecting bar 33 in a substantially T-shaped configuration and also to carriage 57 is able to pivot when acted upon by flipper arms 54.

In use lugs 52c are engaged by mating slots 57b of bar 57 when the receiving means is moved rearwardly by the engagement of rod 14. Additionally, as the receiving means is moved forwardly ready for engagement with rod 14 at the next use, lugs 52c engaged in slots 57b position support arms 52a in their acceptance position ready to engage for the next alignment of rod 14 in future use. As shown most clearly in FIGS. 31c and 31d plate 136 drops down for engagement with the receiving mechanism per se in order to lock the accepting means 130 in its collapsed state. Ordinarily, plate 136 is spring biased by spring means S, shown in FIG. 31d such that it is biased to an upright position for ready engagement of rod 14 in accepting means 130. However, in the packed away state the support arms 52a and supports 52 have rotated such that the support arms 52a are directed outwardly. Further, supports 52 are in their upwardly raised position such that pins 52b or L in FIG. 32 have engaged cut outs 52d and are seated thereon. In this packed away state the accepting means is given a maximal clearance from ground in times of non-use and/or traveling of the towing and towed vehicles.

FIGS. 30a to 30e show the sequential in use steps of acceptance means 130. Arrow 19 indicates the lateral movement of rod 14 relative to acceptance means 130. An operator must initially affix coupling means 13 and acceptance means 130 to their respective mounting position on both towing and towed vehicle, respectively, as previously described above. To begin the vehicle coupling process, an operator engages the trailer brake handle 17 to set trailer braking system 18 in place. This prevents the wheels 11a from rolling and trailer 11 from moving whilst the coupling process is occurring. The operator then moves the towing vehicle 12 to substantially within coupling distance from the trailer 11, and connects the leading end of guidance rod 14 to coupling means 13 by operation of releasable mounting pin 29. The second end of rod 14 is then placed in receiving means 32a of acceptance means 130. With rod 14 connected and associated with both coupling means 13 and accepting means 130, the operator then proceeds to reverse the towing vehicle 12 backwards (arrow 19) towards the trailer 11. Rod 14 proceeding through accepting means 130 as the towing vehicle 12 reverses is capable of lateral and vertical movement to accommodate the differences in height, as approximately pre-determined by jockey wheel 16, and alignment between each vehicle. It should also be noted again, that an arrangement as mentioned with reference to FIGS. 54 and 56 may also allow limited vertical planar movement of rod 92. The reversing of the towing vehicle continues until stop member 24 engages directly with front aperture 32a and the receiving means 32a engages directly with the arcuate member 43b. With alignment complete, under the power of the towing vehicle, the coupling of tow bar ball 22 and trailer socket 23 can be completed and the lock means 118 retracted to allow the receiving means 32b to move forwardly in slot means 112 and downwardly to allow guidance rod 14 to be removed and stored for later use. As previously described, each component of the device is capable of separation from each other component, and from the towed and towing vehicles. FIG. 30d and 30e in particular show how the guidance rod can be removed from the acceptance means 130 once the trailer is attached to the motor vehicle.

FIG. 32 illustrates how receiving means 32a is received and retained within front aperture 40 by arcuate member 43b. Receiving means 32b is received and retained by both receiving means 32a and arcuate member 43b by means of slots 142 receiving tongue members 143 on receiving means 32b. FIG. 33 shows a detailed view of the lock means 118 in a preferred form as shown in FIG. 32.

In another preferred embodiment of the collapsible accepting means of the invention, the accepting means 150 (see FIGS. 34 to 42) comprises the same basic structure as that of acceptance means 110. Acceptance means 150 differs from acceptance means 110 in that it can be formed to be integral with the end of a trailer. The main differences are that the accepting means 150 has sloped roof 151 having an extended portion 151a (see FIG. 40). The sloped roof 151 is fitted at a top edge thereof with an abutment means 154 to but against and retain the trailer in position. In FIGS. 34a, 35a, 36a, 37a, 38a, 39a, 40a and 41a there is shown the accepting means 150 with the alternate arrangement of the plate rest member 611 and rollers 612.

FIGS. 40, 41 and 42 illustrate three possible variations of the rear aperture 41 of accepting means 150. FIG. 40 illustrates the guidance rod fed through the accepting means 150 in the absence of an alignment means. FIG. 41 shows an alignment means having a single alignment post utilized to align the guidance rod into position. The single post can swing downwardly as shown by arrow 156 and be accommodated in cut-out portion 151b of extended portion 151a of roof means 151. FIG. 42 shows an alignment means 155a having a plurality of alignment posts, and preferably two posts, which can similarly swing downwardly as shown by arrow 157 to accommodate the guidance rod therebetween. FIGS. 40a and 41a show a similar arrangement to FIGS. 40 and 41, respectively where the preferred alternate arrangement of the plate rest 611 and rollers 612 are utilized.

FIG. 43 illustrates one embodiment of the attachment means of the trailer to the tow bar 21 of the motor vehicle. The attachment means 25a for receiving the guidance rod 14 is bolted onto the vertical pivot means 27 which is attached by bolt means 31 to the tow ball of the vehicle. Pivot means 27 can pivot as shown in FIG. 44 by arrow 159 about the bolt 31 so as to be stored safety out of the way when not in use. When in use, the attachment means 25a can be raised in the direction as shown by arrow 158 and the pivot means 27 can then be pivoted as shown by arrow 159 to allow attachment means 25a to receive one end of guidance rod 14. In this form, the attachment means can remain on the vehicle at all times if desired. Also shown in FIG. 43 is the guide rod 14 with spacer 24 and pad 24a for contacting the receiving means, which is made preferably of resilient material such as rubber. FIG. 43a shows a preferred form of the attachment means where a biasing means 631 is used to hold the attachment means firmly in place so as to prevent rattle when moving. The biasing means as shown may be a leaf spring, however other forms of biasing are suitable for this purpose as would be recognised by the person skilled in the art. FIG. 45a also shows a preferred form of guide rod arrangement where a protrusion 24b is provided to spacer plate 24 to assist in self aligning when engaging with the receiving means in its variable apertured opening. This protrusion thus allows for an increased angle of engagement of the guide rod with the accepting means.

FIGS. 46 to 60 provide an illustrative example of another embodiment of the second member or accepting means of the invention, which by virtue of having more than one alignment means for the engagement of the guidance rod 14 provides for increased angles of approach and engagement with the guide rod 14. Angles up to and including 35° may be accommodated by this embodiment. The preferred angle of approach however is a maximum of 30°. The embodiment shown in these figures comprises first alignment means for providing progressive alignment of the guidance member and second alignment means for providing final alignment of the guidance member within the second member. In FIGS. 46 to 60 the first and second alignment means comprise swing arms. FIG. 47 is a back perspective illustration of the accepting means of FIG. 46 viewed from underneath where both bottom cover plate and the back cover are removed. FIG. 48 provides more detail of the first and second alignment means in the form of first swing arms 571 and second swing arms 570. FIG. 50 also shows adjustable means in the form of adjustable bolts 572 that can control the freedom of movement of receiving means, which assists in accommodating for increased angles of engagement of guide rod 14. With reference to FIGS. 57 to 60, the first and second alignment means, swing arms 571 and 572, respectively act as staged guides in which the first stage provides initial alignment and the second stage provides final alignment of the guide member. FIG. 57 shows initial engagement of the guide rod with the receiving means positioned towards its most extreme allowed placement by bolts 572 and it is seen that the guide rod is in a maximum off centre position corresponding to this. FIG. 58 shows the action of the first swing arm 571 to partially push the guide rod 14 towards a centred position. FIG. 59 shows the action of the second swing arm 570 in positioning the guide rod 14 into its final centred position for locking engagement with the accepting means. FIGS. 60a to 60c show a schematic view of the staged alignment caused by the first and second swing arms 571 and 572 in cooperation with the marginal movement of adjustable receiving means provided by adjustable bolts 572. In another preferred form the accepting means may be recessed into a gooseneck portion of a trailer as shown in FIG. 55. By virtue of this recessing, which may be a permanent fixture, there is provided an extra clearance C between the accepting means and ground as shown in FIG. 55. This extra clearance is useful particularly when the arrangement of FIG. 56 is adopted for providing the extra degree of freedom of movement previously described by virtue of the vertically moveable coupling shown that gives planar movement of the device indicated by arrow A in FIG. 56.

In a further preferred embodiment illustrated in FIGS. 62 to 80 there is provided an alternate mechanism for allowing increased angles of engagement of the accepting means with the guide rod 14 in which a cooperative assembly of mechanisms best shown in FIG. 72 is utilised. In this embodiment self aligning means are provided by way of a projecting bar 720 for providing leverage, longitudinal movement mechanism 752, transverse movement mechanism 751 and stabilising guide point or pins 753 with attached chains 660 provides improved guidance for coupling a trailer to a tow vehicle. As opposed to previous embodiments, the chain means may aid in providing initial alignment of the guide member, only. In this example, a wider angle of approach may be allowed on the part of the first vehicle when being guided to closer proximity to the second vehicle. This embodiment has the components of the accepting means generally disposed in the upper or ceiling portion of the accepting means housing to provide further compactness of the device and improved ground clearance. FIG. 66 provides an illustration of the compact construction showing supports 52 almost entirely within the housing of accepting means. This is in contrast to previous embodiments where the supports generally protrude beyond the top of the housing. Also as shown in FIG. 71, the components are disposed in the housing not only in a more compact form but also with a wider separation of each of the complimentary functioning components such that, for example, support or swing arms or rollers 741 are positioned at wider separation to accommodate even greater angles of engagement with the guide rod 14. Rollers 741 of FIG. 71 have further adjustment provided by slots 742.

In FIG. 62 the preferred guide member arrangement of FIGS. 43a and 45a is utilised, which allows more accurate alignment of the guide member into the accepting means. Lock mechanism 670 is provided to prevent movement of the receiving means as engaged with the accepting means during travel of the device. FIG. 67 shows at 700 an increased spacing provided by the aperture of the receiving means which assists in enabling wider angles of engagement of the guide rod 14 into the accepting means. FIG. 71 shows rollers 741 moveable in slots 742 for engaging the guide rod in a similar fashion to the rest plate arrangement shown in FIGS. 61a and 61b. The tensionable chain arrangement for providing staged alignment is best shown in the exploded view illustration of FIG. 72. it can be seen that the tensionable chains 660 are used in combination with receiving and engagement means 751, 752 and 753 to accommodate the guide rod as a first alignment stage. Transverse movement of the guide rod is accommodated by mechanism 751. Longitudinal movement is accommodated by mechanism 752 and pins 753 engage with guide rod 14 to provide stabilised alignment. The action of the alignment means is clearly shown in plan view and schematic form in FIGS. 73 to 80. With the assistance of swing arms 570, final alignment of the guide rod 14 can be achieved. Pins 753 are adjustable by virtue of the chain means 660 which attaches thereto at each side thereof. The chain means may be anchored at side points of the accepting means, shown by A′ in FIG. 72, and this point of anchoring may vary to allow increasing or decreasing effect of the chain means providing its early alignment function. Besides having a choice of where to anchor chain means at the sides of accepting means, it is also possible to have the chain means 660 adjustable for its tension either at the anchor point A′ or at the connection point to pins 753 as shown in FIG. 72. This point of connection is also preferably spring loaded. This may prevent tangling of the chain means when it has slack. In a previous embodiment as shown in FIGS. 19 to 23, it is the tensionable chain means combined with gripping arms and socket 87 lockably engaging with protrusion 90 of rod 92 which forms the entire alignment mechanism. In the embodiment shown in FIGS. 62 to 80, at least, the chain means is only used for initial correction of alignment at greater angles of engagement of rod 14. At narrower angles of approach both sides of chain means 660 may remain with slack whilst the receiving and engagement means 751, 720, 752, 753 provide the necessary alignment into final position for coupling to be possible. FIG. 79 illustrates an example of the alignment where the chain means has no part in the continuing alignment.

Alternatively, the first and/or second alignment means may comprise a combination of one or more of tensionable chain means as shown in FIGS. 62 to 80 as well as one or more swing arms as shown in any of FIGS. 46 to 80.

FIGS. 81 to 94 provide an illustrative embodiment of the second member or accepting means having articulation means for providing movement of the second member relative to the second vehicle. The articulation means may comprise, as shown in FIGS. 84 to 97, a turntable arrangement for rotation of a portion of the second member in a horizontal plane. There is also preferably provided a means of allowing limited movement of the turntable arrangement to allow some flexibility in the initial feeding of the guide rod 14 into the accepting means. Preferably, the articulation means further comprises a tooth arrangement, as shown more clearly in FIGS. 82 to 85 for engaging the guide member assisting with its alignment and final engagement. This preferred embodiment is particularly useful in guiding the coupling of two vehicles in difficult conditions, which may include for example, having a towing vehicle and trailer on disparate and uneven surfaces. The turntable arrangement 841 also comprises a mechanism for providing a margin of compensation in the form of slots 843 that may be engaged with locking pins 866 and whereby the locking pins further engage a series of holes 830 for providing positioning of the turntable. As clearly shown in FIG. 93 the margin of compensation is provided in this example by slots 843 for up to 5° either side of the engagement position of locking pins 866 and holes 830. Portion 96A of FIG. 93 with insets 96A, 96A− and 96A+ illustrate the margin of compensation provided by this arrangement. The embodiment as shown in FIGS. 83 and 84 utilises a rest bar 863 adjustably fastened by fastener 864 into one of holes 865 to the accepting means to provide guidance and support to guide rod 14 in a similar fashion to the arrangement of FIGS. 61a and 61b. This arrangement assists in providing a margin of compensation for guiding the coupling of the two vehicles on uneven surfaces. Further a tooth arrangement 842 is provided and is retractable for engaging the guide rod 14. When manually aligning, all pins are removed first and the tooth arrangement is retracted. A side bar or manual insert bar 960 may form a portion or extension of the guide rod 14 that is detachable therefrom and capable of use as a manual alignment bar once guide rod 14 is fully accepted by accepting means and final coupling of tow ball to trailer socket is possible. FIGS. 85 and 86 show the tooth arrangement engaged and retracted respectively. FIGS. 92 and 94 show a biasing arrangement in the form of spring 942 that holds the tooth arrangement in the retracted position. Further, FIGS. 85 and 86 show lugs 883, which hold the accepting means in place against a gooseneck region of a trailer in a similar fashion to the hook flanges of previous embodiments described above. In embodiments as described herein, the guidance coupling device with its guidance rod may provide for separation between towing and towed vehicle of up to 1.2 m. Greater flexibility of engagement of the two vehicles may be provided in confimed or difficult spaces.

While this invention has been described in connection with specific embodiments thereof, it will be understood that it is capable of further modification(s). This application is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. Integers or components of the present invention may be passive components driven by movement of either the towing or towed vehicle or, motorised so as to allow either or both towed and towing vehicle to remain stationary whilst the first and second members are moved relative to one another. Such integers may be the various mechanisms that comprise either the first member or guidance member coupling means for coupling to a towing vehicle; the second member or accepting means or; the guidance member itself. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

Throughout this specification, unless the context required otherwise, the word “comprise”, or variations such as “comprises” or “comprising” will be understood to imply the inclusion of a stated integer or group of integers, but not to the exclusion of any other integer or group of integers.

1. A coupling guidance device comprising:
a first member adapted to be coupled to a first vehicle, the first member further adapted to be operatively associated with a guidance member for providing a guide path;
a second member adapted to be coupled to a second vehicle, the second member comprising a receptacle adapted to cooperate with the guidance member such that the first and second member are adapted to be moved relative to one another, the relative movement serving to bring the first vehicle and the second vehicle into closer proximity.

2. A coupling device as claimed in claim 1 wherein the receptacle comprises:
movable receiving means adapted to move from an open to a closed condition for receiving the guidance member in the closed condition during the relative movement if the first and second member for releasing the guidance member in the open condition upon the first and second vehicle being brought into closer proximity.

3. A coupling device as claimed in claim 2 wherein the receiving means comprises sequentially collapsible portions.

4. A coupling device as claimed in claim 2 wherein the receiving means is slidably engageable with a body portion of the second member.

5. A coupling device as claimed in claim 1 wherein the second member further comprises first alignment means for providing progressive alignment of the guidance member within the second member upon cooperation of the guidance member with the second member.

6. A coupling device as claimed in claim 5 wherein the second member further comprises second alignment means for providing final alignment of the guidance member within the second member upon cooperation of the guidance member with the second member such that the first vehicle and the second vehicle are brought into closer proximity.

7. A coupling device as claimed in claim 5 wherein the first and second alignment means comprise one or more of:
tensionable chain means;
one or more sewing arms.

8. A coupling device as claimed in claim 1 further comprising auxiliary adjustment means adapted for manual operation to provide final alignment of the guidance member upon cooperation with the second member.

9. A coupling device as claimed in claim 1 wherein the second member further comprises articulation means for providing movement of the second member relative to the second vehicle.

10. A coupling device as claimed in claim 9 wherein the articulation means comprises a turntable arrangement for rotation of a portion of the second member in a horizontal plane.

11. A coupling device as claimed in claim 9 wherein the articulation means further comprises a tooth arrangement for engaging the guide member.

12. A coupling device as claimed in claim 1 wherein the guidance member is pivotally coupled to the first member so as to allow one or more of:
substantial free lateral movement;
limited vertical movement;
limited rotational movement; and
limited planar movement of the guidance member when cooperating with the second member.

13. A coupling device as claimed in claim 1 wherein the first vehicle comprises a towing vehicle and the second vehicle comprises a towed vehicle.

14. A coupling device as claimed in claim 13 wherein the towing vehicle comprises one or more of:
a motor vehicle, such as a car or a truck.

15. A coupling device as claimed in claim 13 wherein the towed vehicle comprises one or more of:
a trailer, a caravan or the like.

16. A coupling device as claimed in claim 1, wherein the first member is mountable upon or to a tow-bar of the first vehicle.

17. A coupling device as claimed in claim 1 wherein the second member is mountable upon or to a gooseneck area of the second vehicle.

18. A coupling device as claimed in claim 1 wherein the guidance member comprises an elongated rod.

19. A coupling device as claimed in claim 1 wherein the guidance member further comprises a rigid member.

20. A coupling device as claimed in claim 1 wherein the first member and the second member are removable attachable to said first and second vehicle, respectively.

21. A coupling device as claimed in claim 1 wherein the second member is permanently attachable to said second vehicle and/or recessed into a portion of the second vehicle.

22. A coupling device as claimed in claim 1 wherein the first member is permanently attachable to said first vehicle.

23. A method of guiding a first and a second vehicle into closer proximity for enabling the coupling of one vehicle to the other comprising the steps of:
operatively associating a first member adapted to be coupled to the first vehicle with a guidance member for providing a guide path;
cooperating a second member adapted to be coupled to the second vehicle with the guidance member such that the first and second member are adapted to be moved relative to one another along a guide path provided by the guidance member, the relative movement serving to bring the first vehicle and the second vehicle into closer proximity.

24. Apparatus adapted to guide a first and a second vehicle into closer proximity for enabling the coupling of one vehicle to the other said apparatus comprising a coupling device as claimed in claim 1;
said apparatus, in conjunction with said coupling device, being adapted to perform the method as claimed in claim 23.

25. Apparatus as claimed in claim 24 wherein one or more of:
a) the first member;
b) one or more components of the first member;
c) the second member;
d) one or more components of the second member;
e) the guidance member;
f) one or more components of the guidance member are motorized.

26. A coupling guidance device comprising:
a guidance member;
a guidance member accepting means adapted for mounting to a second vehicle, and;
a guidance member coupling means adapted for mounting to a first vehicle, wherein the guidance member in operative association with the coupling means interacts with the accepting means and upon movement of at least one of the first vehicle or the second vehicle relative to one another the guidance member, the accepting means and the coupling means, in combination, cause substantial alignment of the two vehicles to enable coupling of one vehicle to the other.

27.-28. (canceled)
